(19) United States
(12) Patent Application Publication
(10) Pub. No.: US 2012/0197777 A1
(43) Pub. Date: Aug. 2, 2012

(54) Online System and Method for Issuing Collateralized Securities

(76) Inventors: James P. Shoen, Reno, NV (US); Jason Allen Berg, Phoenix, AZ (US)

(21) Appl. No.: 13/362,739

(22) Filed: Jan. 31, 2012

Related U.S. Application Data
(60) Provisional application No. 61/438,146, filed on Jan. 31, 2011.

(51) Int. Cl. G06Q 40/04

(52) U.S. Cl. 705/37

(57) ABSTRACT

A computer-implemented method for conducting a registered public offering of collateralized securities includes storing offering information in a database. The offering information is associated with a public offering of a collateralized debt security offered for sale by the issuer of the debt security. The offering information includes payment terms of a loan and a description of collateral for securing the loan, as well as the number of units of the security to be sold in the initial offering. The website is used to receive from a retail investor an offer for the purchase of the debt security directly from the issuer. The purchase price for the retail investor can be as small as $100.

### RELATED APPLICATION

This application claims the benefit of U.S. Provisional Application No. 61/438,146, filed Jan. 31, 2011, entitled “Online System and Method for Issuing Collateralized Securities,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

The present invention relates generally to methods and systems for electronically issuing debt securities. More specifically, it relates to a method and system for electronically issuing directly to retail customers over a computer network (including over the Internet) collateralized debt securities backed by specific corporate assets in small amounts. The method and system enables the issuer to sell the securities directly to retail customers without the assistance of underwriters or investment bankers or brokers and dealers (“middlemen”).

Commercial enterprises have traditionally used bank loans or securities offerings as means of raising new capital. A disadvantage of bank loans as a source of financing is that the bank may seek a measure of protection against default by the borrower via extensive financial covenants. Securities may be an attractive option relative to bank loans depending on their pricing and market demand. Through securities, capital is provided by investors who purchase the securities upon their initial issuance.

Debt securities may be called debentures, bonds, deposits, notes or commercial paper depending on their maturity and certain other characteristics. The holder of a debt security is typically entitled to the payment of principal and interest, together with other contractual rights under the terms of the issue, such as the right to receive certain information. Debt securities are generally issued for a fixed term and redeemable by the issuer at the end of that term. Debt securities may be protected by collateral.

Typically, initial securities offerings are purchased by wholesale investors, i.e. by financial institutions acting on their own account, or as middlemen on behalf of clients. These middlemen include underwriters or investment bankers (who package the loans and then market and sell them typically to portfolio managers in bulk) and broker/dealers (usually on a secondary market) who sell them to end consumers. Retail investors, i.e. members of the public investing other than by way of business, typically cannot buy securities directly from the issuing companies. Instead, they must purchase such securities through middlemen, and only in relatively large quantities. Typically, rating agencies are involved in such issuances. This involvement by middlemen and rating agencies increases the cost of raising capital.

It is an object of the present invention, therefore, to provide a system and method that enables an organization to finance its debt by selling securities directly to retail investors without the assistance and cost of middlemen traditionally required for securities issuance.

It is still another object of the invention to provide a system and method for issuing debt securities that provides the issuing organization more control over the terms of the loans underlying the debt securities.

It is yet another object of the invention to provide a system and method for issuing collateralized debt securities backed by specific assets, which can be purchased and sold in relatively small amounts.

It is still another object of the invention to provide a system and method for issuing securities that reduces the cost, complexity and time of obtaining financing.

It is another object of the invention to provide a system and method for issuing securities that allows for a fair return and other favorable terms, such as collateralization.

It is yet another object of the invention to provide a system and method for issuing securities that provides transparency by allowing investors to see exactly what assets are securing the loan.

Still another object of the invention is to provide a method and system that is easy for investors to use and that allows virtually all persons and entities who are interested to have an opportunity to invest.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a computer-implemented method for issuing collateralized securities. The method includes storing offering information in a database. The offering information is associated with a public offering of a collateralized debt security offered for sale by the issuer of the debt security. The offering information includes corporate disclosures about the issuer of the securities and its business, risk factors relating to the issuer and the securities, payment terms and conditions, and a description of collateral for securing the loan, as well as the number of units of the security to be sold in the offering. The offering information is filed with the appropriate regulatory authorities and is displayed on a website for viewing by a retail investor. The website is used to receive from the retail investor an offer to purchase the debt security directly from the issuer. The purchase price for the retail investor can be as small as $100.

According to one advantageous aspect of the invention, the collateral can be assets used by the issuer of the debt security in its business, such as real property, vehicles and equipment used in connection with a self-help moving business.

### BRIEF DESCRIPTION OF THE DRAWINGS

The accompanying drawings, which are incorporated in and constitute a part of the specification, illustrate the presently preferred embodiments and methods of the invention and, together with the general description given above and the detailed description of the preferred embodiments and methods given below, serve to explain the principles of the invention.

FIG. 1 is a functional block diagram of a preferred computer system and a network for practicing the present invention.

FIG. 2 shows an exemplary screen display of an Account Setup page for opening a user system account according to the present invention.

FIGS. 2A-2K show the Account Setup page of FIG. 2 with each of the various user system account types selected, respectively.

FIGS. 3A-B show alternative embodiments of an exemplary screen display of an investor's Account Summary page according to the invention.

FIGS. 4A-E show exemplary screen displays of pages for adding funds to a user's system account according to the invention.

FIGS. 5A-E show exemplary screen displays of pages by which a user can browse securities available for purchase and for placing an offer for the purchase of a security, all according to the invention.

FIGS. 5F-H show exemplary screen displays of a pages for a user to view and add investment alerts according to the invention.

FIGS. 6A-C shows exemplary screen displays of pages for a user to view and edit their user profile information according to the invention.

FIG. 7 shows an exemplary screen display of a user's account activity page according to the invention.

FIGS. 8A-C show exemplary screen displays of a website home page that allows a potential investor to view information about investment opportunities available to users who join as members according to the invention.

FIG. 9 shows an exemplary screen display of a Summary page for use by an administrator of the system according to the invention.

FIG. 10 shows an exemplary screen display of a security information page for use by a system administrator to display detailed information about a security according to the invention.

FIGS. 11A-B show exemplary screen displays of a Manage Members page for use by a system administrator to display detailed information about users who have registered as members.

FIGS. 12A-B show exemplary screen displays for use by a system administrator to search and manage securities information stored in the system according to the invention.

FIGS. 13A-H show exemplary screen displays for use by a system administrator to search and manage rules and content stored in the system according to the invention.

FIG. 14A-E shows exemplary screen displays for use by a system administrator to add a security to the system according to the invention.

FIG. 15 shows an exemplary screen display for use by a system administrator to manage the categories of collateral for securities according to the invention.

FIG. 16 shows an exemplary screen display for use by a system administrator to add an investor to the system as a member according to the invention.

FIGS. 17A-B show exemplary screen displays for use by a system administrator to send communications to holders of the securities according to the invention.

FIGS. 18A-B show exemplary screen displays for use by a system administrator to buy out holders of securities according to the invention

FIG. 19 shows an exemplary screen display for use by a system administrator to search and manage member information stored in the system according to the invention.

FIG. 20 is a flowchart showing eligibility questions presented to a user in connection with starting up a traditional IRA or Roth IRA with the system.

FIG. 21 is flowchart showing eligibility questions presented to a user in connection with rolling over all or part of a previous employer's 401K.

FIG. 22 is flowchart showing eligibility questions presented to a user in connection with rolling over an IRA or making a direct transfer to a traditional IRA or a Roth IRA.

### DETAILED DESCRIPTION

Reference will now be made in more detail to presently preferred embodiments and methods of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention, and the description is intended to cover alternatives, modifications, and equivalents as may be included within the spirit and scope of the invention as defined by the appended claims.

The present invention enables an organization to issue collateralized debt securities backed by specific assets, which can be purchased by investors in small amounts (e.g., as small as $100). The securities are issued and sold directly to retail investors without the assistance and cost of middlemen that have been traditionally required for securities issuance. The invention enables individuals or small investors to purchase debt securities directly from the issuer, allowing companies an alternative to finance corporate debt; it provides the company more control over the terms of the loan; it ultimately reduces cost by eliminating the middlemen; it allows for a fair return and other favorable terms; it allows consumers to directly invest in a company they trust; and it provides transparency by allowing customers to see exactly what assets are securing the loan.

### Computer System

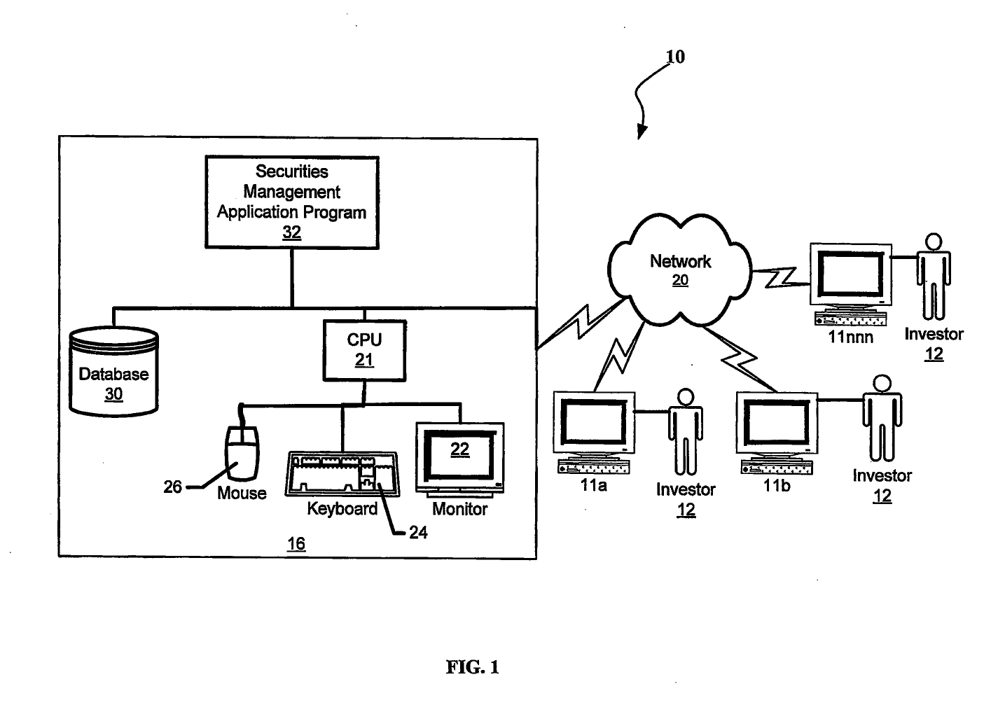

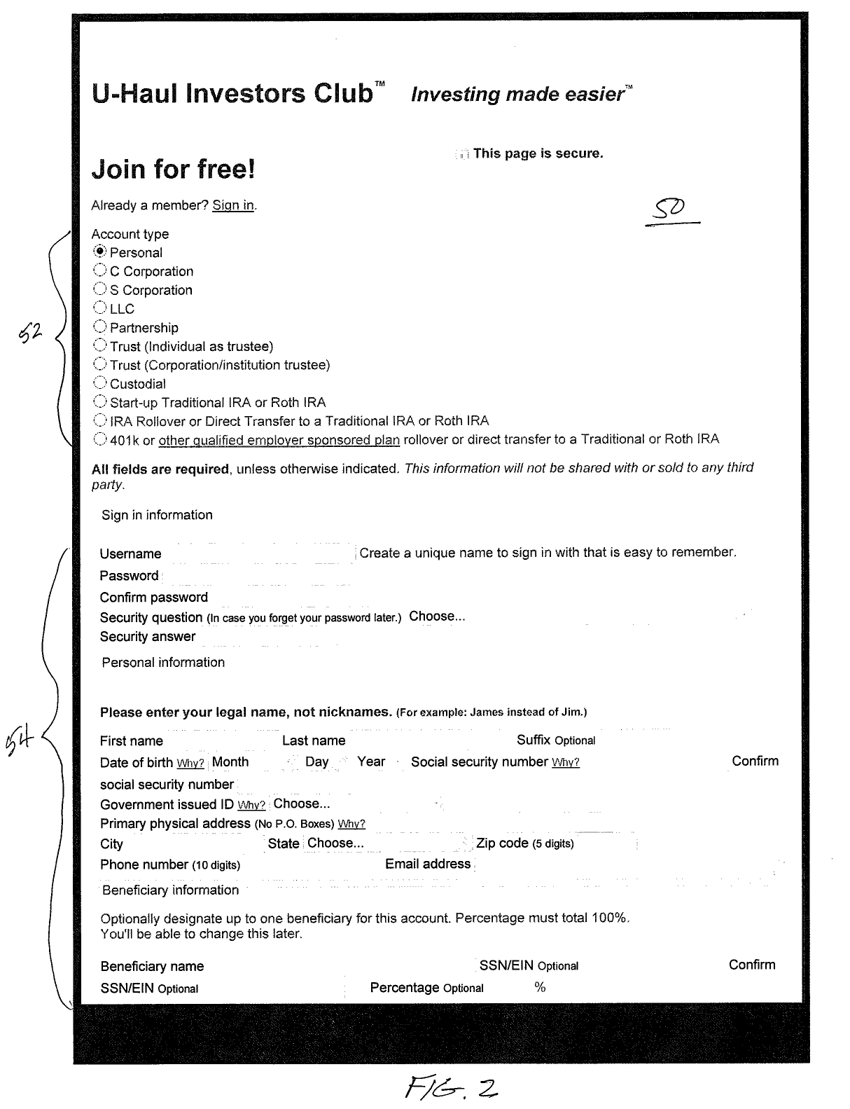

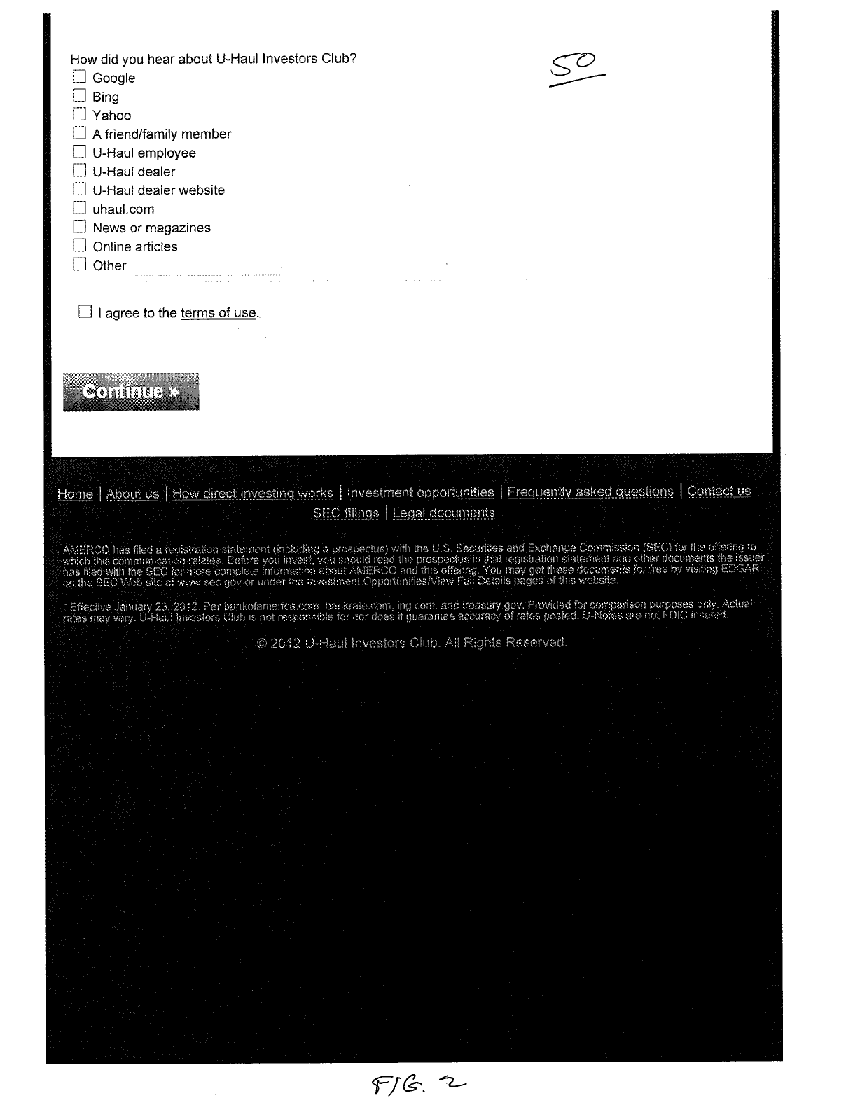

FIG. 1 illustrates a preferred system 10 for practicing the present invention. The system 10 includes a securities management computer system 16, which stores and processes the information described below, including information regarding securities data and investor data. Users 12 can access the securities management computer system 16 via user computers 11a, 11b and 11nnn, (where nnn refers to any number of users and user computers) coupled to the securities management computer system 16 via a computer network 20, such as the Internet, or by other suitable communications means. In a preferred embodiment of the invention, the computer network 20 comprises the Internet. Upon reading this specification, those skilled in the art will understand that, under appropriate circumstances, considering issues such as developments in computer hardware, software and connectivity, etc., other network configurations and devices also may suffice, such as for example, PDAs connected via a wireless network, etc.

Still referring to FIG. 1, the securities management computer system 16 includes a central processing unit (CPU) 21 for processing data and program instructions. The computer system 16 also includes input and output devices, as is well known in the art. For example, the computer system 16 preferably includes a display screen or monitor 22, a keyboard 24, a mouse 26, a printer (not shown), etc. The computer system 16 further includes data storage and memory devices, as are known in the art, for storing a database 30. The database 30 is used to store securities data and investor data, as described below. Preferably, the database 30 is a relational database, as is well known in the art. A securities management application program 32 is operable with the database to provide the functionality described below. In a presently preferred embodiment, the securities management application program 32 is implemented using the .NET operating system platform, and the database 30 is implemented using the SQL Server database management system, both marketed by Microsoft Corporation of Redmond, Wash. Upon reading this specification, those skilled in the art will understand that, under appropriate circumstances, considering issues such as developments in computer hardware, software and connectivity, etc., other operating systems, programming languages and database management systems can be used.

### Operation of the System

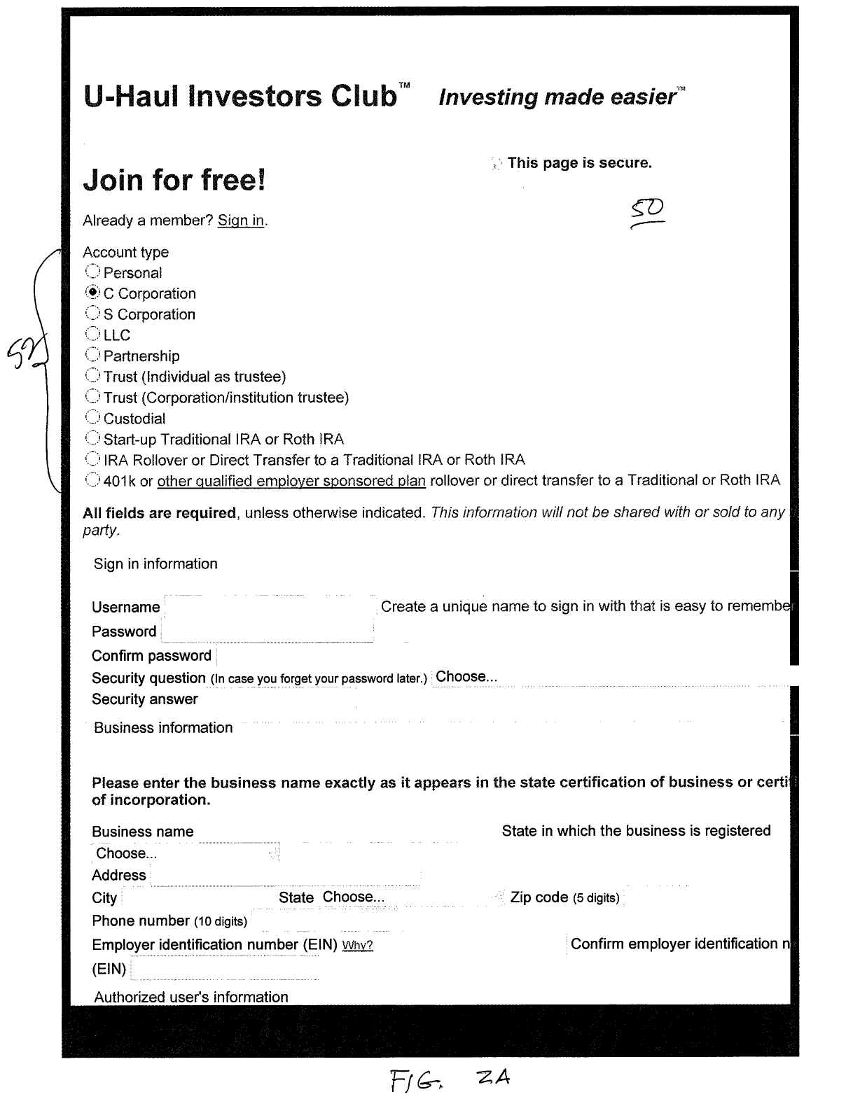

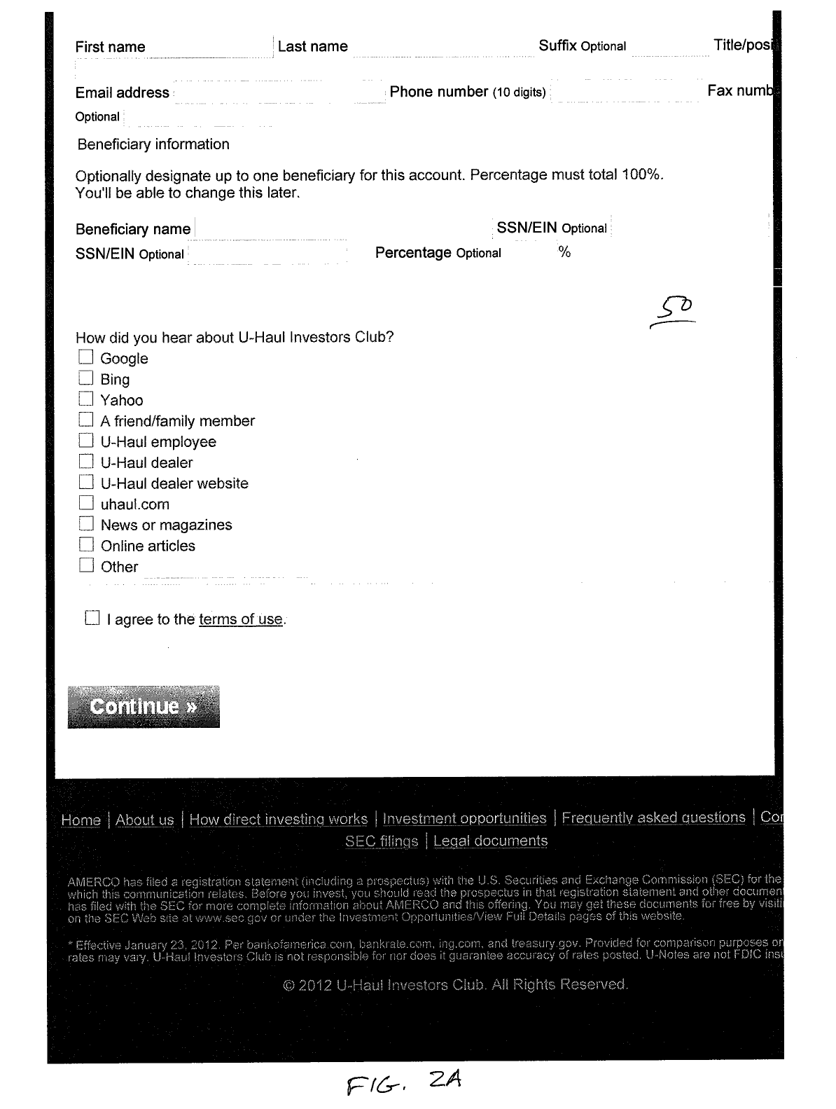

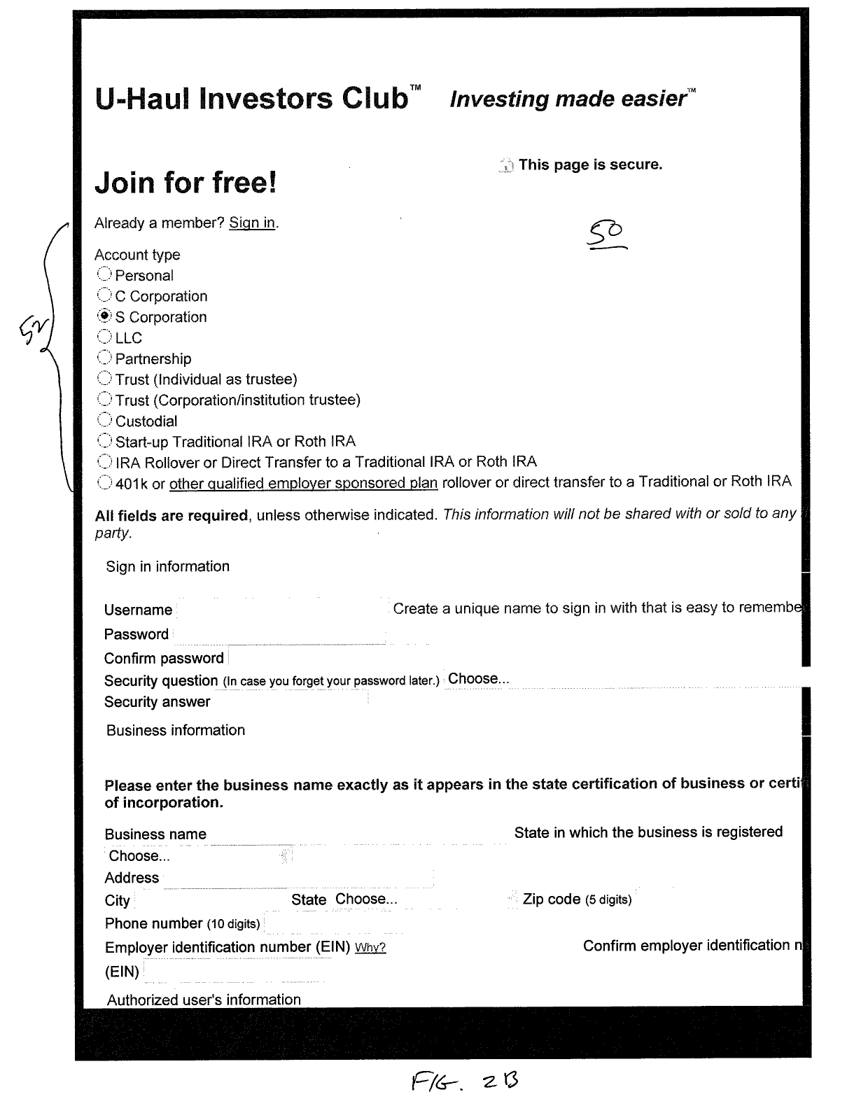

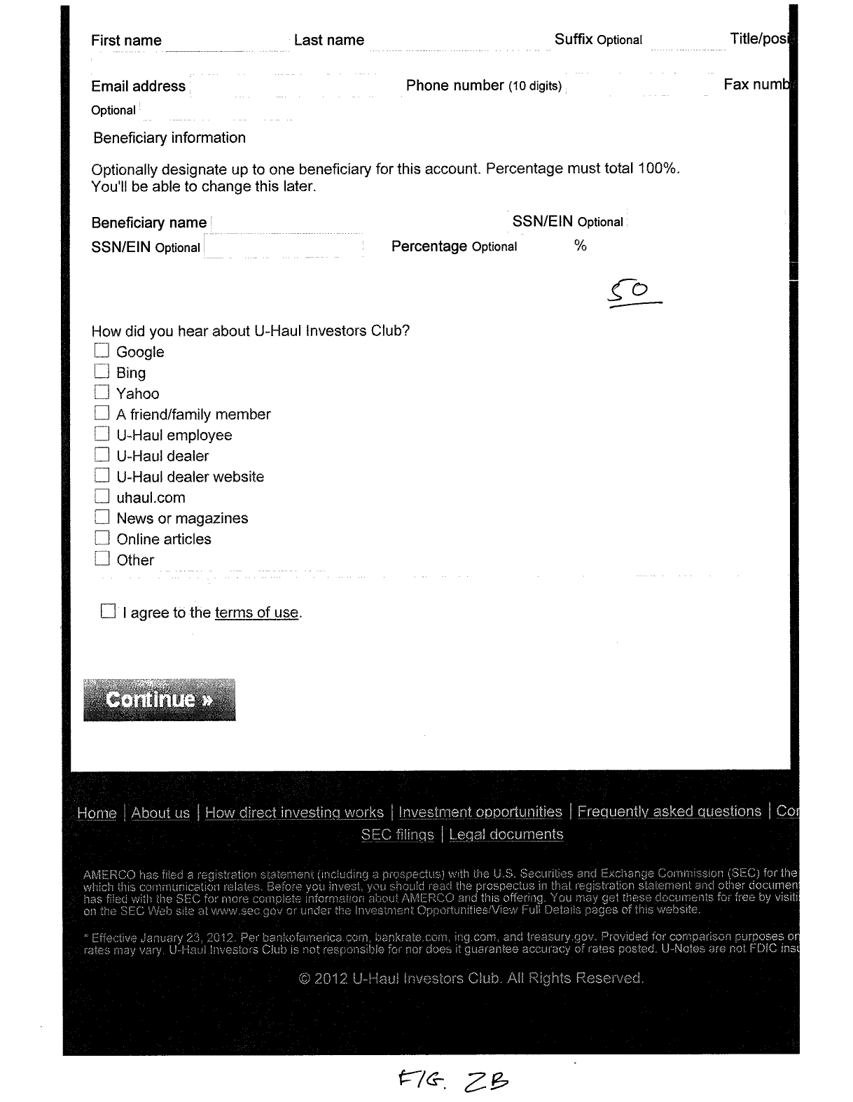

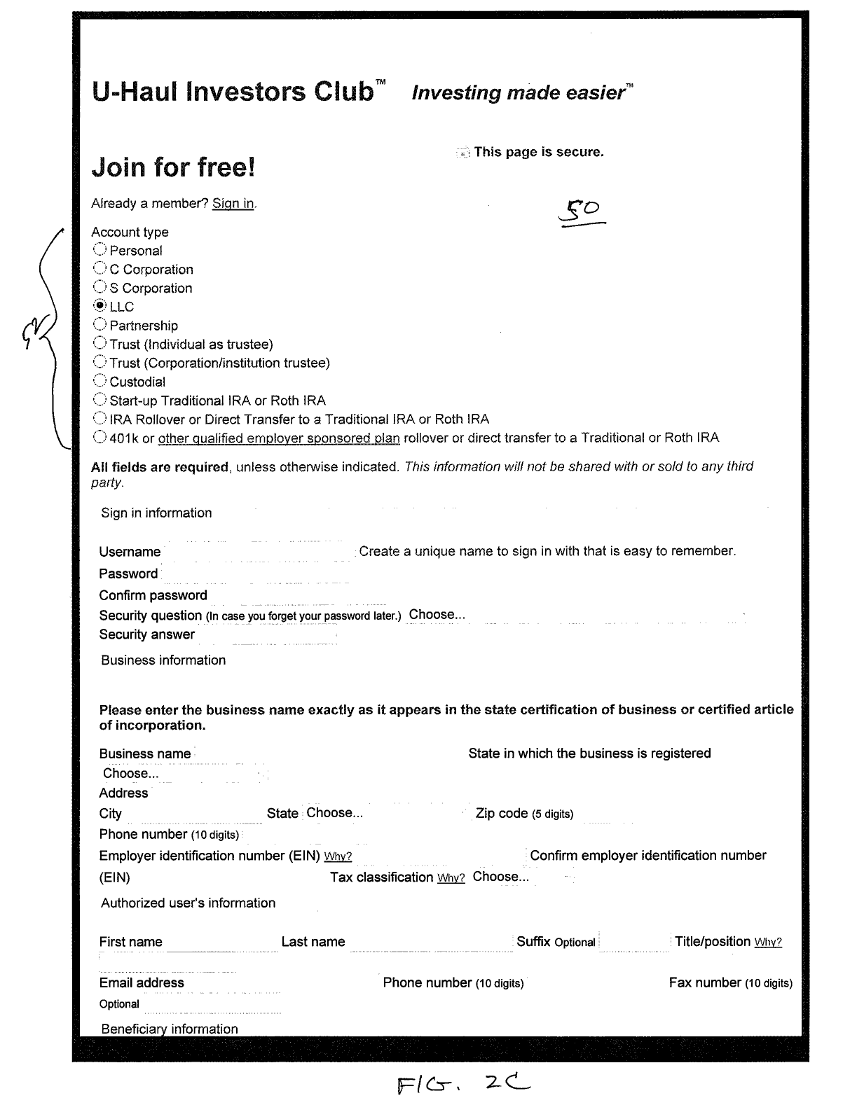

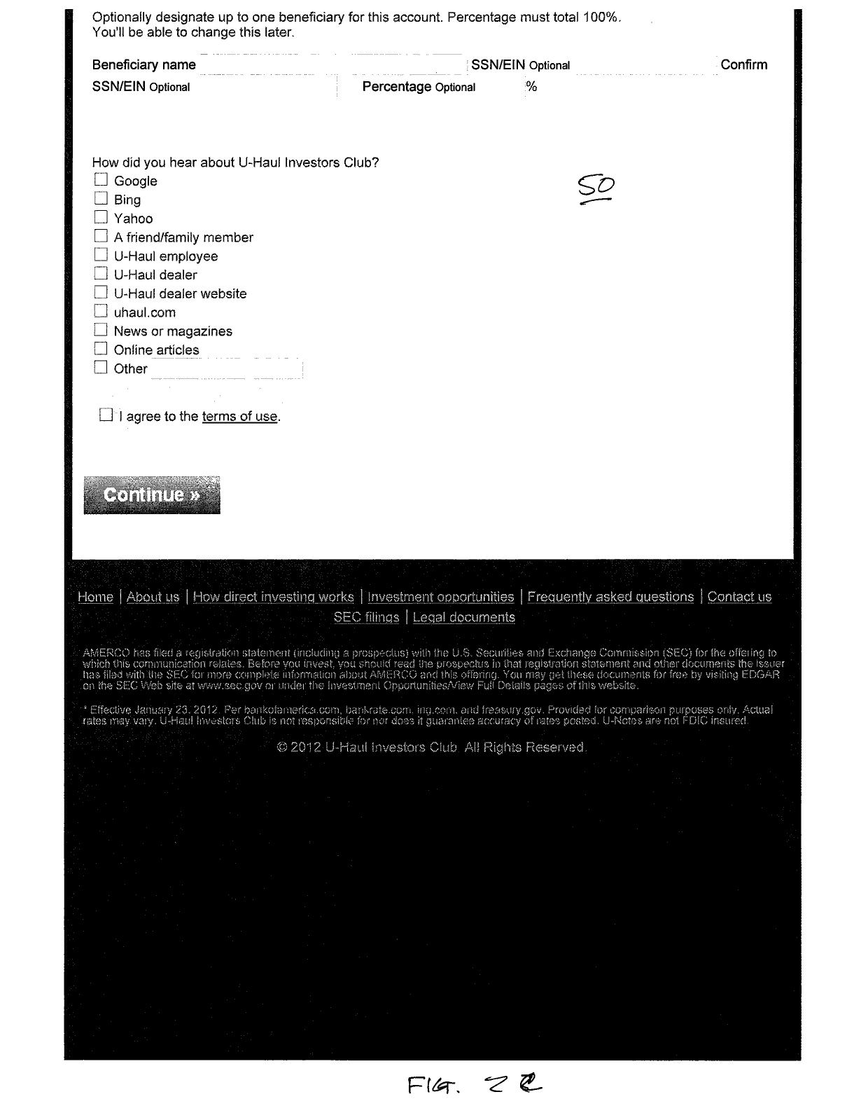

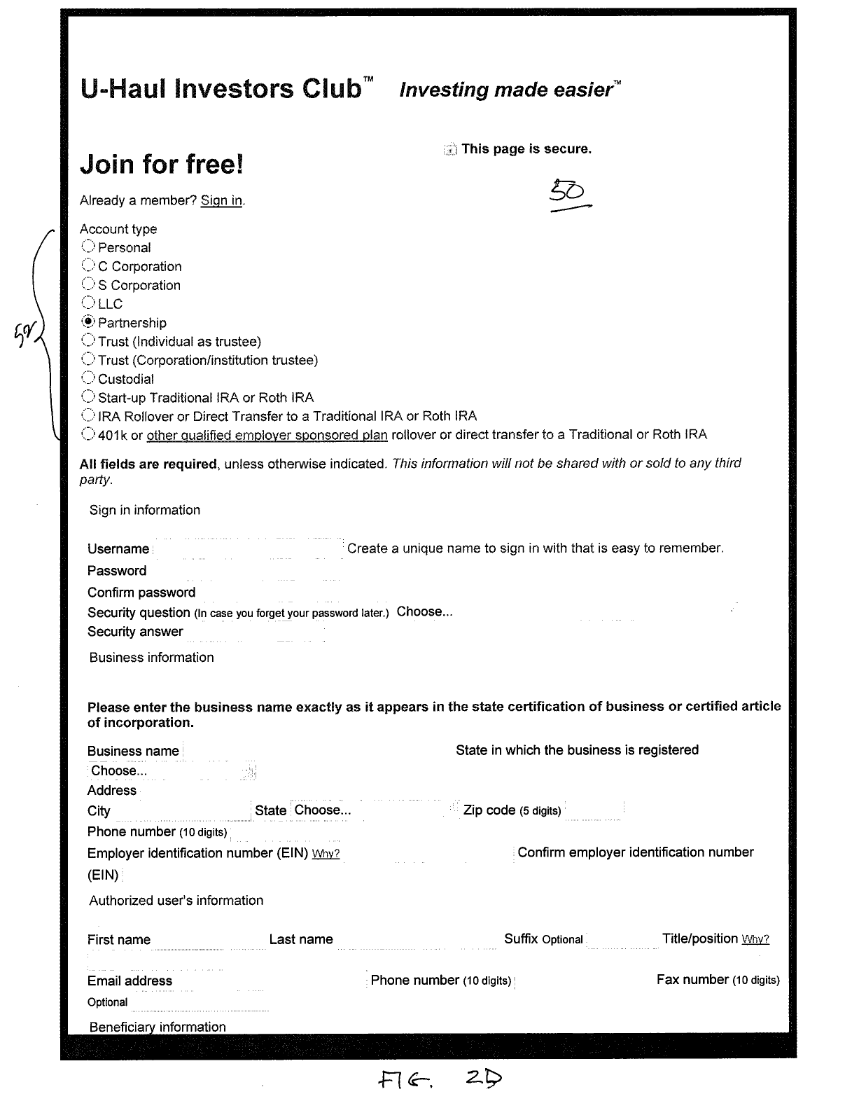

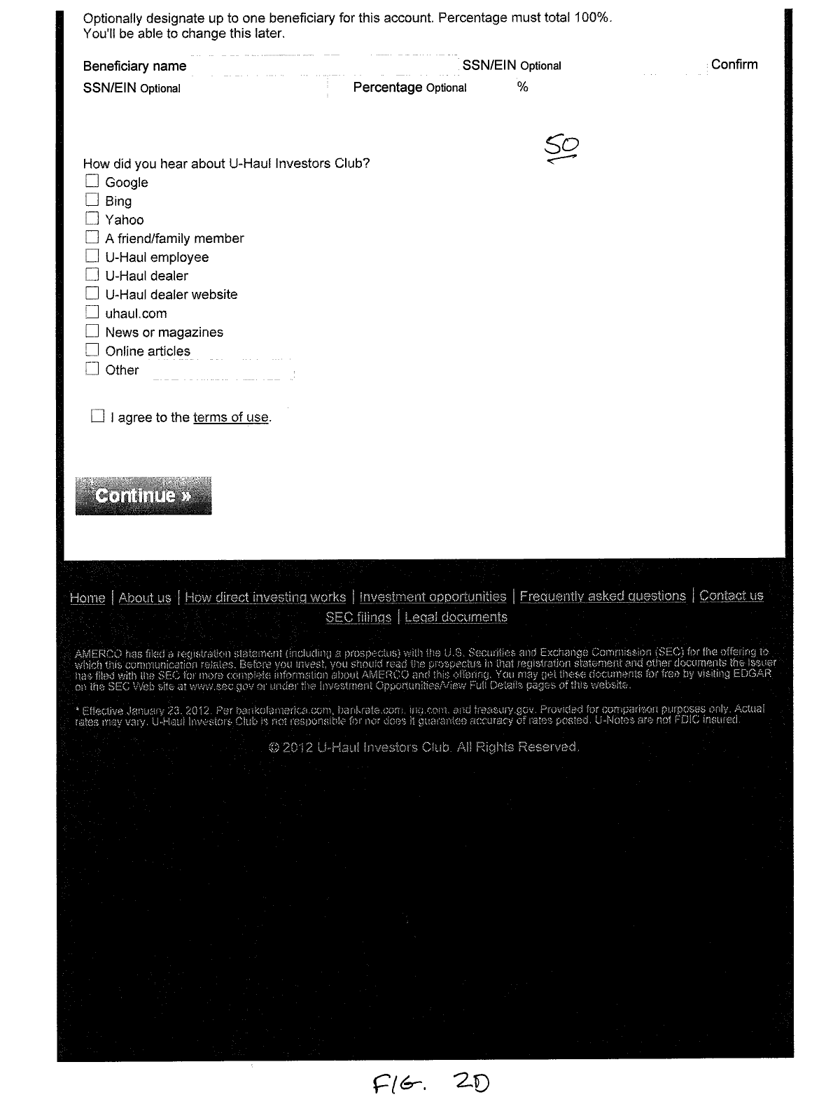

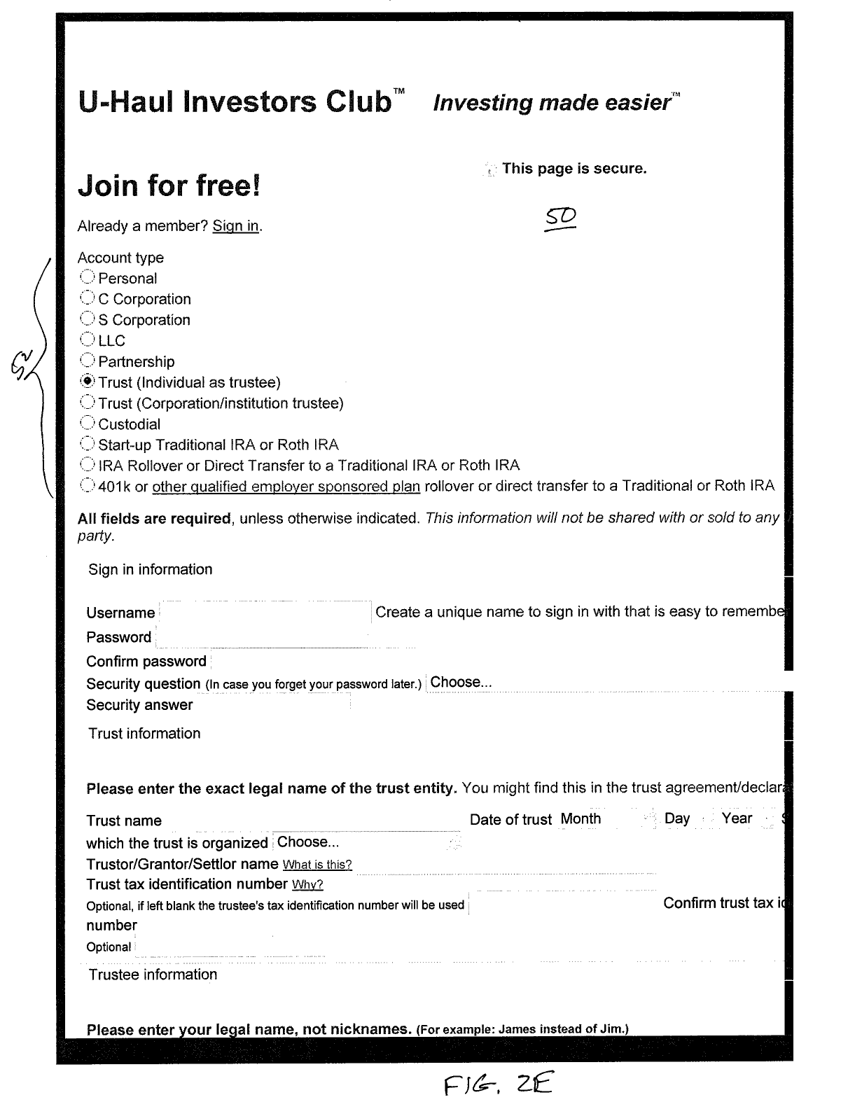

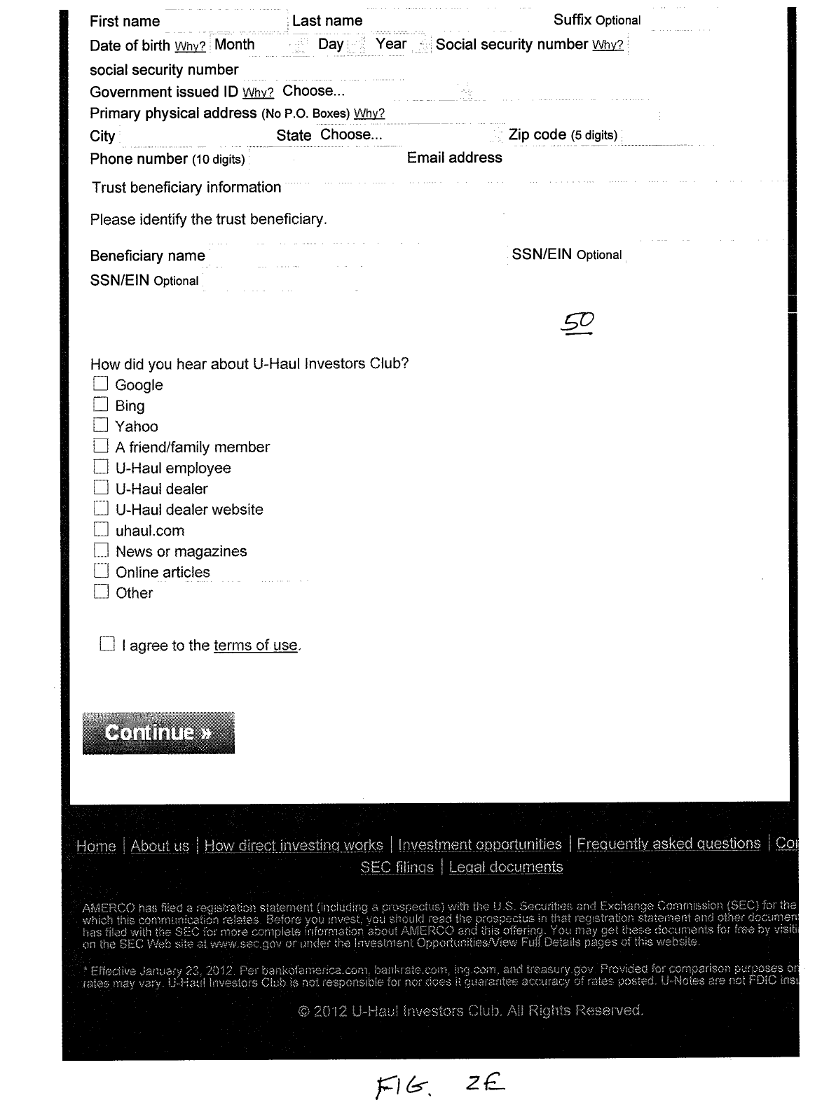

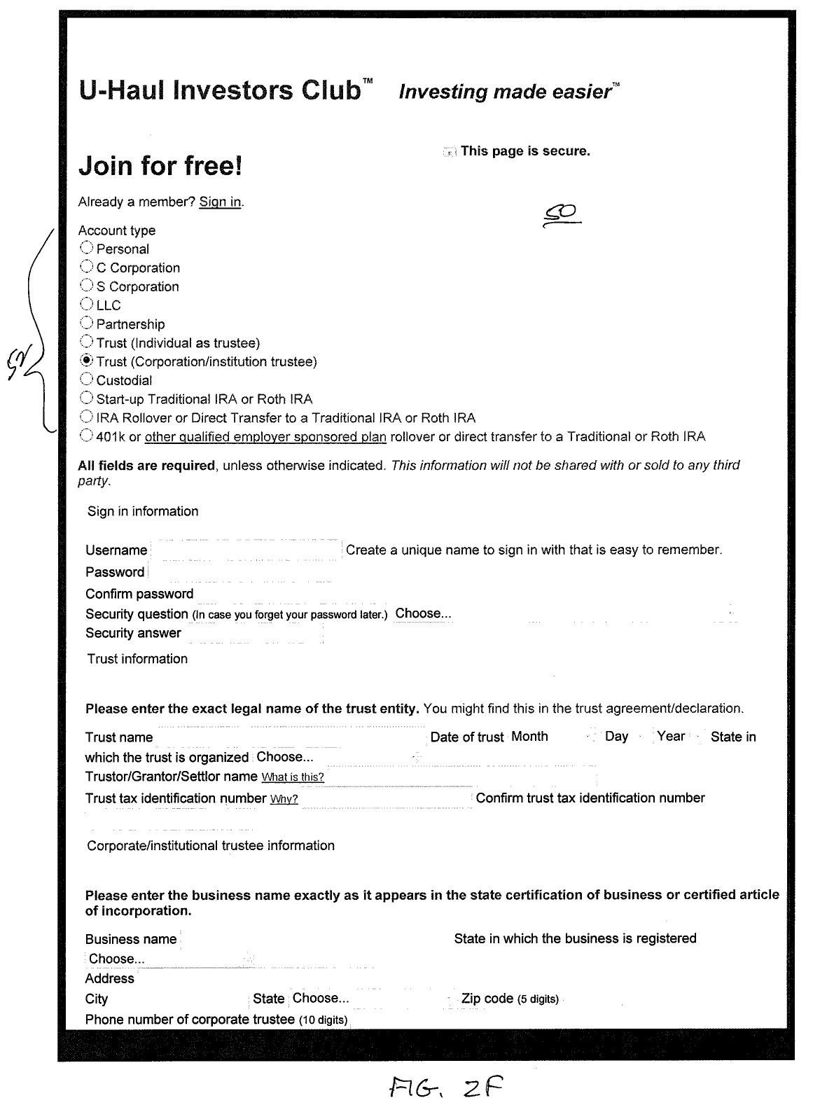

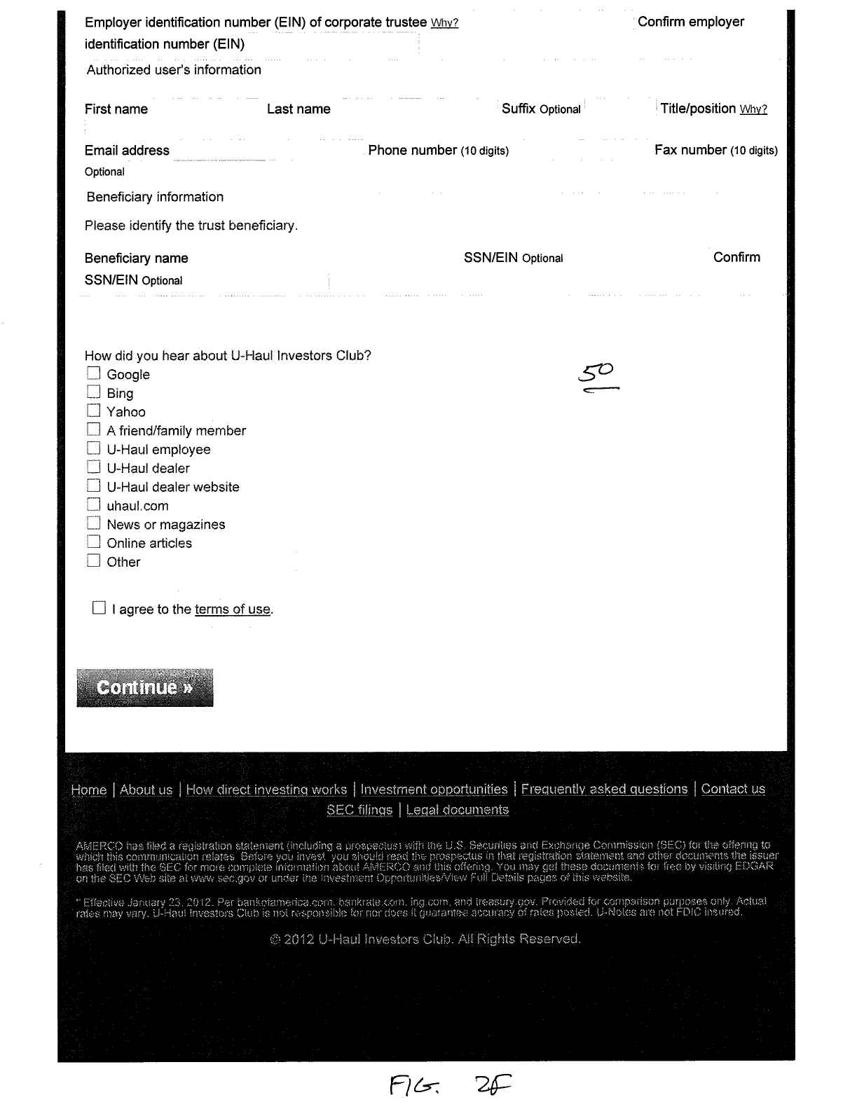

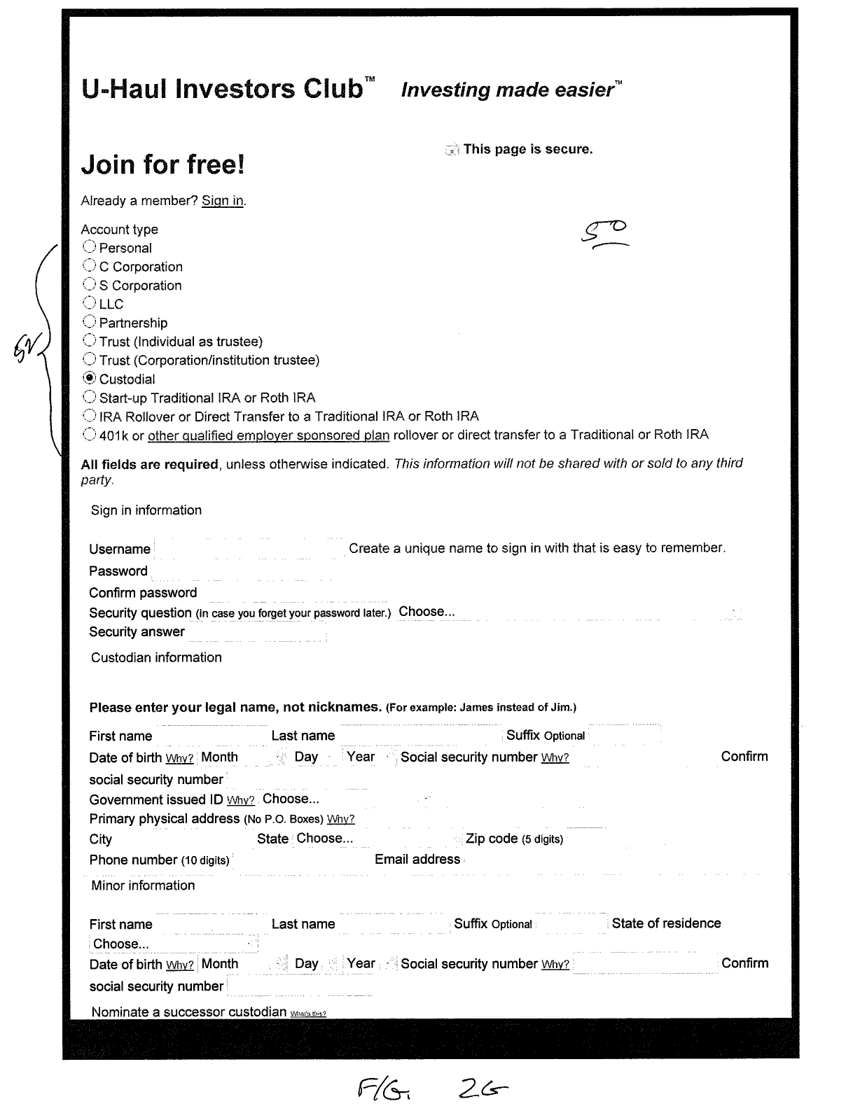

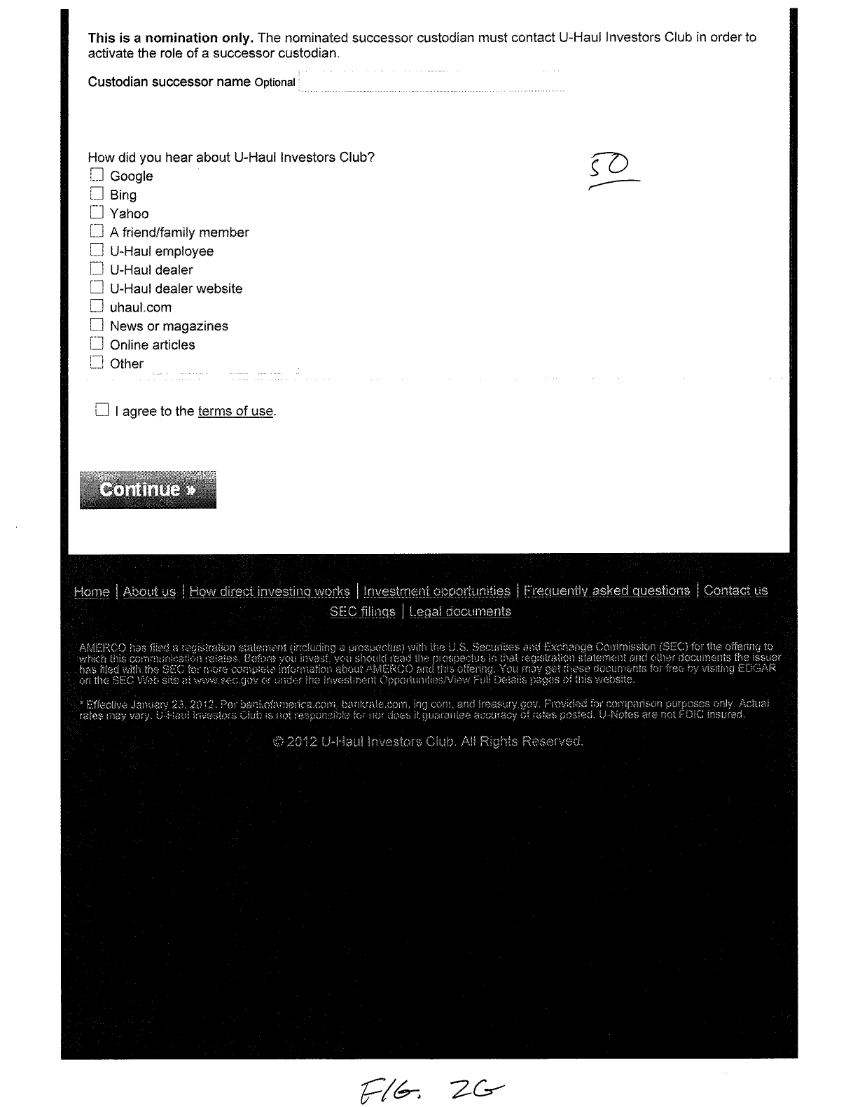

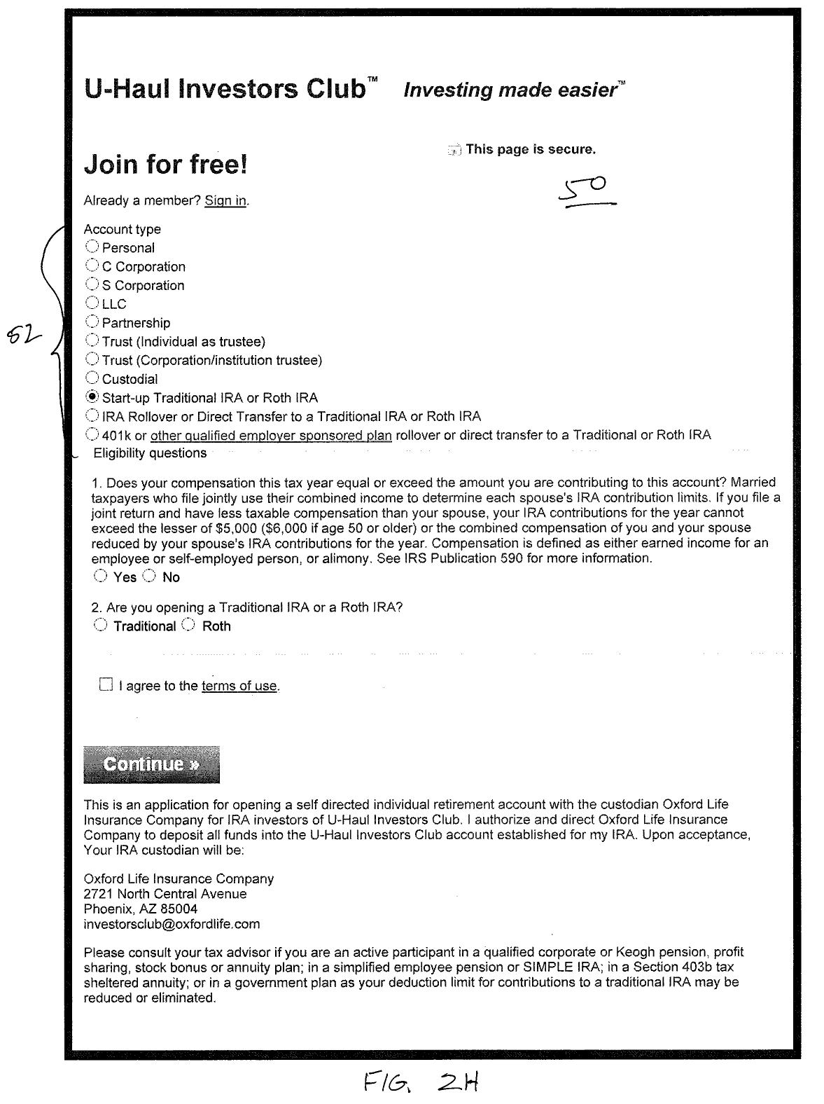

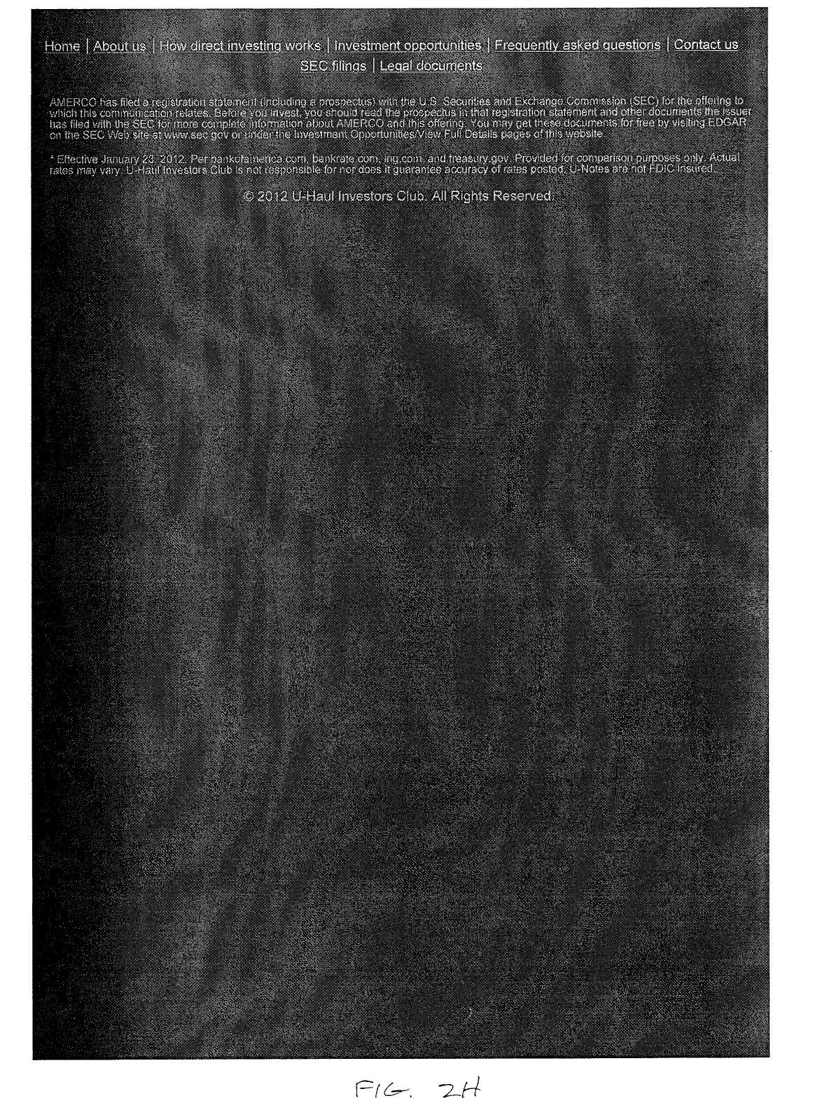

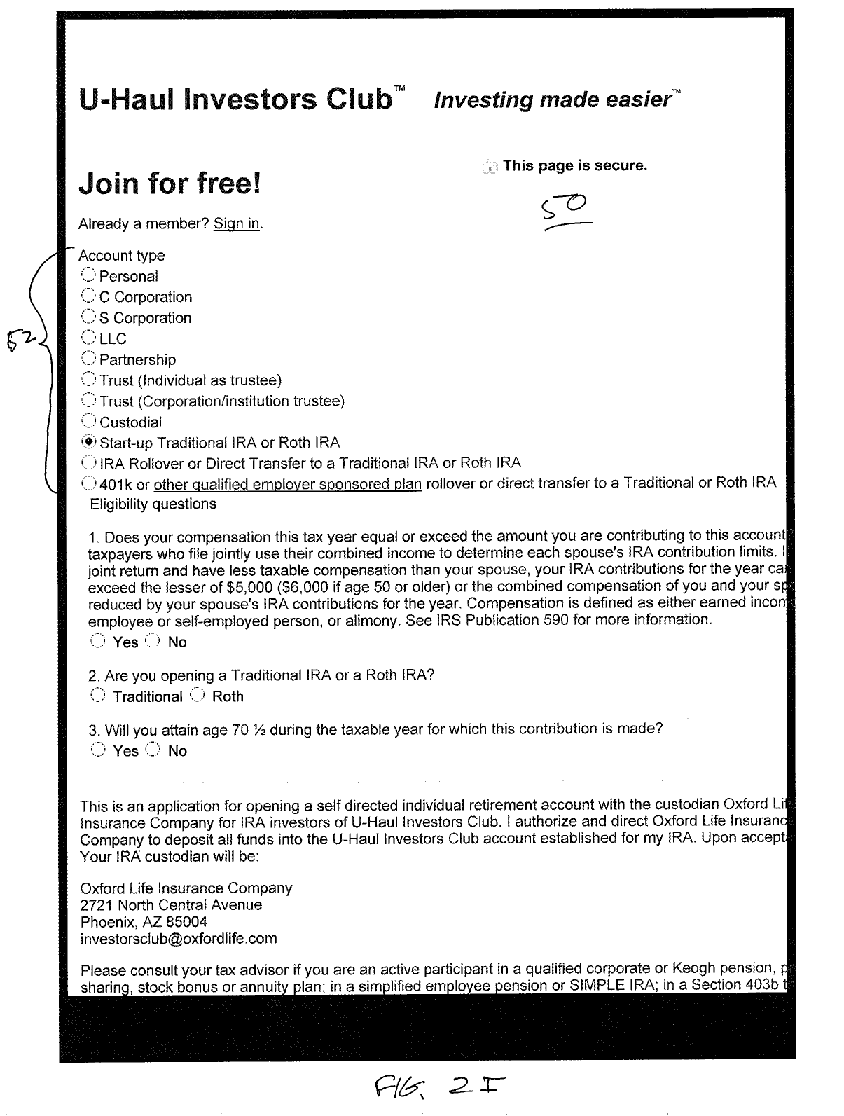

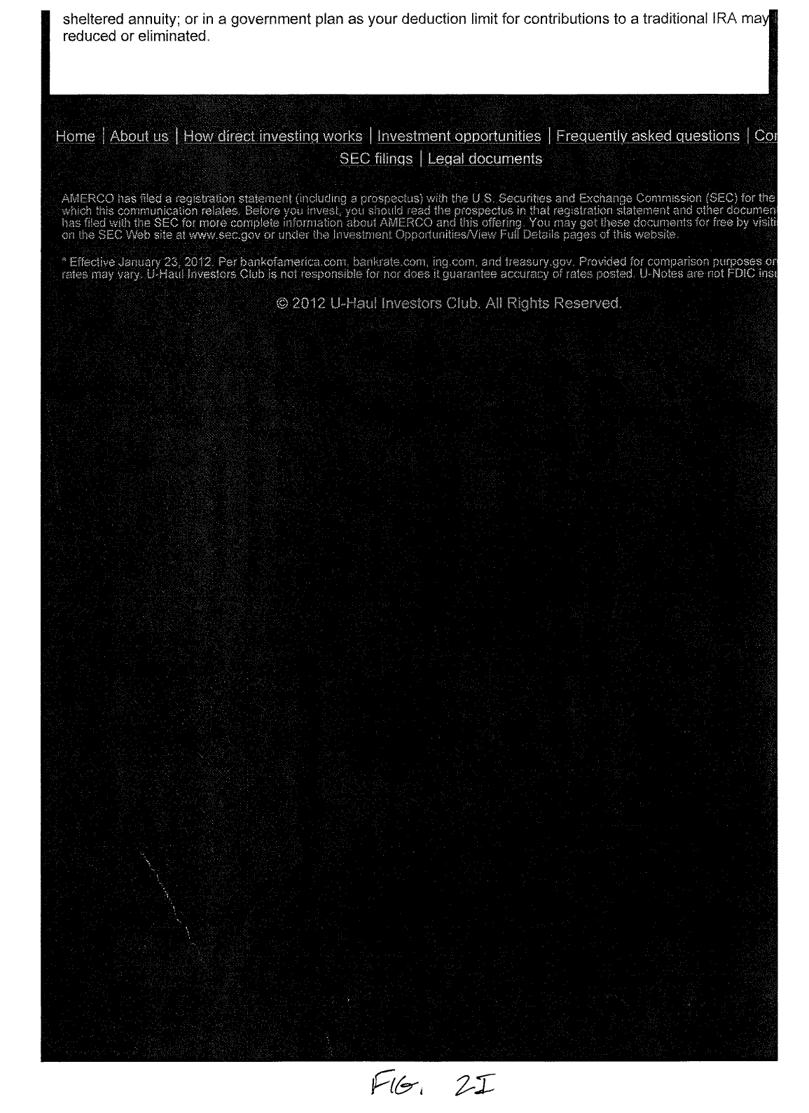

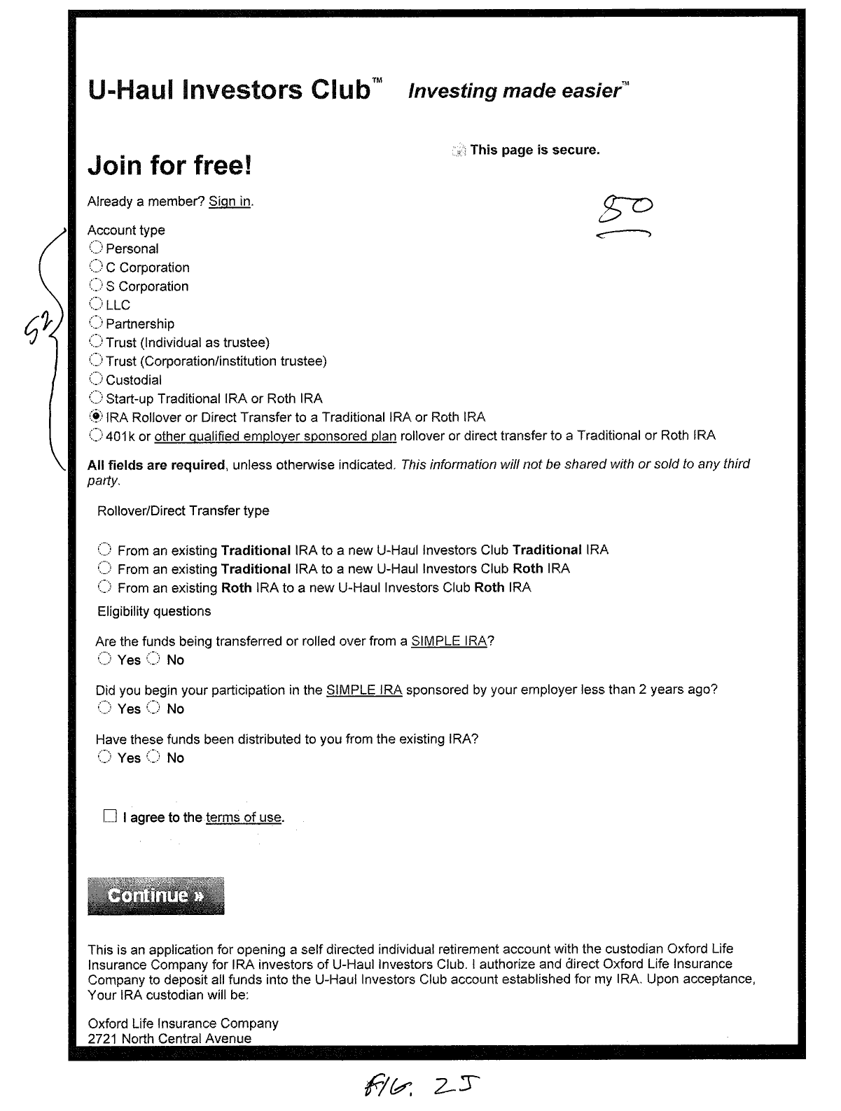

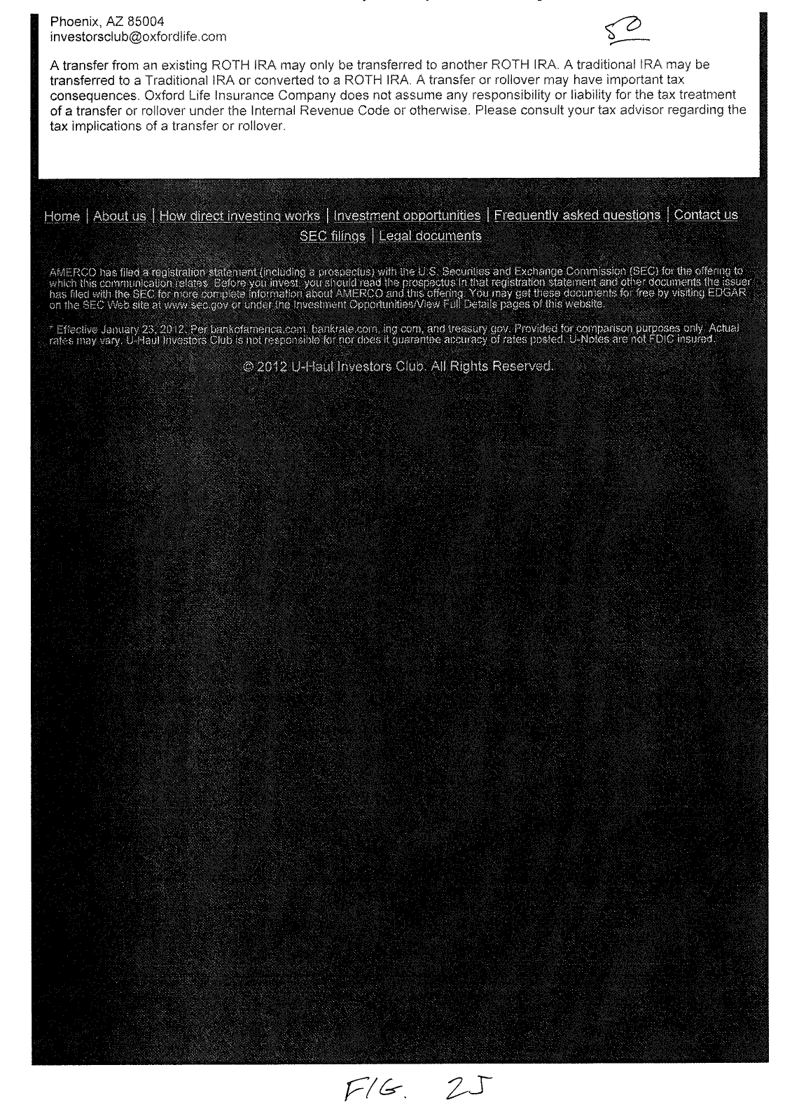

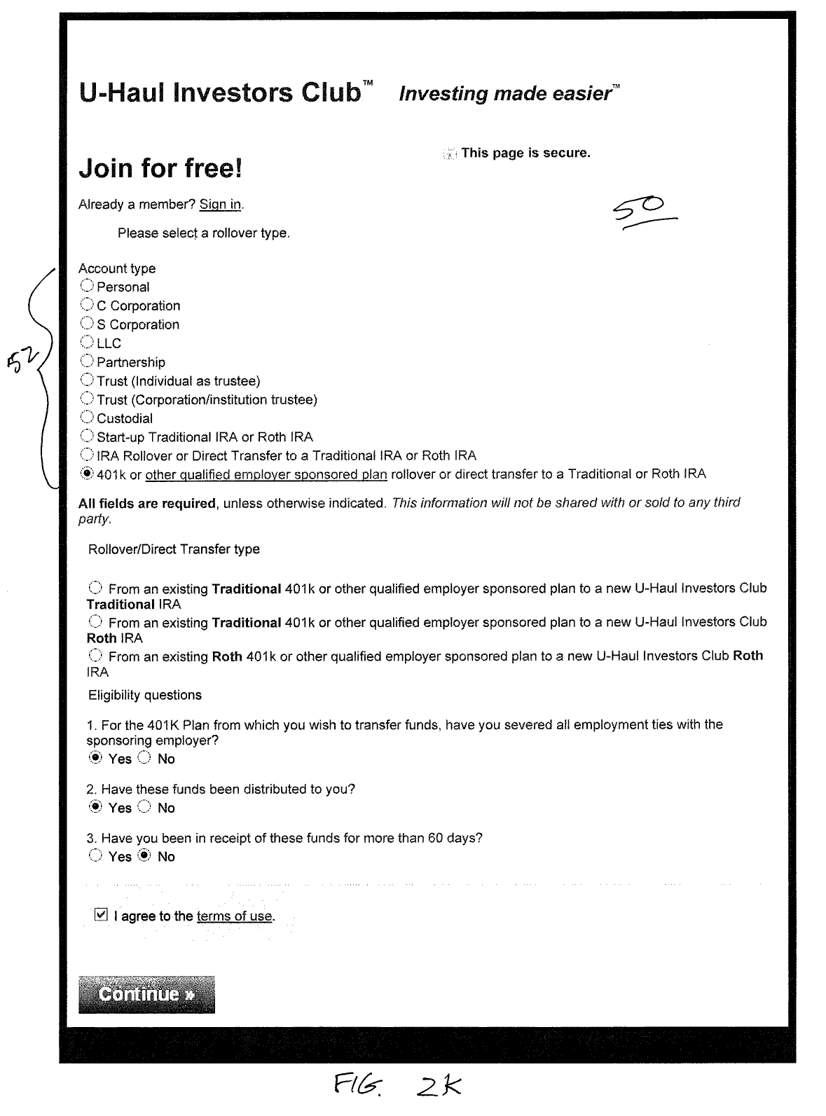

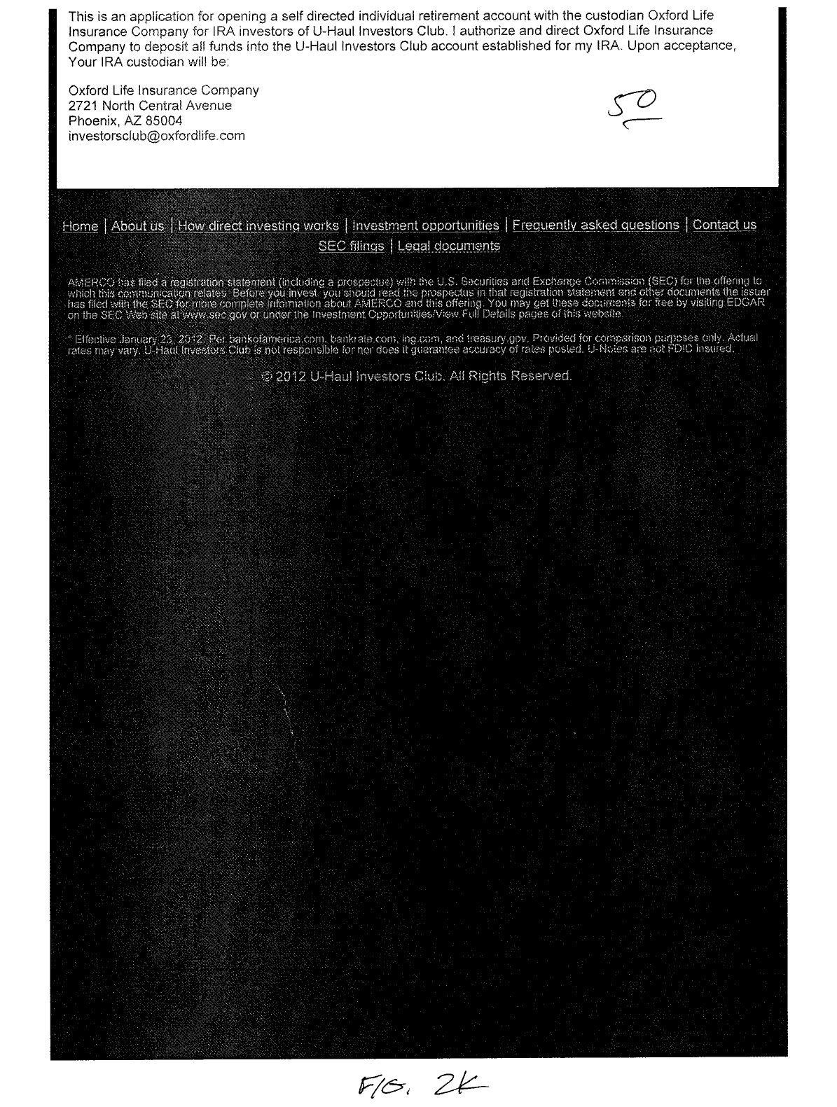

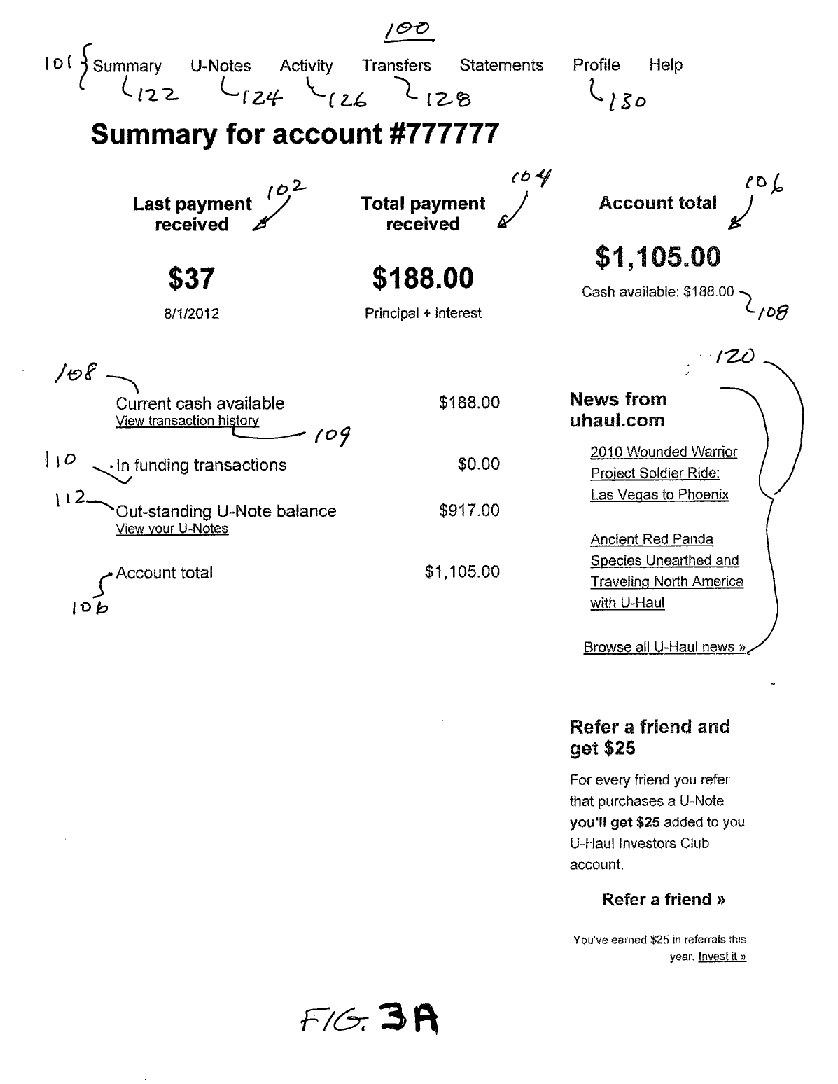

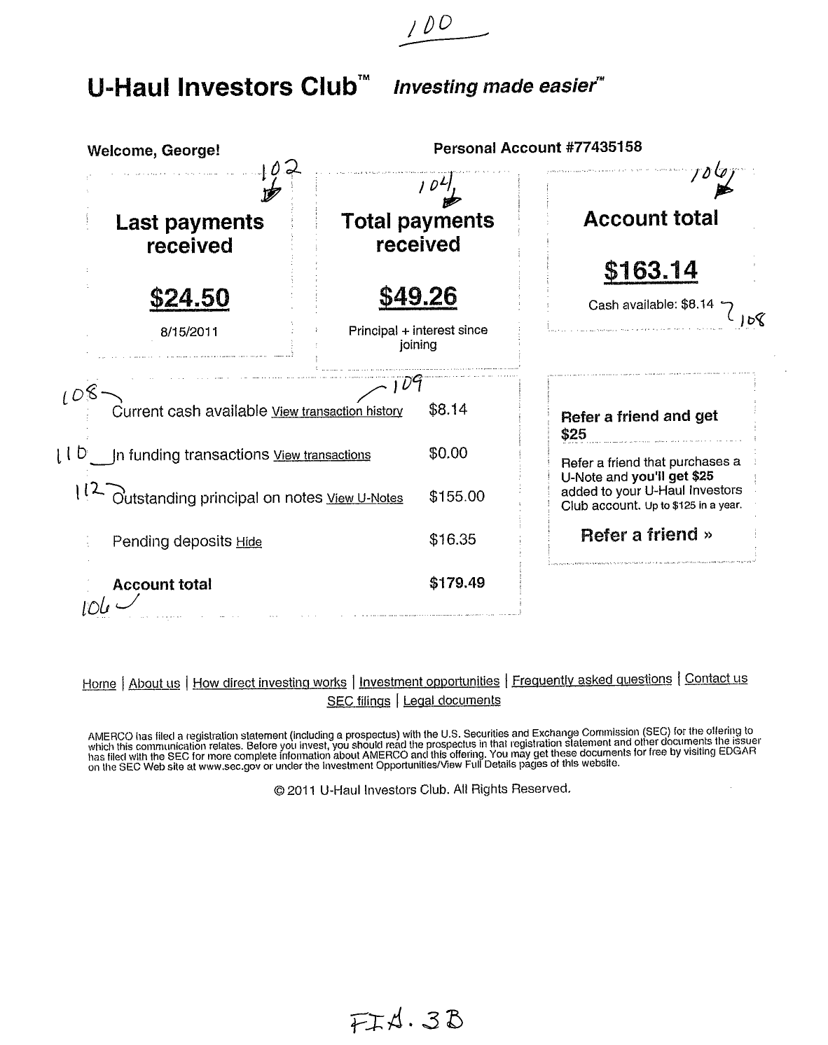

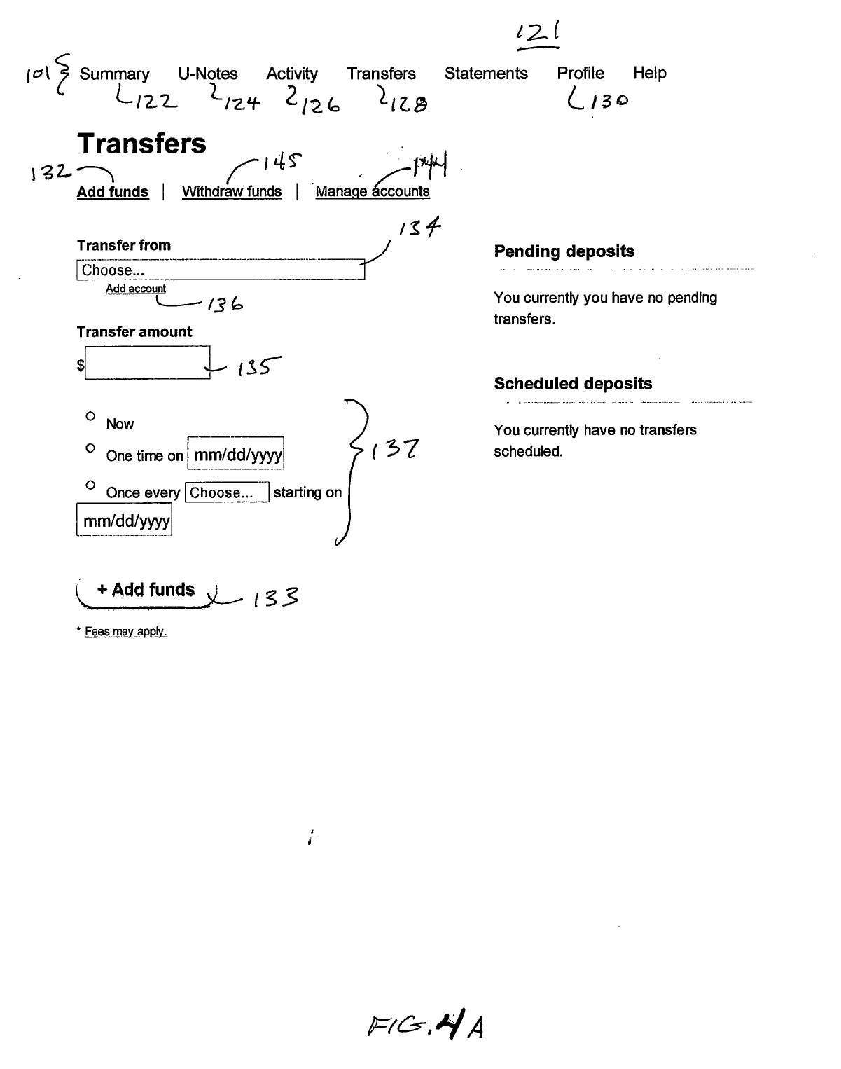

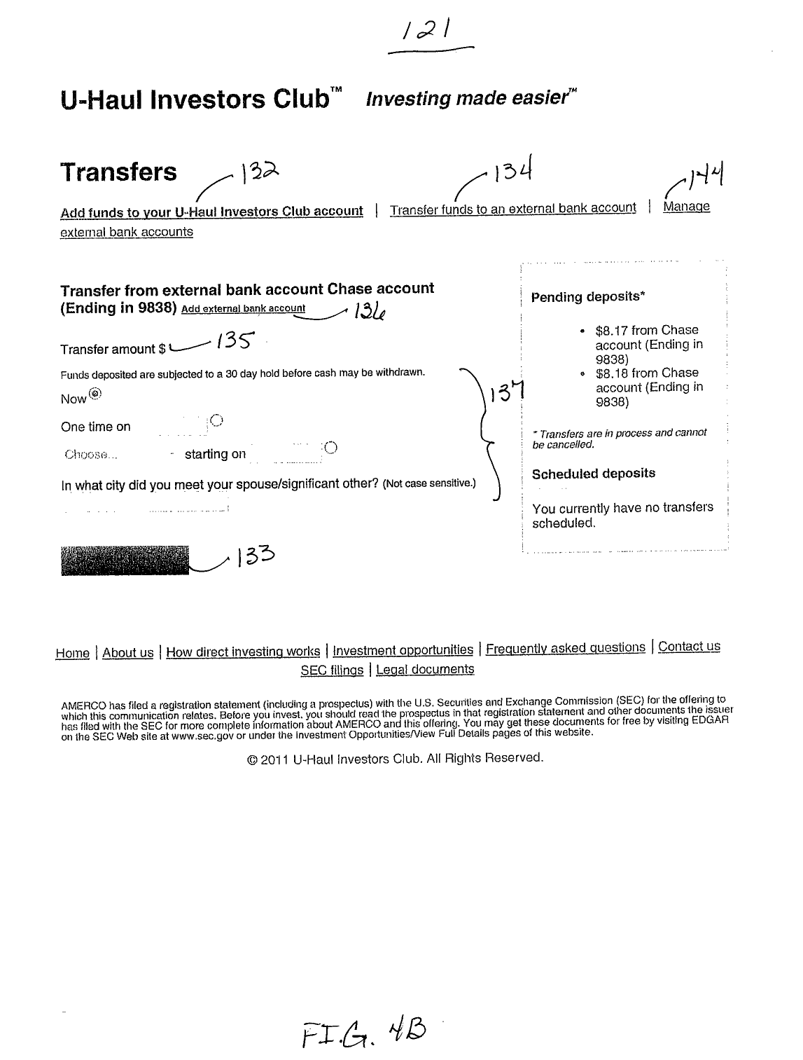

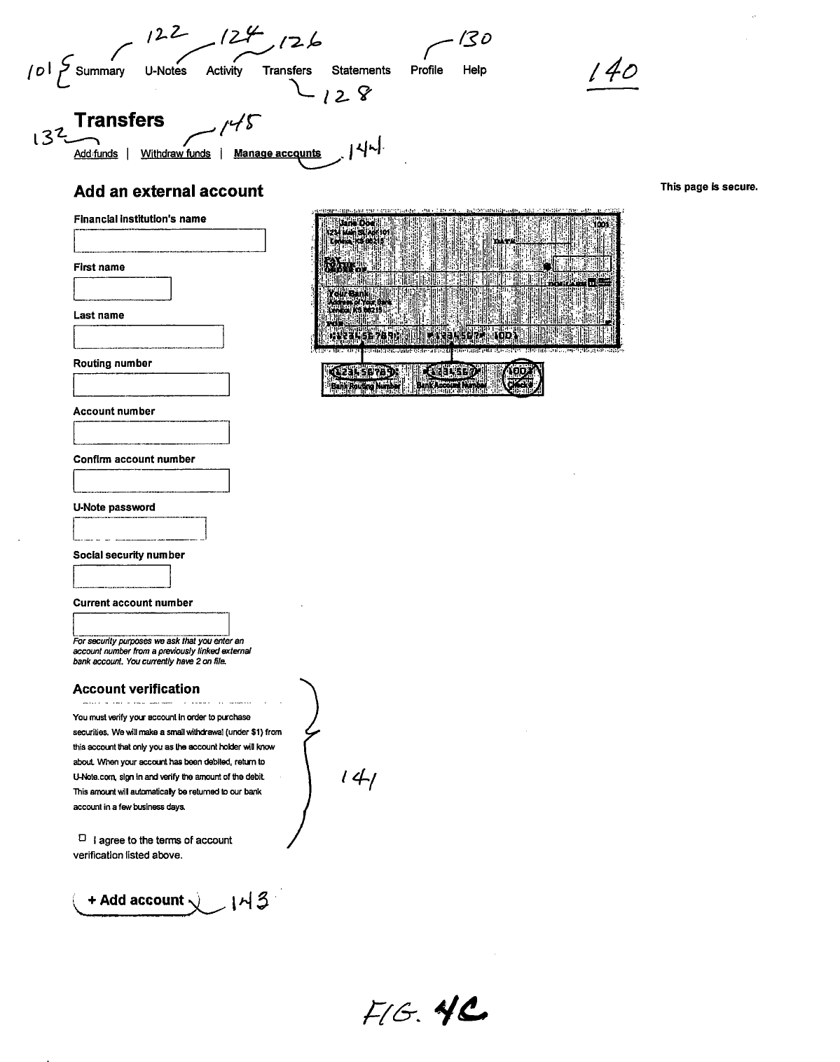

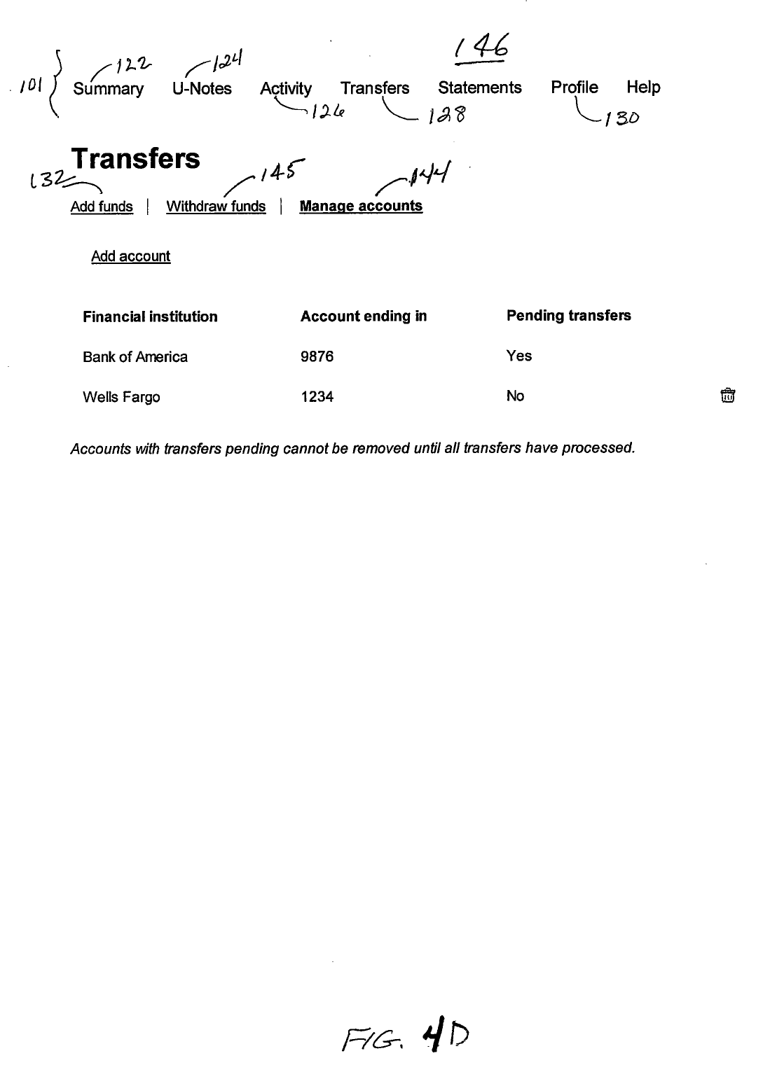

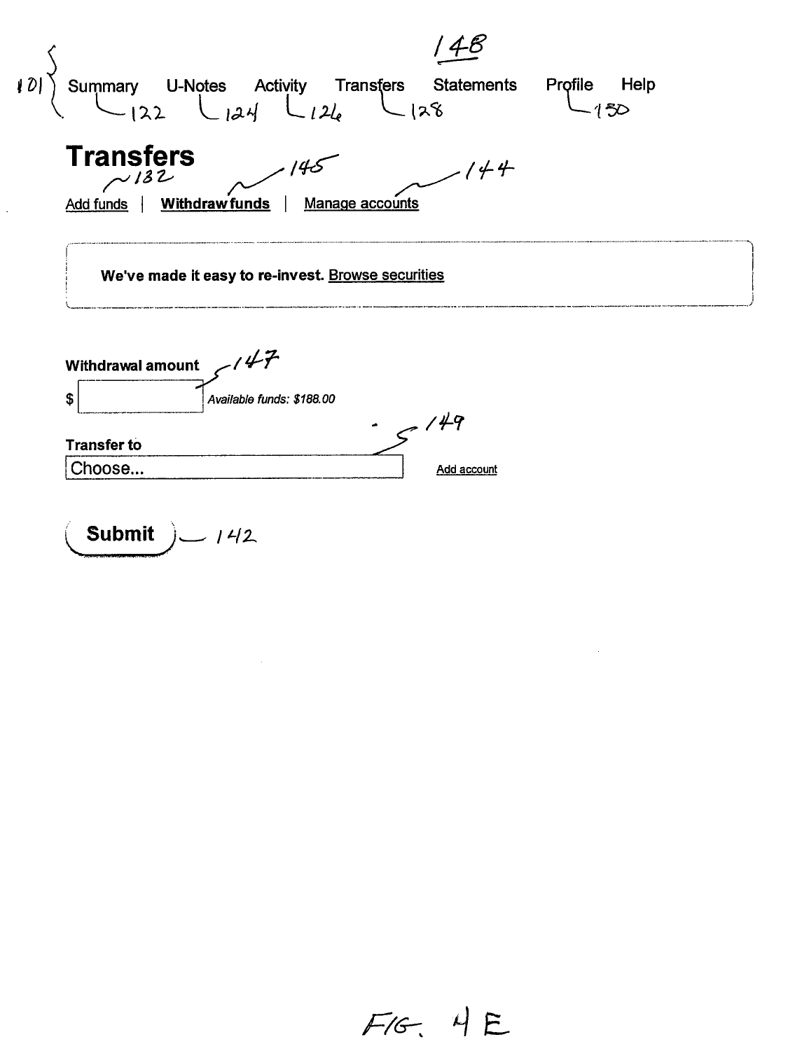

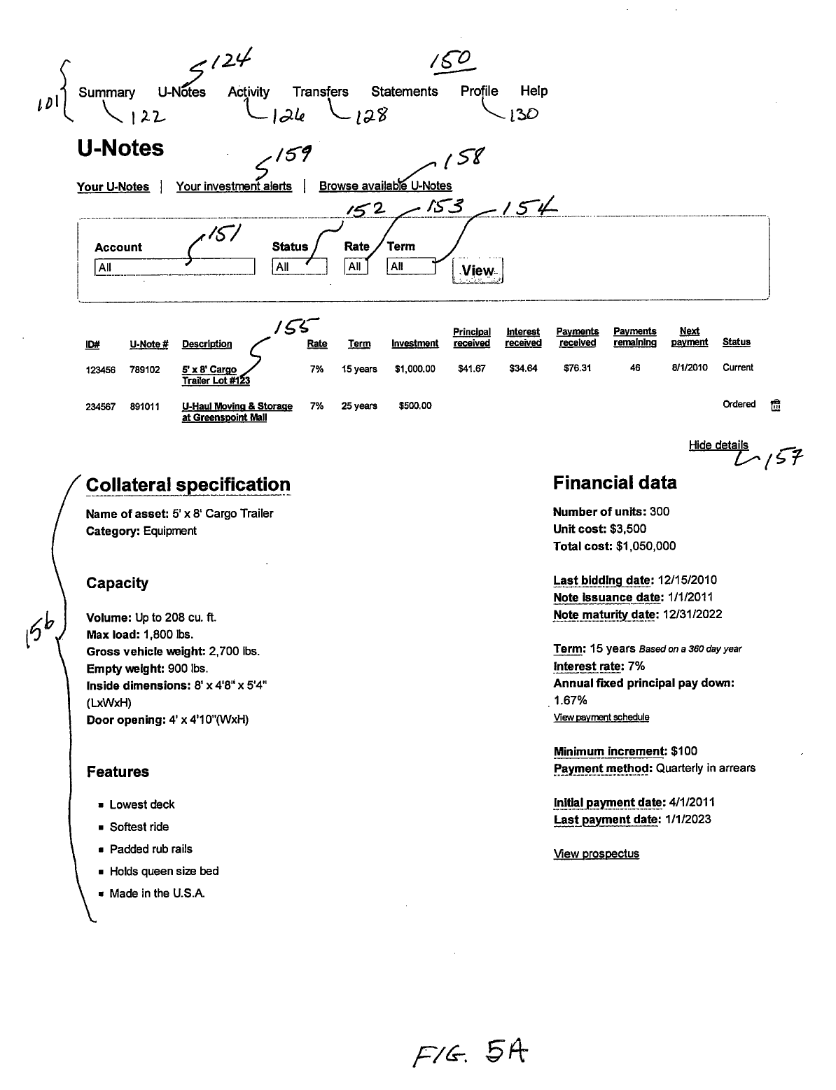

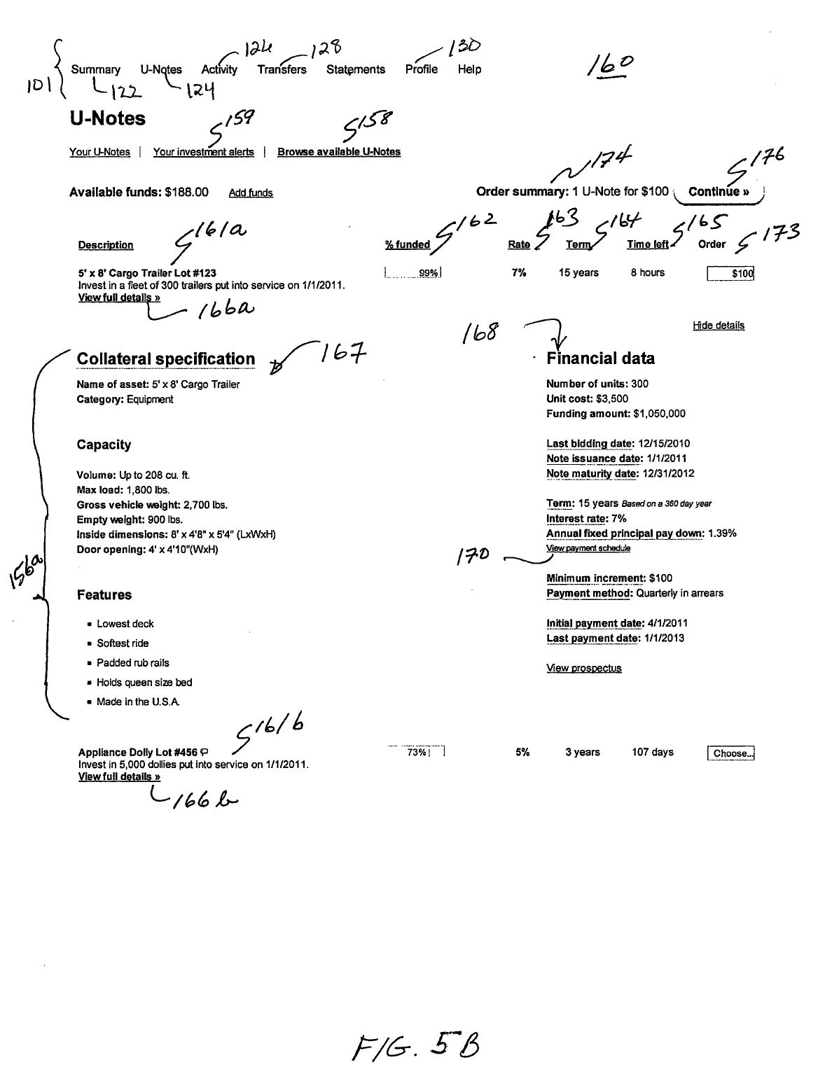

FIGS. 2-22 illustrate the operation of the system 10. Once a user has been set up as an investor in the securities management computer system 16, the user can login to the system using his or her username and password.

### Investor Accounts

According to one aspect of the invention, a user can establish one or more system accounts, which are utilized to receive payments from and make payments to the user. Funds added by the user and payments on notes held by the user are credited to the user's system account(s). A user can add funds to the balance of their system account by using the system to initiate an electronic funds transfer from an external account, such as the user's bank account, to a bank account of the issuer. After the transfer clears and any appropriate settlement time period, the user's system account is credited with the amount of the transfer. To make a payment on a note held by the issuer, the system credits the user's system account with the amount of the payment. The user can (i) invest (or reinvest) any available balance in the system account(s), (ii) make withdrawals of the available balance, or (iii) leave the available balance alone.

### Investor Interface

FIG. 2 shows an exemplary screen display of an Account Setup page 50 by which a user can set up a system account. The Account Setup page 50 includes an Account Type list 52 for selecting the type of account that the user wishes to set up. As shown in FIG. 2, in a presently preferred embodiment, the type of account can be selected from the following: Personal; C Corporation; S Corporation; LLC; Partnership; Trust (individual as trustee); Trust (corporation/institution trustee); Custodial; Start-up Traditional IRA or Roth IRA; IRA Rollover or Direct Transfer to a Traditional IRA or Roth IRA; 401K (or other qualified employer sponsored plan) Rollover or Direct Transfer to a Traditional IRA. The Account Setup page 50 displays data input fields 54 to prompt the user to input user information required by the system based on the selected account type. For example, the Account Setup page 50 of FIG. 2 shows the Personal account type selected from the Account Type list 52, with the corresponding input fields 54 displayed for the user to enter required information, along with some optional information, for a personal account. FIGS. 2A-2K show the Account Setup page 50 with each of the respective account types selected from the Account Type list 52 and displaying the corresponding input fields 54 for the selected account type.

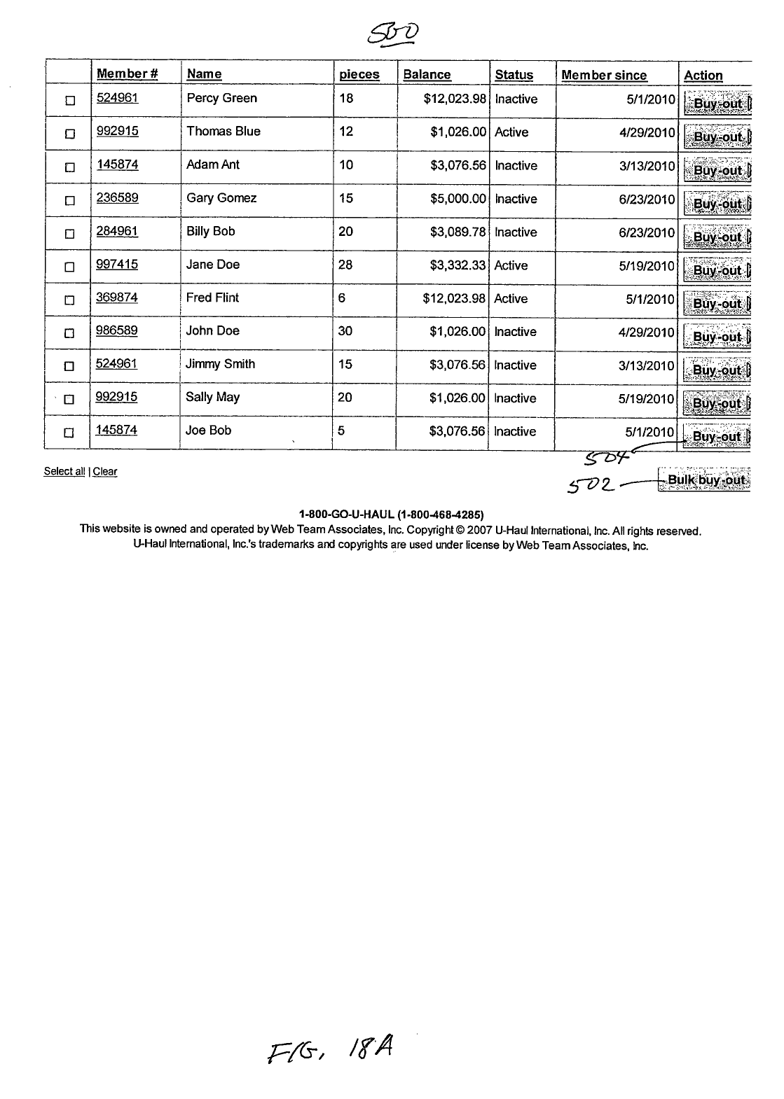

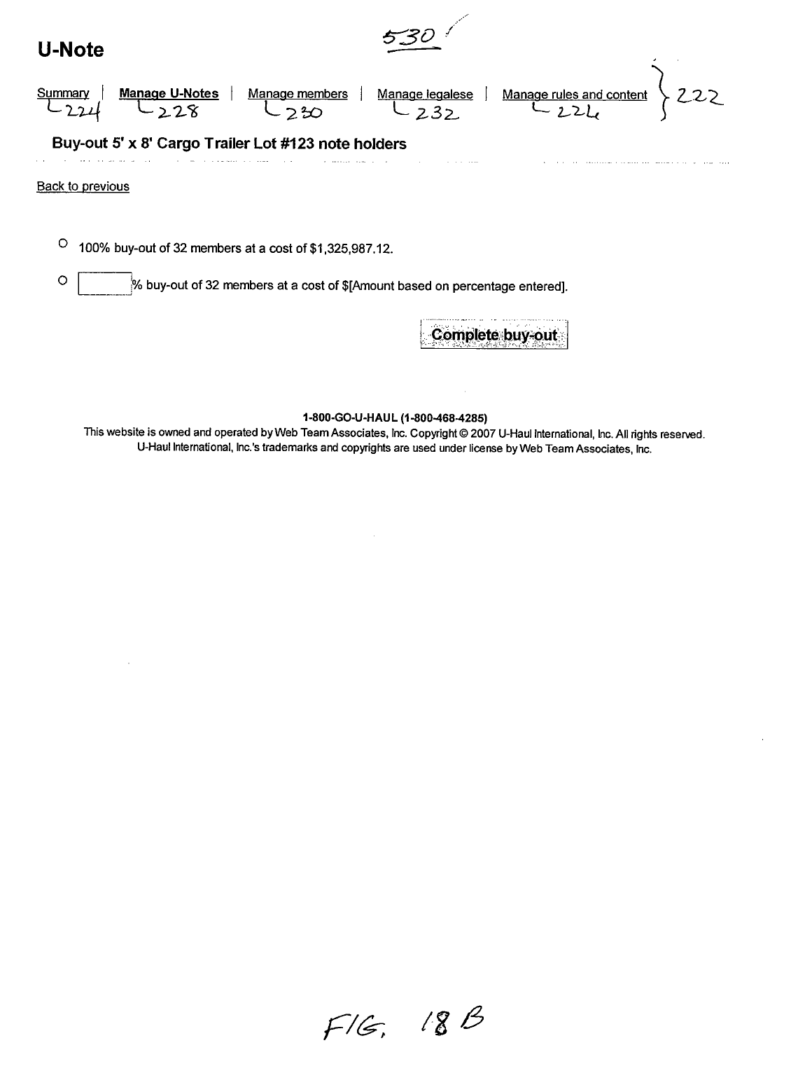

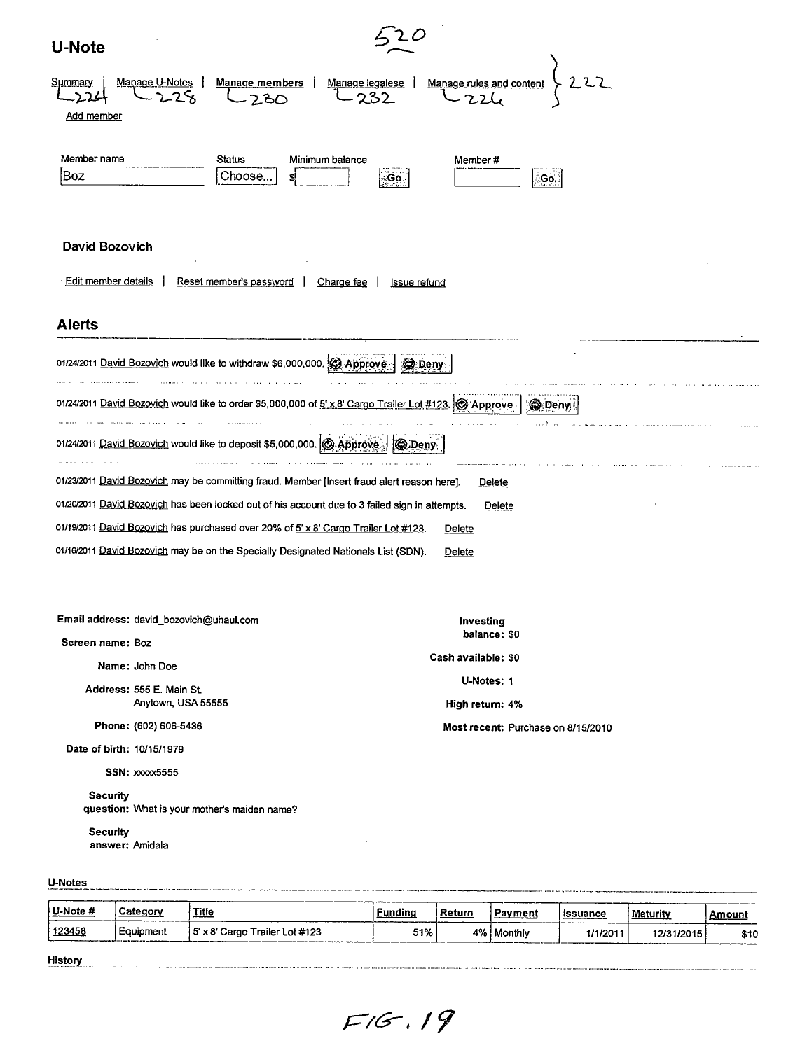

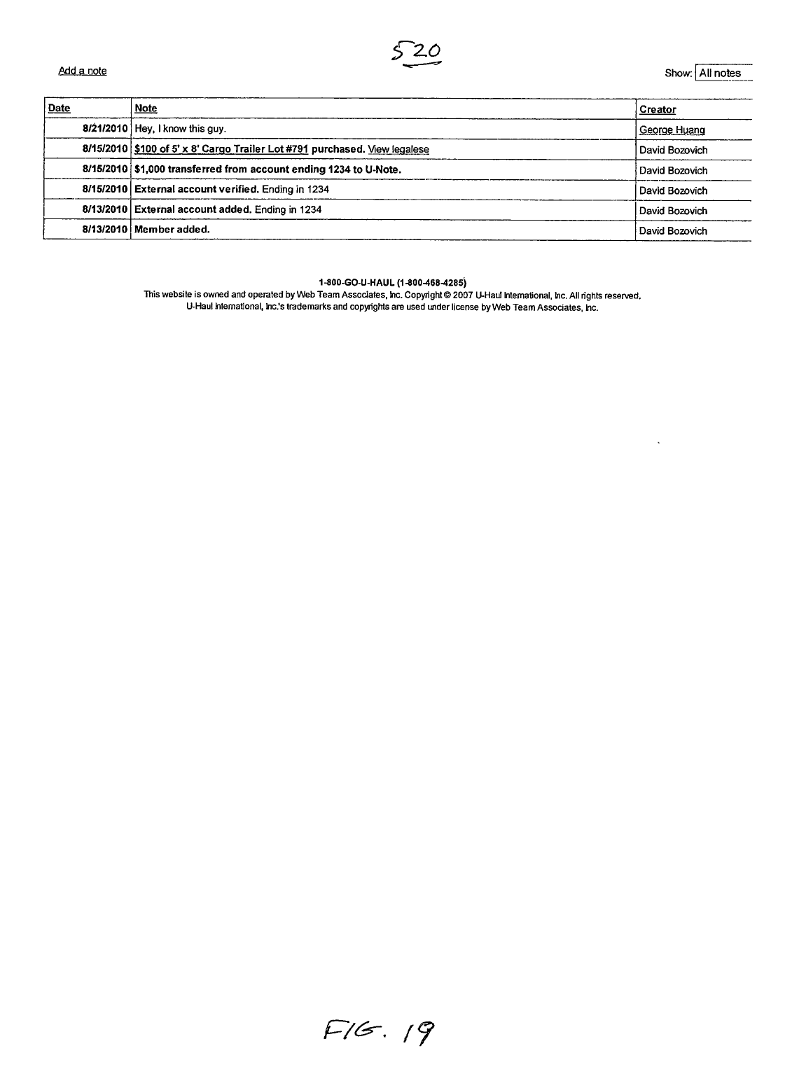

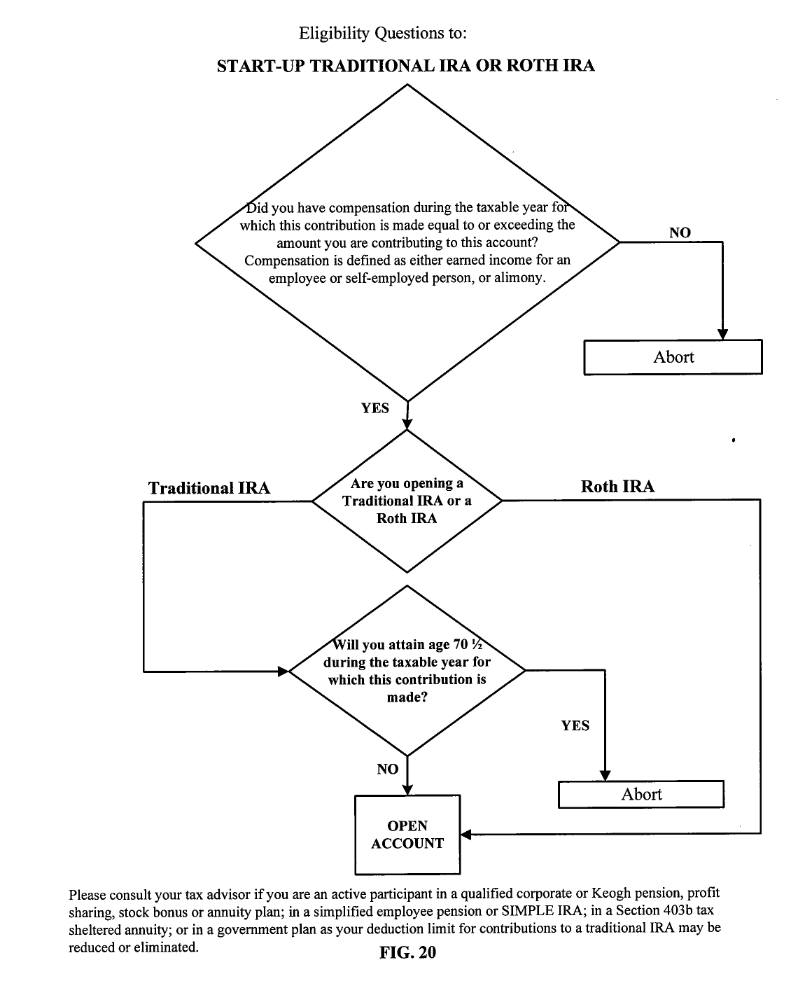

Referring to FIGS. 2H-I, the Account Setup page 50 shows the Start-up Traditional IRA or Roth IRA option selected from the Account Type list 52. When the user selects this option, the system presents the user with a series of eligibility questions, as shown in the flowchart of FIG. 20, to determine whether the user will be allowed to open the requested account within the system.

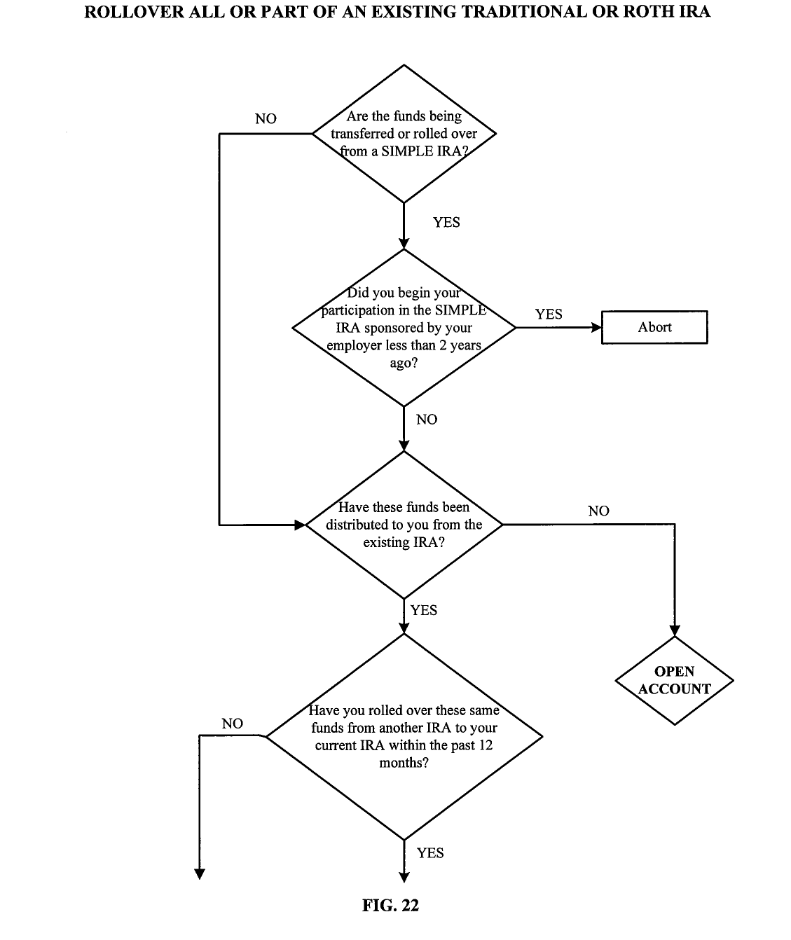

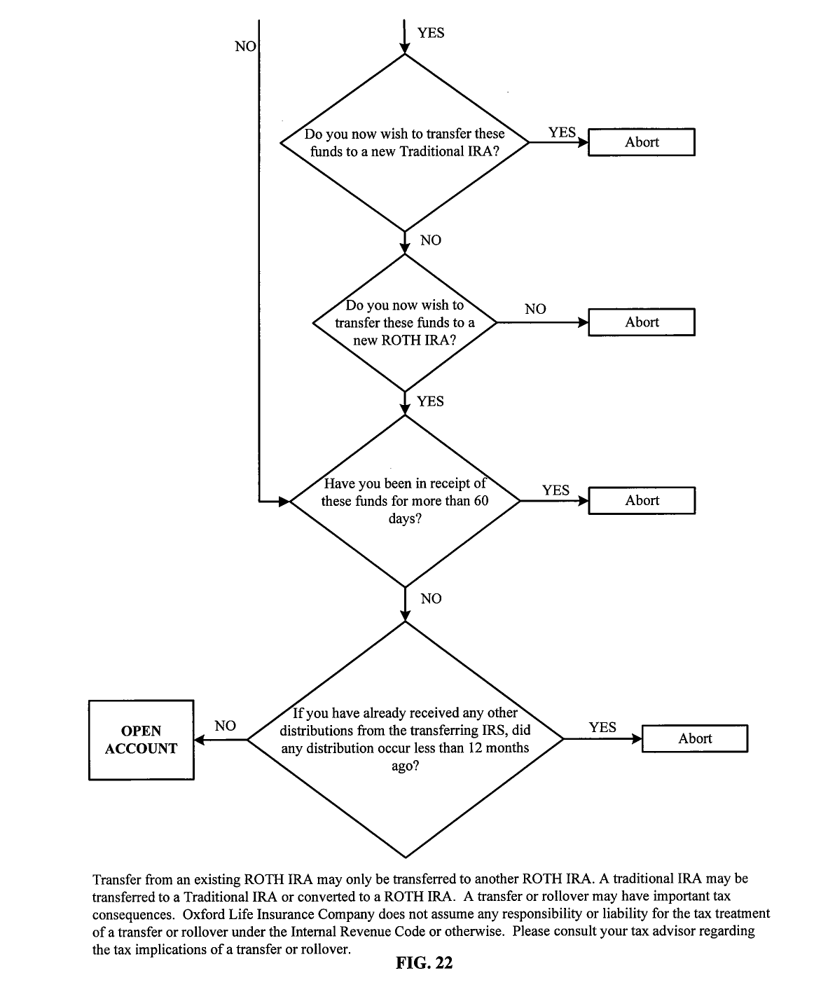

Referring to FIG. 2I, the Account Setup page 50 shows the IRA Rollover or Direct Transfer to a Traditional IRA or Roth IRA option selected from the Account Type list 52. When the user selects this option, the system presents the user with a series of eligibility questions, as shown in the flowchart of FIG. 22, to determine whether the user will be allowed to open the requested account within the system.

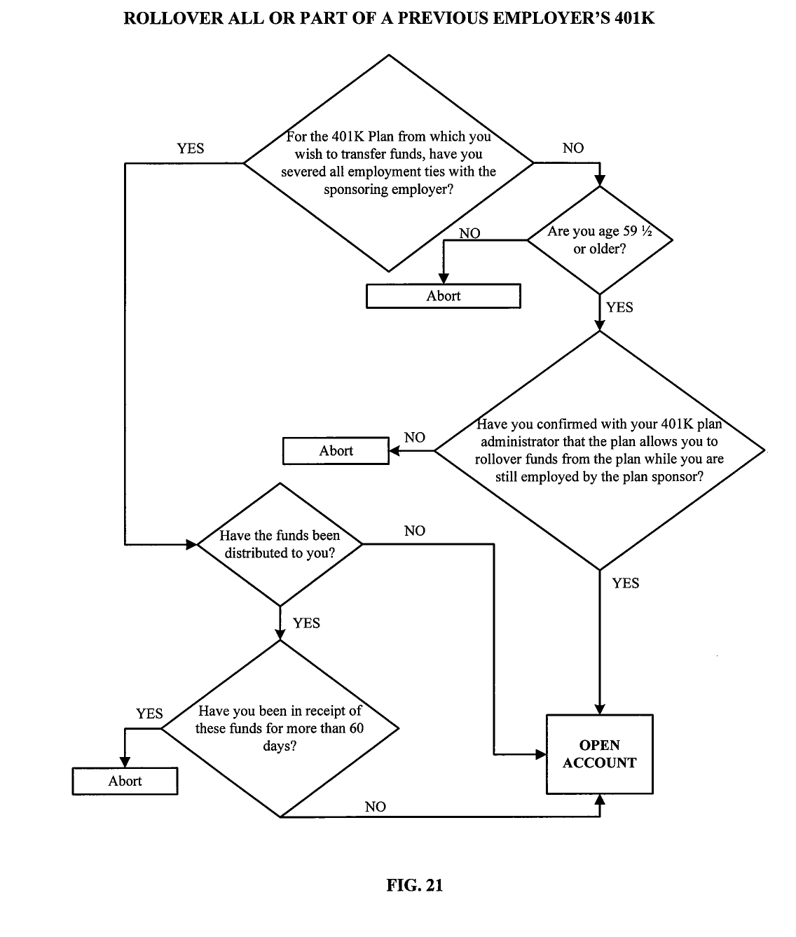

Referring to FIG. 2K, the Account Setup page 50 shows the 401K Rollover or Direct Transfer option selected from the Account Type list 52. When the user selects this option, the system presents the user with a series of eligibility questions, as shown in the flowchart of FIG. 21, to determine whether the user will be allowed to open the requested account within the system.

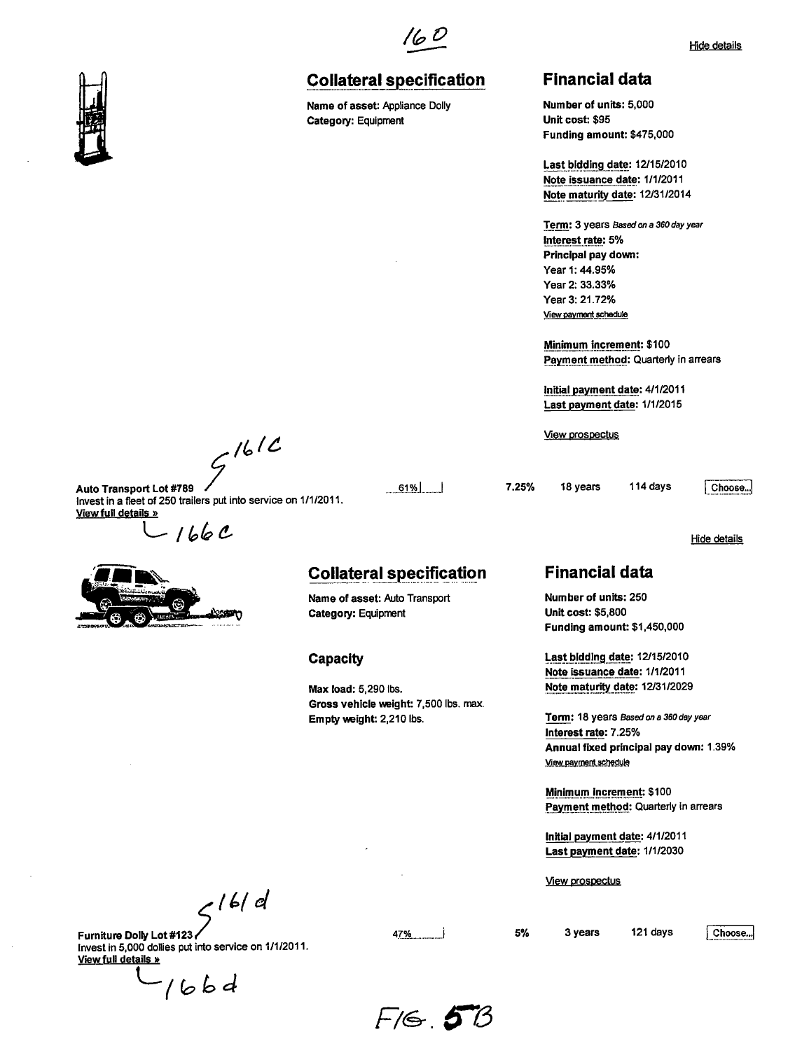

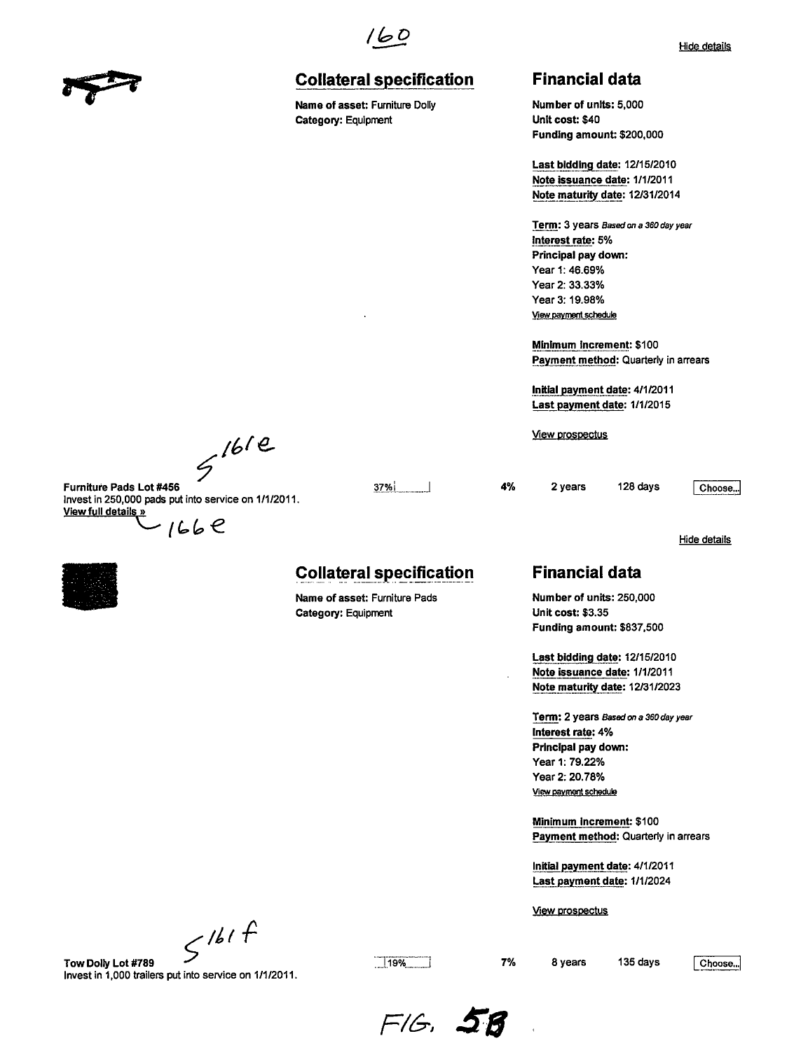

FIGS. 3A and 3B show two alternative exemplary displays of an Account Summary page 100 that is served by the securities management system 16 to the user computer 11 after the user 12 has logged into the system 16. The Account Summary page 100 displays information regarding the last payment received in the user's account 102, the total principal and interest payments received 104, the total amount in the user's system account 106, the current cash amount available in the user's system account 108, the amount in funding transactions 110, which represents the funds in the user's system account that are unavailable because they have been committed to the purchase of one or more securities that are in the process of being funded, and the outstanding principal balance 112 on the notes that the user has purchased. The Account Summary page 100 also includes a View Transaction History link 109 for displaying the user's transaction history. As shown in FIG. 3A, the Account Summary page 100 can include a user navigation menu 101 for navigating the website, and it can include a News section 120 with links to newsworthy information.

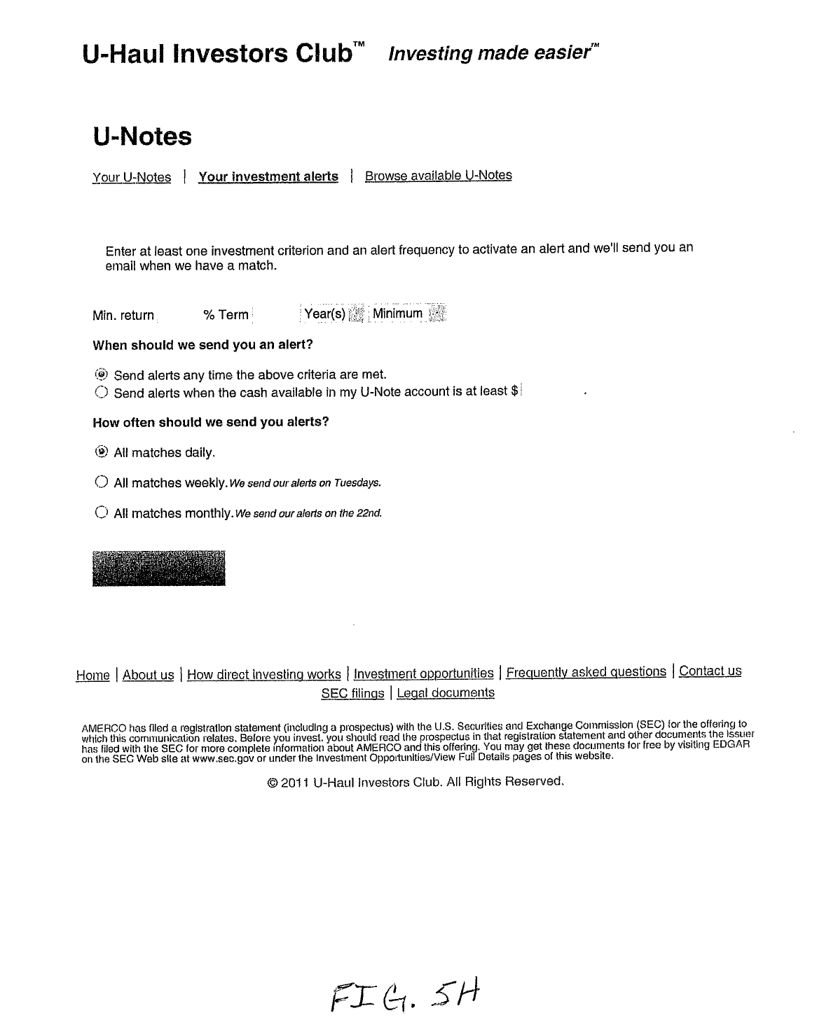

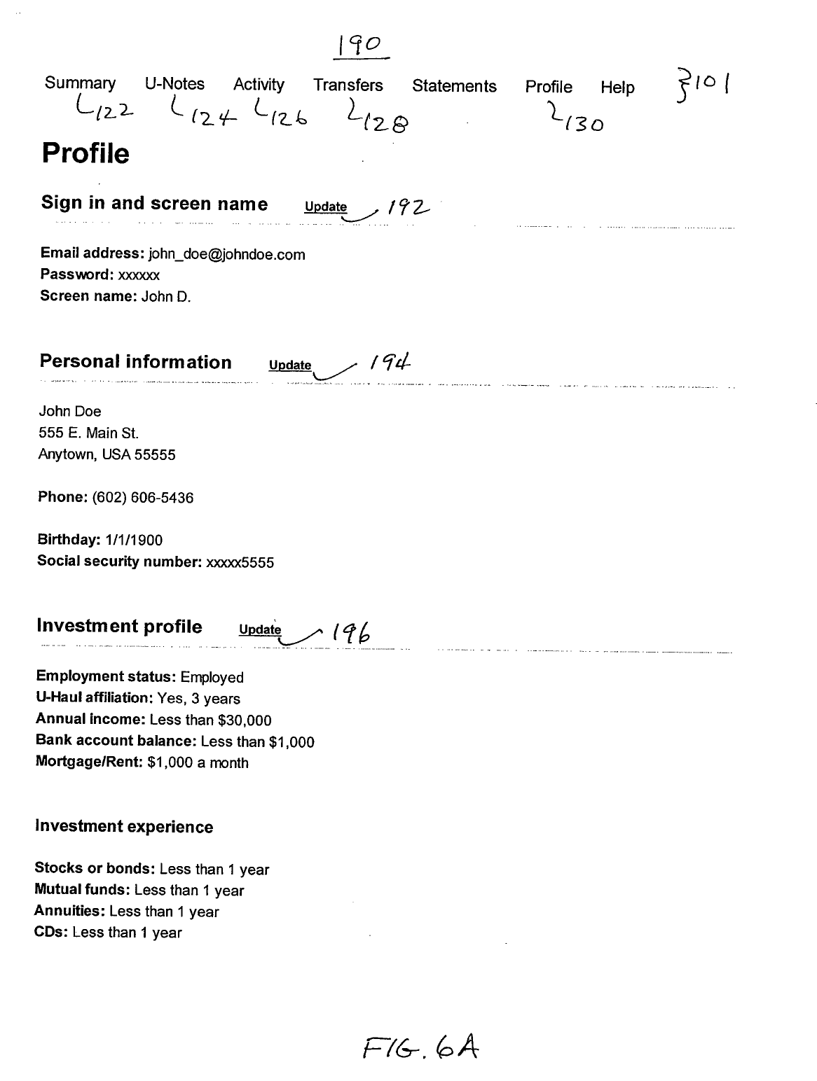

In the user navigation menu 101, a user can click on the Profile link 130 to view their Profile page 190, as shown in FIG. 6A. The Profile page 190 includes an Update Sign In link 192 to allow the user to update or change their sign in and screen name information, an Update Personal Information link 194 to allow the user to update or change their personal information, and an Update Investment Profile link 196. When the user selects the Update Investment Profile link 196, the securities management system 16 displays an Update Investment Profile page 198, as shown in FIG. 6B, for entering personal investment information, such as employment status, any affiliation with the securities issuer, years of investment experience, and the like. FIG. 6C shows a second example of an embodiment of the Profile page 190, which includes an Update Beneficiary link 197, which allows the user to update or change their beneficiary information.

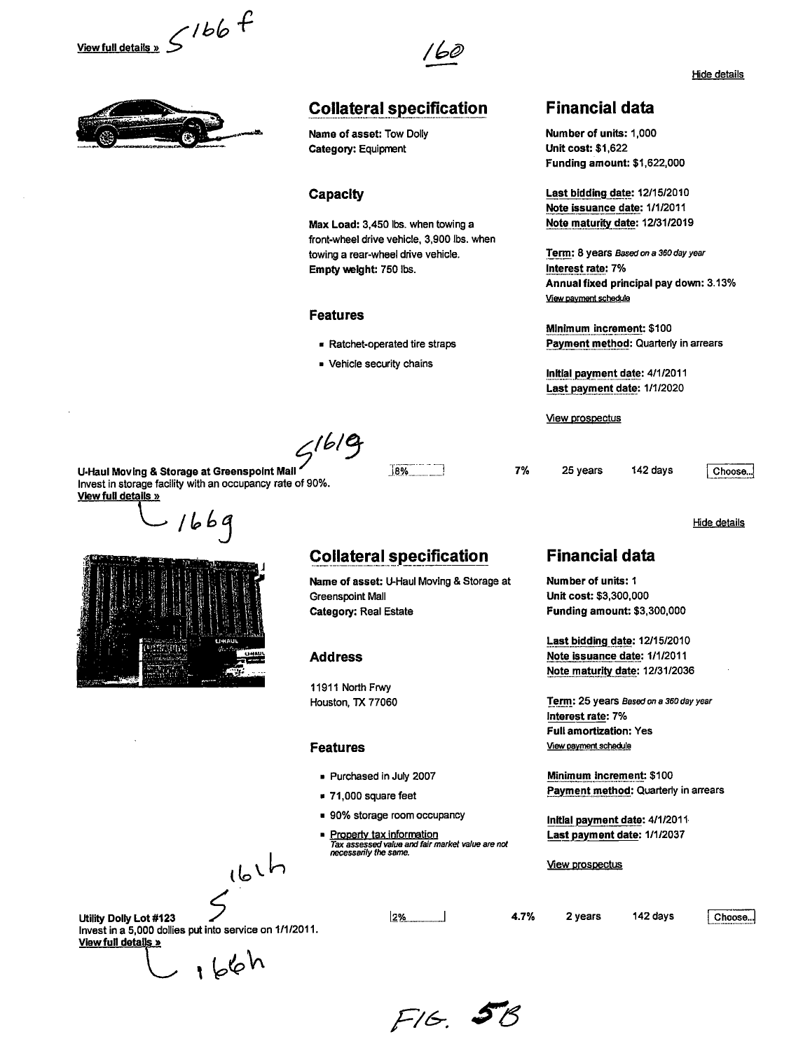

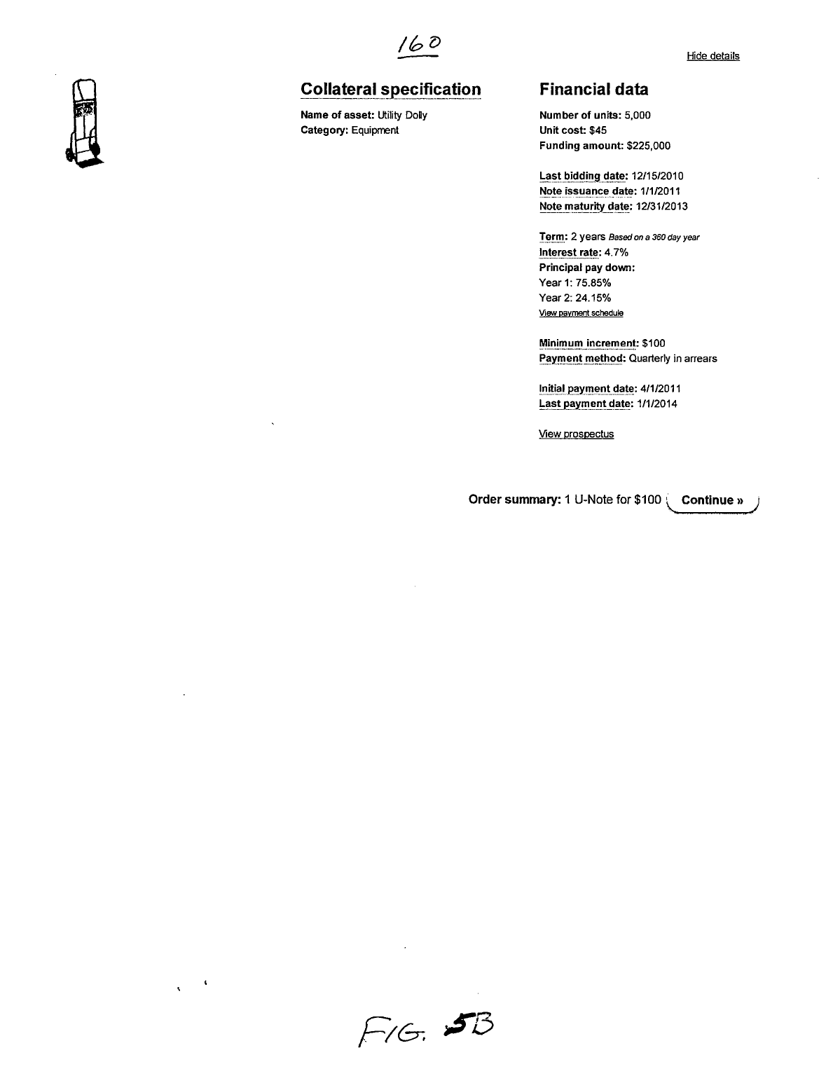

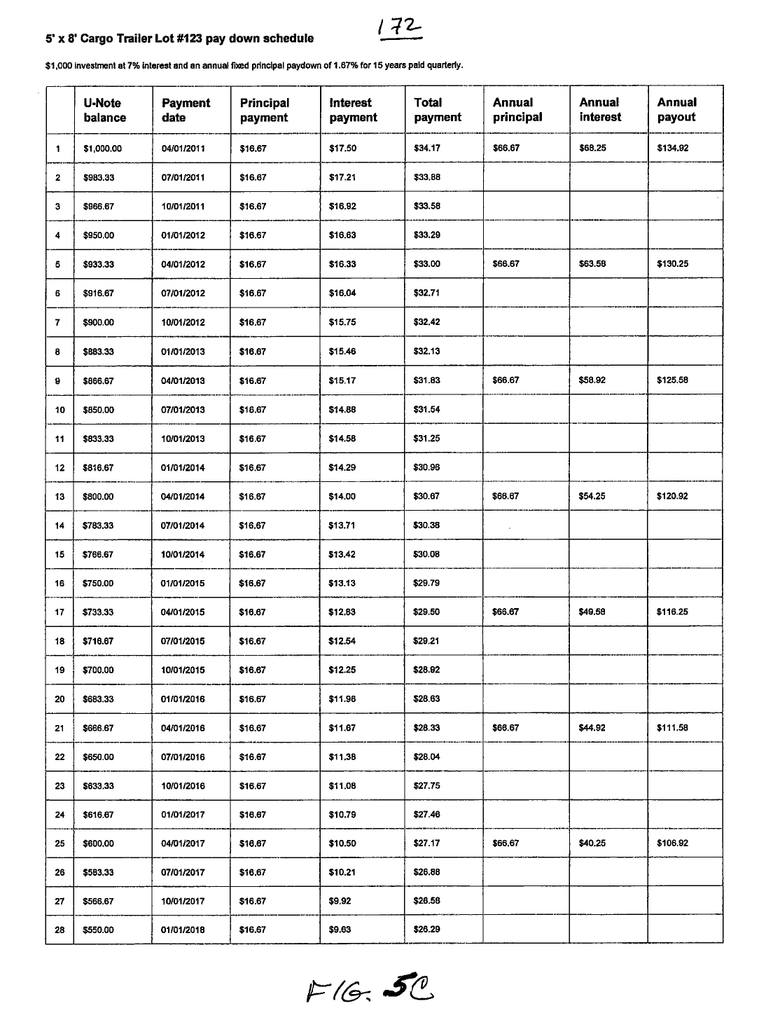

Also with the user navigation menu 101, the user can transfer funds to and from his or her account by clicking a Transfers link 128. In response, the securities management system 16 displays on the user computer 11a Transfers page 121, as shown in FIG. 4A. FIG. 4B shows a second embodiment of the Transfers page 121. To transfer funds to the user's account from an external account, such as a bank account, the user clicks on an Add Funds link 132, in response to which the system 16 displays the fields shown in FIG. 4A, from which the user chooses a bank account 134 from which to transfer funds, enters a transfer amount 135, selects a transfer time option 137, and clicks an Add Funds button 133. In response, the securities management computer system 16 initiates an electronic transfer of funds from the user's external account to a bank account of the issuer and credits the user's system account with the amount of the transfer. To add an external account, the user clicks on an Add Account link 136, and the securities management system 16 serves an Add External Account page 140, as shown in FIG. 4C. After inputting the requested information and agreeing to the terms of account verification 141 shown on the Add External Account page 140, the user can click the Add Account button 143 to add the external account from which funds can be transferred to the user's system account.

Still referring to FIGS. 4A-4C, the user can display and remove external accounts from the system by clicking a Manage Accounts link 144, which displays a Manage Accounts page 146, as shown in FIG. 4D. The user can transfer available funds from their system account to an external account by clicking a Withdraw Funds link 145, which displays a Withdraw Funds page 148, as shown in FIG. 4E. If the user has funds available in his or her system account, the Withdraw Funds page 148 displays the funds that are available for withdrawal. To withdraw funds, the user inputs a withdrawal amount 147, selects an external account to transfer the funds to 149, and then clicks the Submit button 142. In response, the securities management system 16 initiates an electronic transfer of the requested funds from issuer's bank account to the selected external account and debits the amount from the user's system account.

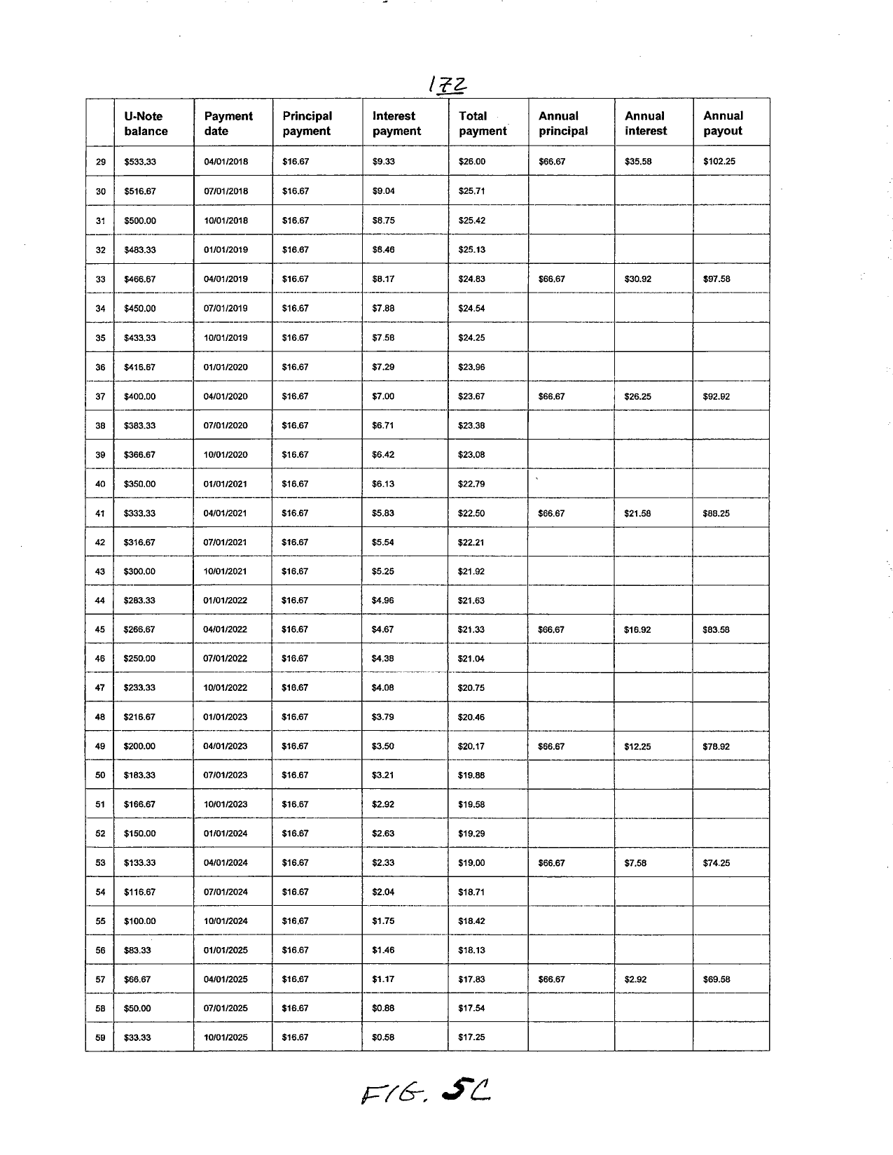

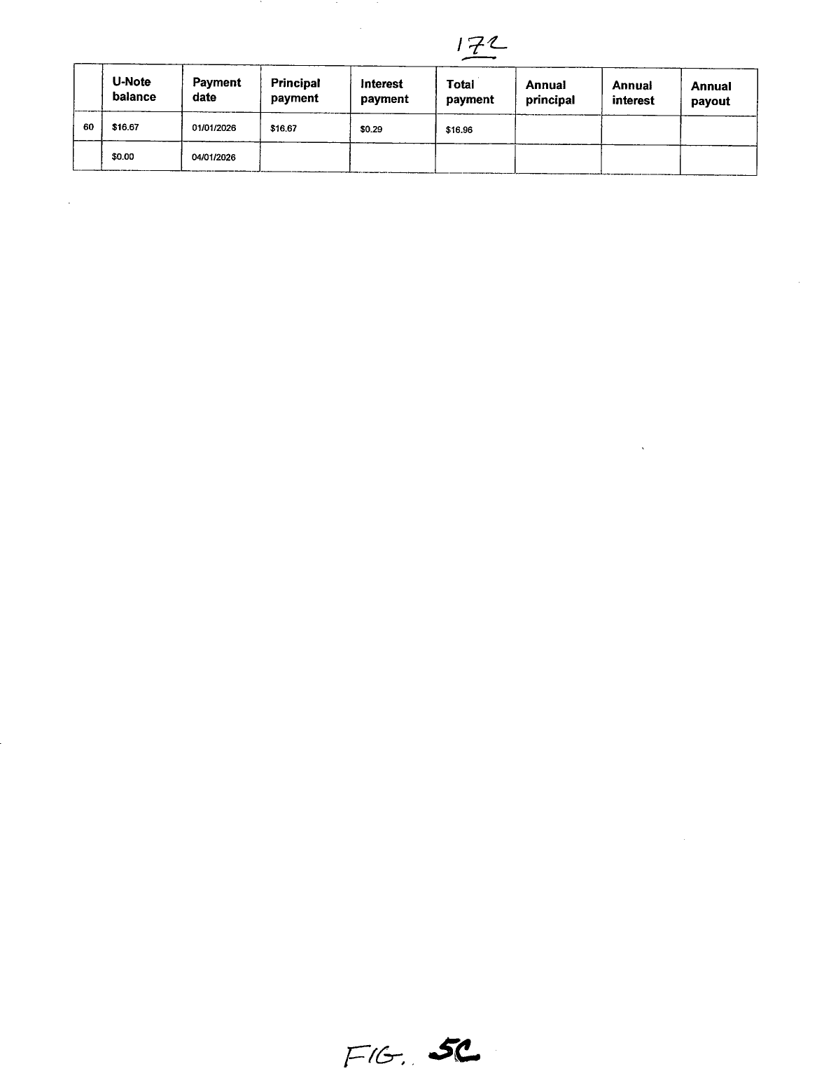

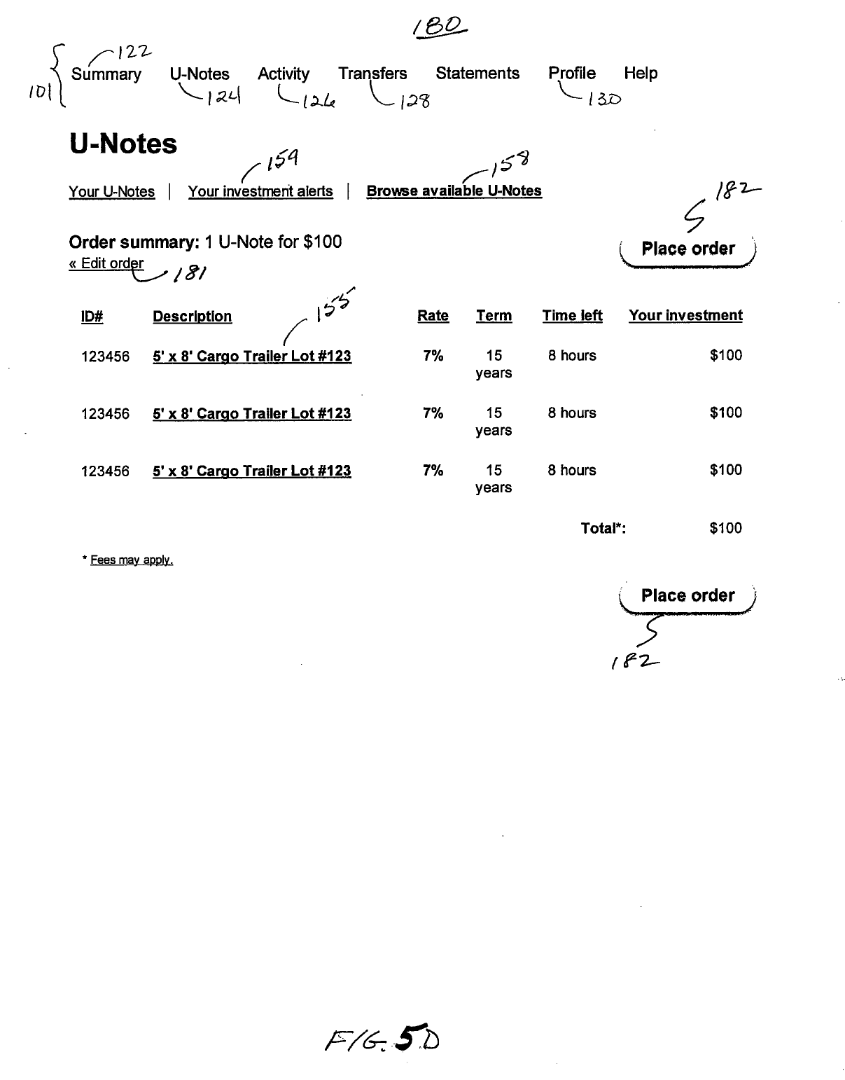

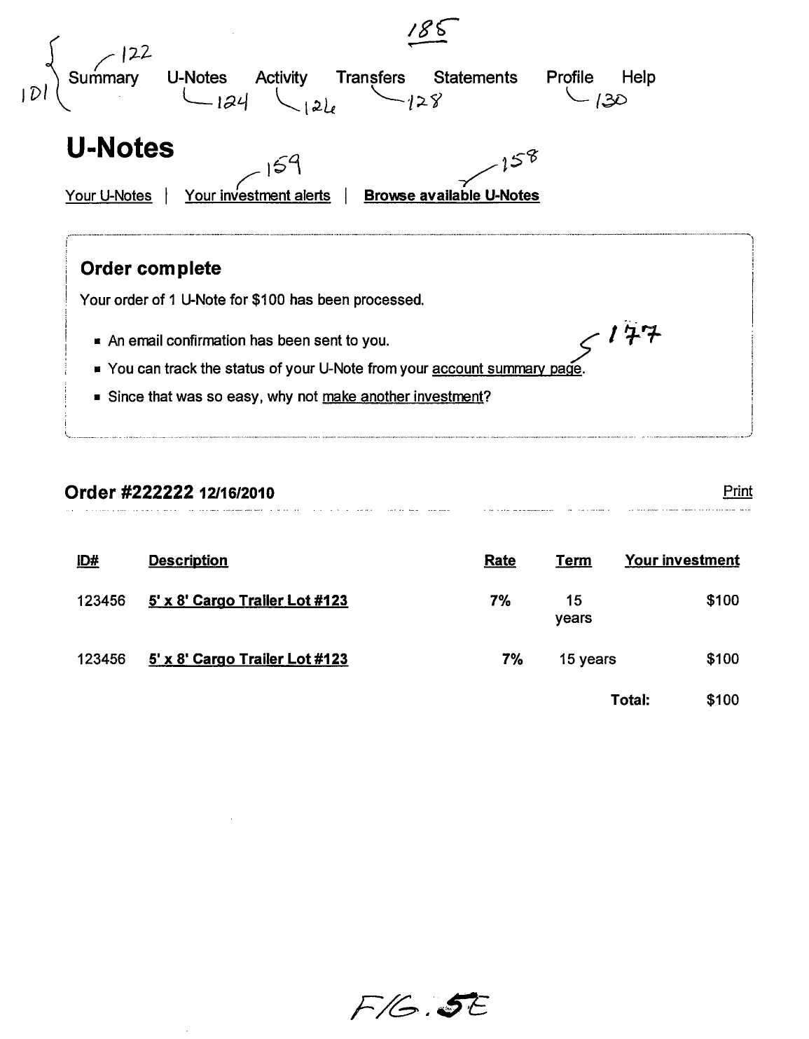

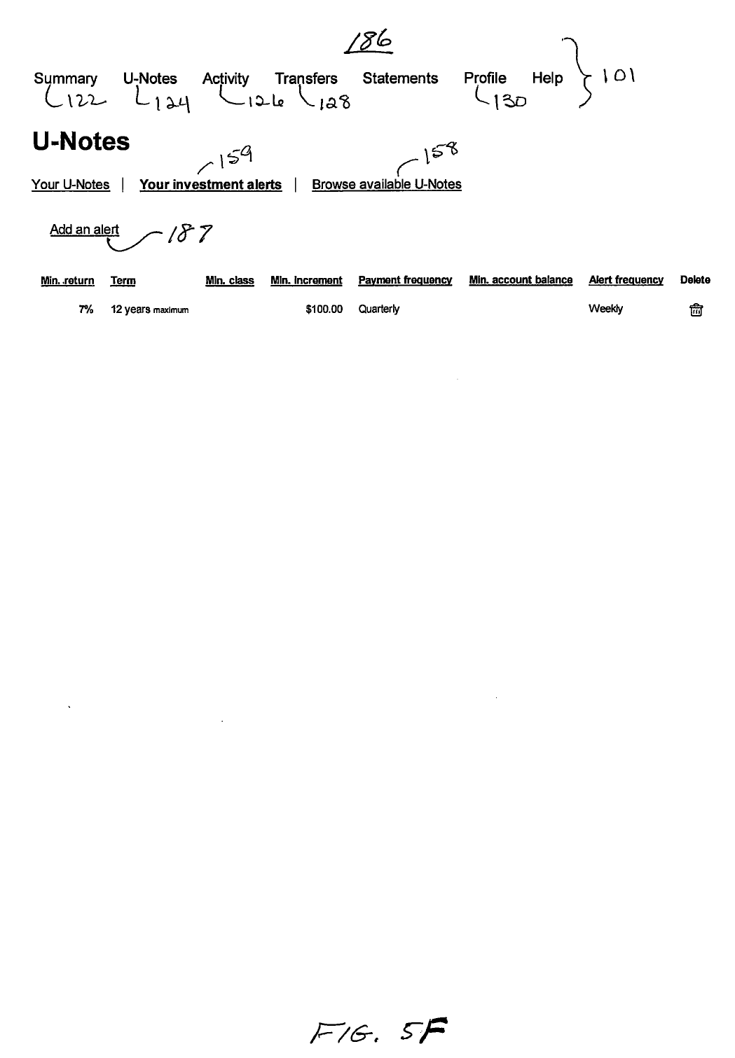

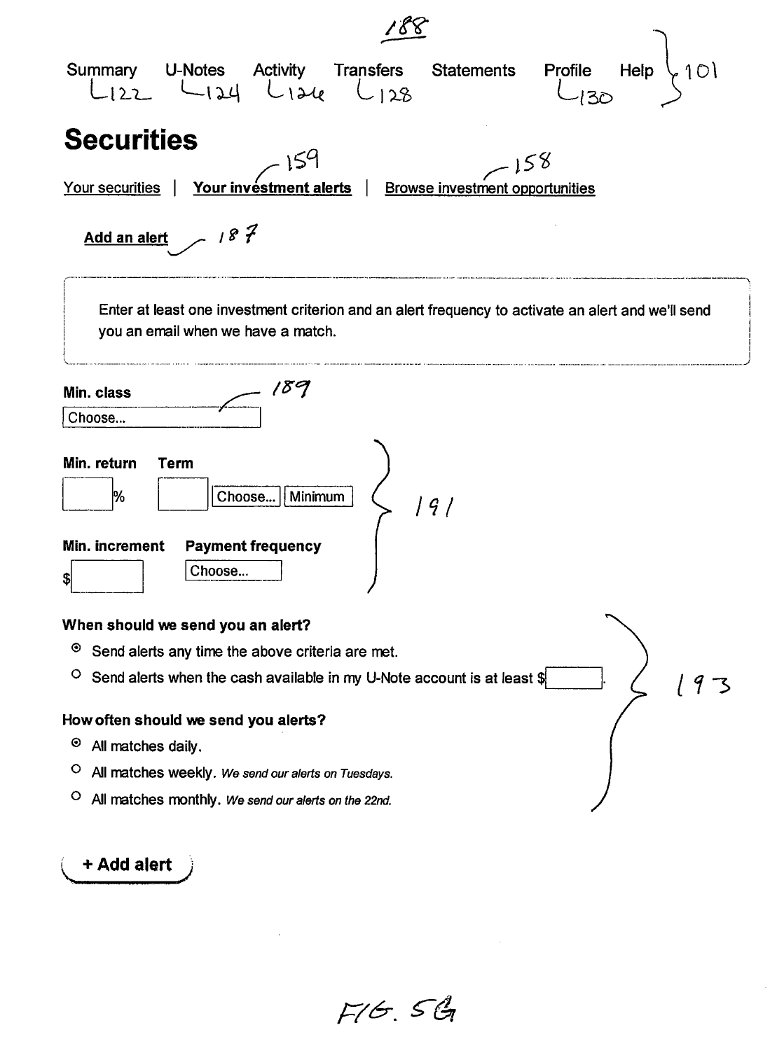

With the user navigation menu 101, a user can view the securities in his or her account as well as those that are available for purchase by clicking on the Notes link 124, in response to which the securities management system 16 serves a Notes page 150, as shown in FIG. 5A. The Notes page 150 presents information about the user's securities, which can be selectively displayed by inputting information into fields for the external account used to purchase the security 151, status of the security 152 (i.e., Current, In Funding, Issued, Mature, etc.), interest rate 153, and term 154. If the user clicks on the Description link 155 for a security, the Notes page 150 will display an expanded view 156 with more detailed information about the selected security, including collateral information and financial data, as seen in FIG. 5A. This detailed information can be hidden from view by clicking on the Hide Details link 157.

Still referring to FIG. 5A, clicking the Browse Available Notes link 158 displays a Browse Available Notes page 160, as shown in FIG. 5B. The Browse Available Notes page 160 displays information about each of the securities that is available for purchase from the issuer, including the description of the security 161, the percentage funded 162 (i.e., the percentage of the security offering that has been purchased to date), and the interest rate paid on the security 163, the term of the note 164, the time left that the security can be purchased 165. For each security, a View Full Details link 166 is shown. When the user clicks on this link for a specific security, the securities management system 16 serves an expanded view 156 of more detailed information for that security, as shown in FIG. 5B, which displays a Collateral Specification section 167 as well as a Financial Data section 168 for the security. The financial data section 168 includes a View Payment Schedule link 170, which the user can click to display principal and interest payment information window 172, such as that shown in FIG. 5C.

In one advantageous embodiment, the securities management system 16 can be used to offer securities that are collateralized by specific types of assets that can be used in the issuer's business. For example, as shown in FIG. 5B, a company in the self-help moving business can use the system to offer securities that are collateralized by tangible assets, including real estate and equipment, such as trucks, cargo trailers, appliance dollies, auto transport trailers, furniture dollies, furniture pads, tow dollies, utility dollies, and the like.

Still referring to FIG. 5B, the Browse Available Notes page 160 also includes an Order menu 173 from which the user can choose a purchase amount of the security to be ordered. When the user selects the purchase amount, the securities management system 16 displays an Order Summary 174 for the user's order. To complete the order and purchase the displayed security, the user clicks a Continue button 176. In response, the securities management system 16 displays an Order Summary page 180, as shown in FIG. 5D, which includes information about the order. To edit the order before placing it, the user can select an Edit Order link 181, which will return the user to the Browse Available Notes page 160 shown in FIG. 5B. To place the displayed order, the user clicks a Place Order button 182, which causes the securities management system 16 to place the order for the user and to display an Order Confirmation page 185, as shown in FIG. 5E. The Order Confirmation page 185 includes an Account Summary link 177, which returns the user to their Account Summary page 100.

Still referring to FIG. 5A, the Notes page 150 includes an Investment Alerts link 159. When the user selects this link, the securities management system 16 serves an Investment Alerts page 186, as shown in FIG. 5F, which displays alerts that the user has requested the system to send him or her regarding investment opportunities. The Alerts page 186 includes an Add Alert link 187, which the user can click to display an Add Alert page 188, as shown in FIG. 5G. The Add Alert page 188 includes an input field for risk/reward class 189 (e.g., Low risk, low reward; Low risk medium reward; Low risk, high reward; Medium risk, medium reward; Medium risk, high reward; and High risk, high reward) and input fields for other investment criteria 191 as well as inputs for timing and frequency of alerts 193. Using these input fields, the user can select investment criteria and alert frequency information to cause the system to email him or her alerts. FIG. 5H shows a second example of an embodiment of the Add Alert page 188.

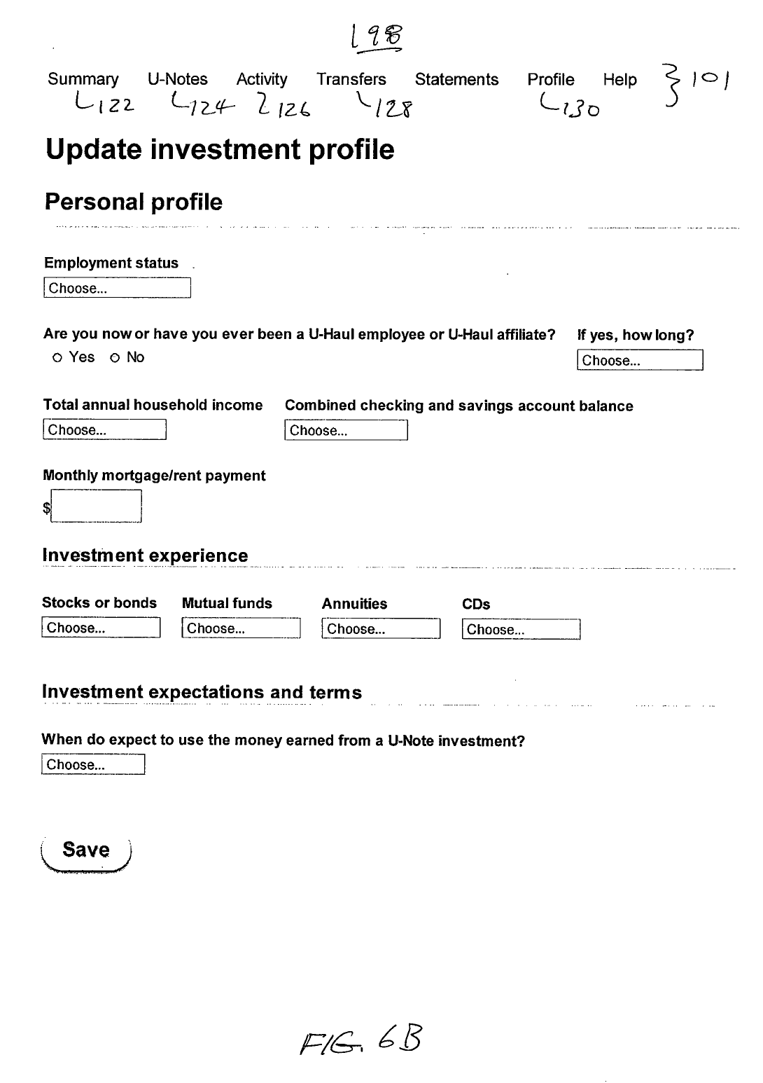

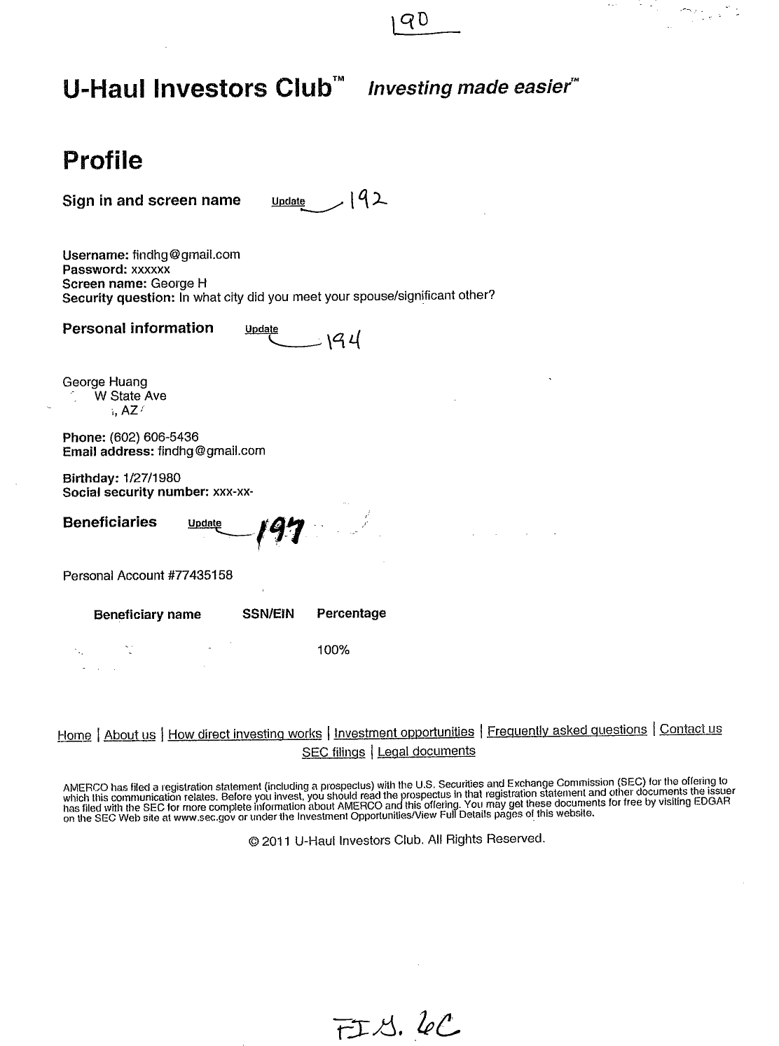

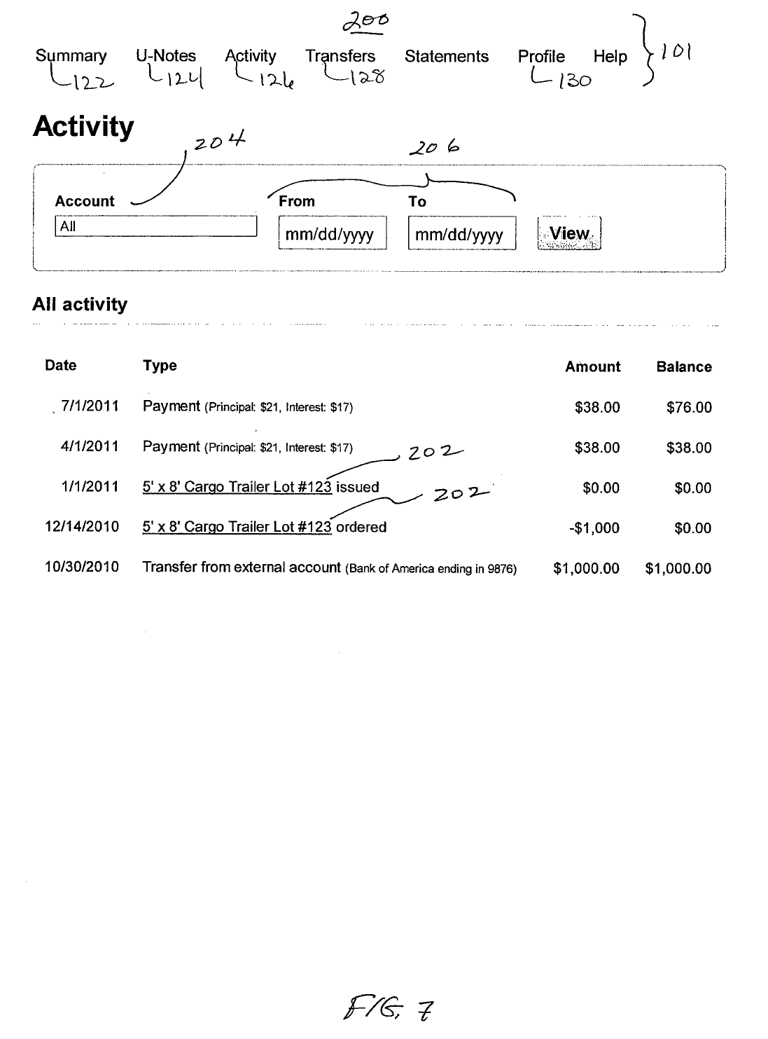

With the user navigation menu 101, a user can view their transaction history by clicking on the Activity link 126, in response to which the securities management system 16 serves an Activity page 200 for display on the user computer 11, as shown in FIG. 7. The Activity page 200 displays information about the transactions associated with the user's system account, including debt service payments received by the investor as well as securities ordered by the investor and related issuances. The transaction information can be displayed selectively for each of the user's external accounts by inputting information into the External Account field 204 and the Date Range fields 206. If the user clicks on the Description link 202 for a security, the system will display an expanded view 156 with more detailed information about the selected security, as seen in FIG. 5A. For each displayed description having a status as an ordered or issued security, a transaction link 202 is included, which the user can click to display specific information about the subject security in the form shown in FIG. 5A.

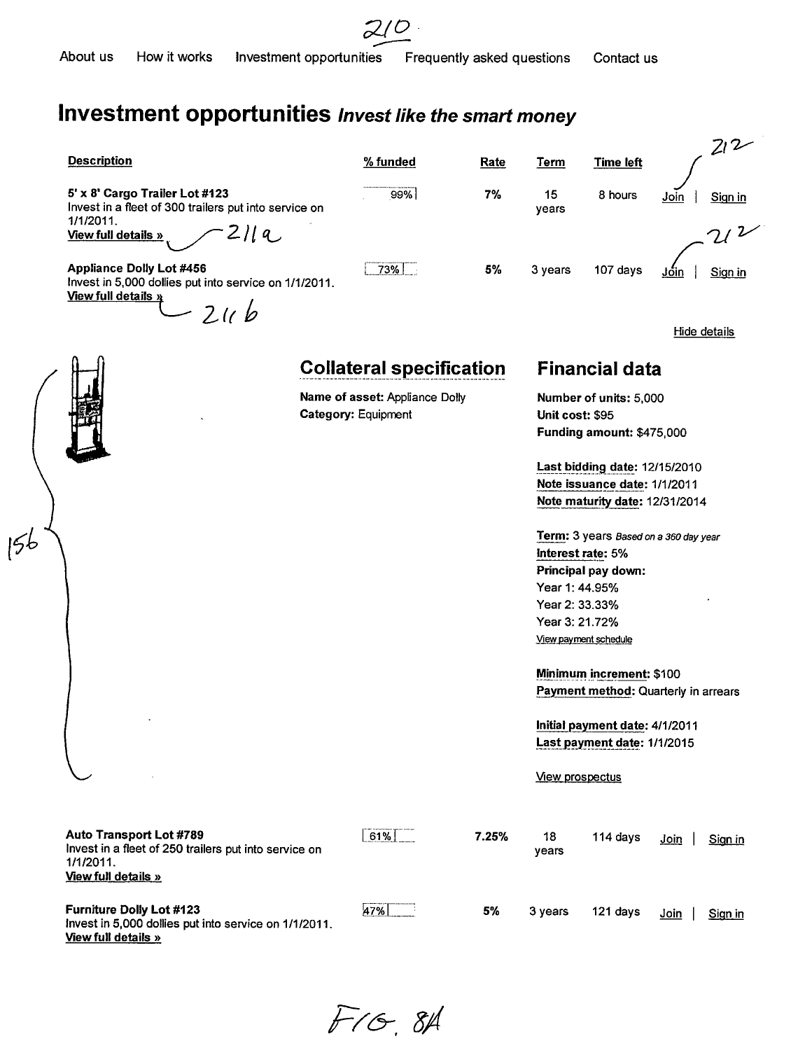

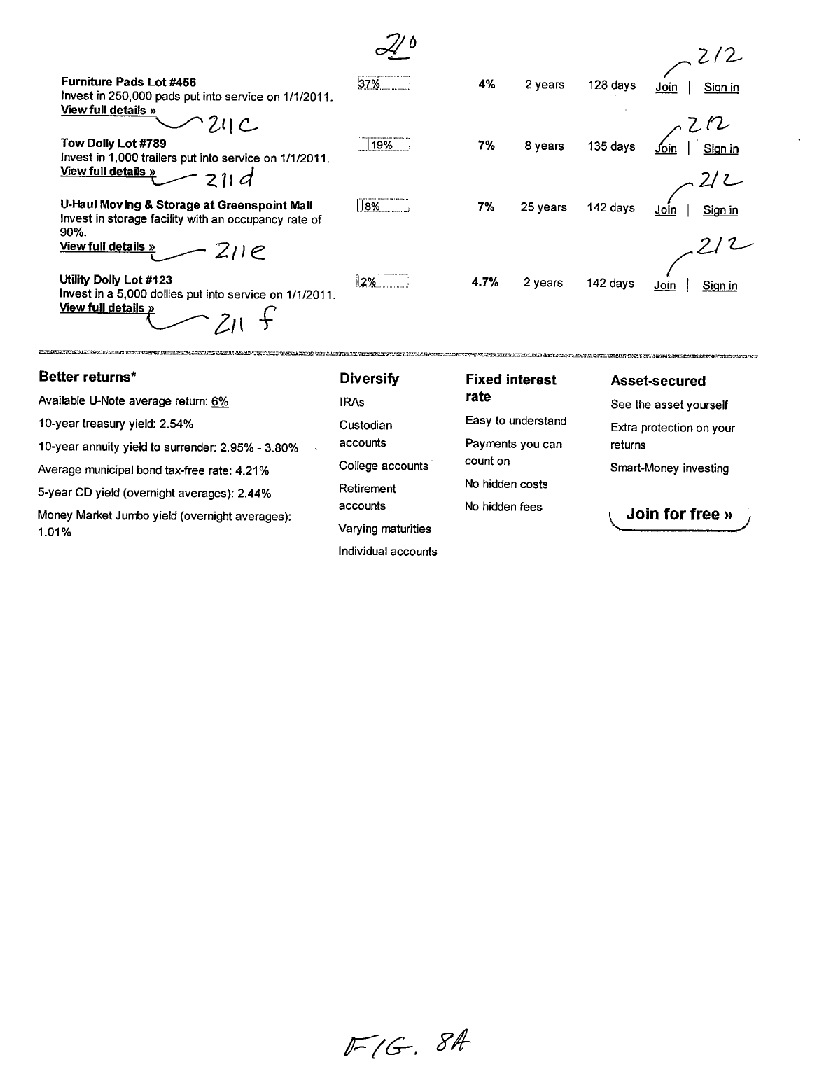

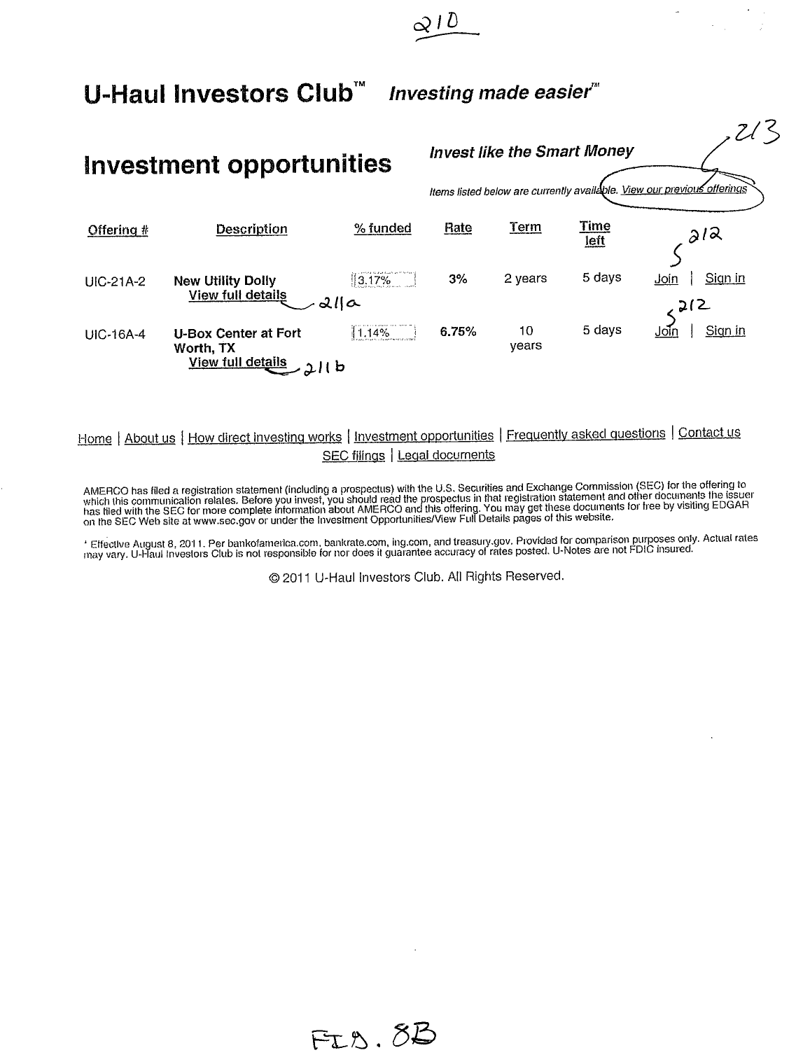

According to one aspect of the invention, a potential investor can view information about investment opportunities that are available to users who join as members. FIG. 8A shows an exemplary screen display of a website home page 210 for this purpose, which includes brief securities descriptions and a View Full Details link 211 for a security. By clicking on the View Full Details link 211, the potential investor can see an expanded view 156 with more detailed information about the selected security. If the potential investor is not yet a member of the website, he or she can click a Join link 212 to begin the process of registering with the securities management computer system 16 to join as a member in order to invest. FIG. 8B shows a second example of an embodiment of the website home page 210, which includes a View Previous Offerings link 213. By clicking the View Previous Offerings link 213, the potential investor can see a Previous Investment Opportunities page 215, as shown in FIG. 8C, which displays information about previous offerings.

### Administrator Interface

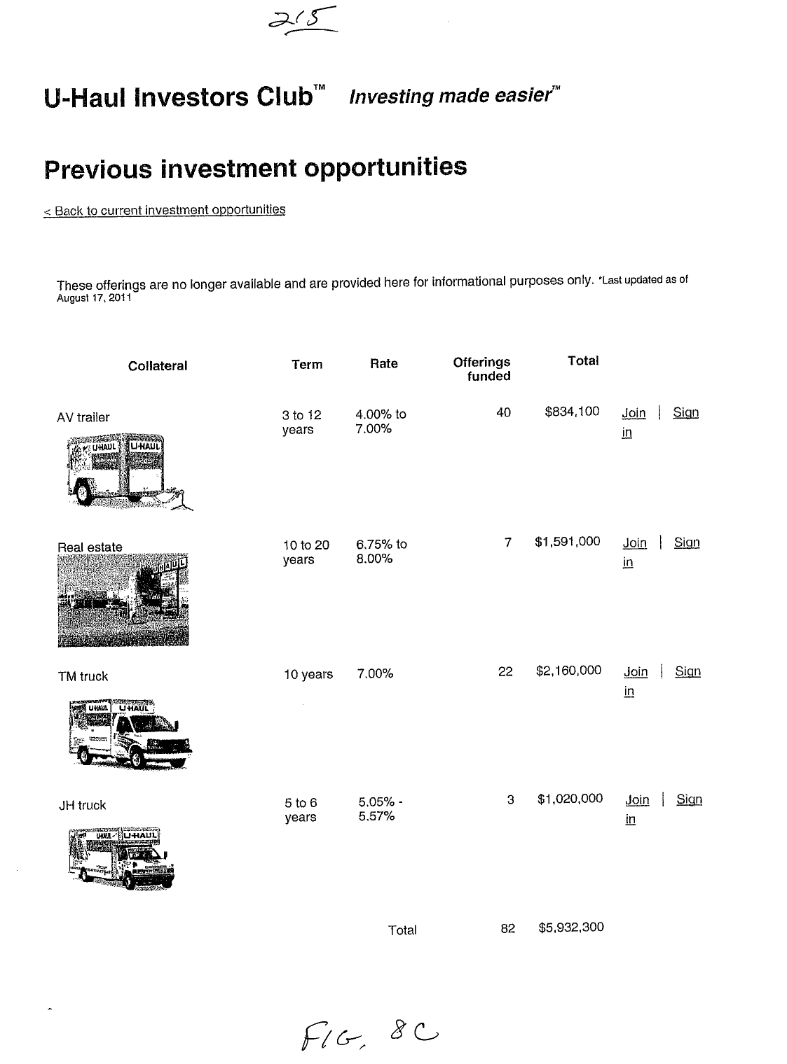

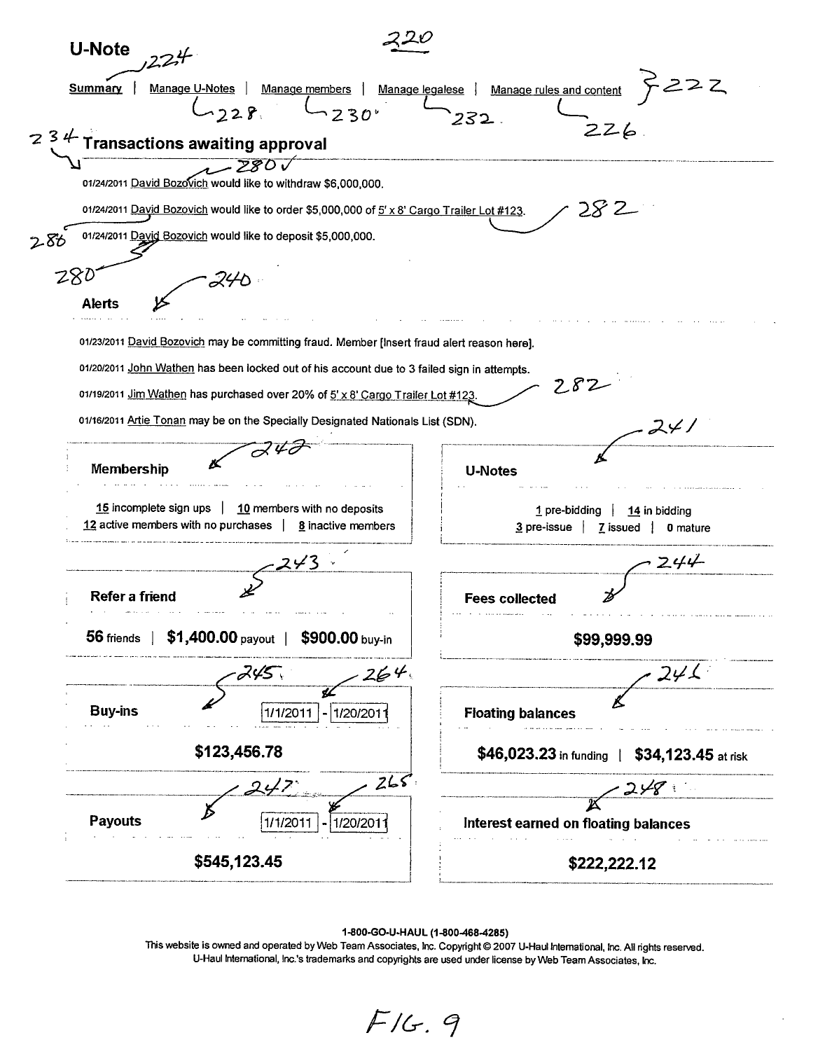

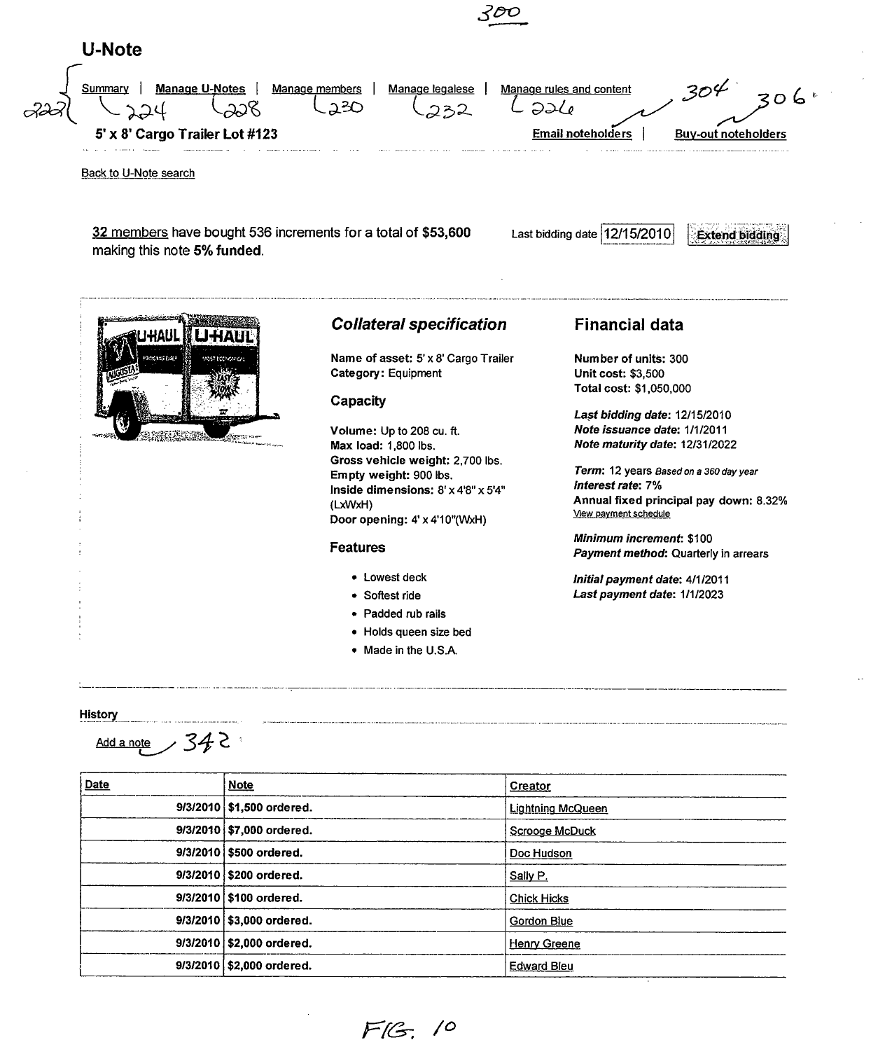

FIG. 9 shows an exemplary screen display of a Summary page 220 for use by an administrator of the system according to the invention. The Administration Summary page 220 includes a navigation menu 222 with a Summary link 224, a Manage Notes link 228, a Manage Members link 230 and a Manage Legal Terms link 232 and a Manage Rules and Content link 226. The Summary page 220 includes display sections for Transactions Awaiting Approval 234, Alerts 240, Membership 242, Notes 241, Referrals 243, Fees Collected 244, Buy-ins 245, Floating Balances 246, Payouts 247 and Interest Earned on Floating Balances 248. The Floating Balances display section 246 displays the total amount in the system that is “in funding” (i.e., the amount that investors have committed to purchase notes) as well as the total amount that is “at risk” for the issuer (i.e., the total amount in the investors' system accounts that is not committed to purchase notes and that can be withdrawn from the system by investors). The Transactions Awaiting Approval section 234 displays information about transactions that users have requested and that are awaiting approval by the system administrator. Each of the Buy-ins section 245 and the Payouts section 247 includes a time period field 264, 265 for selecting the time period for the information displayed.

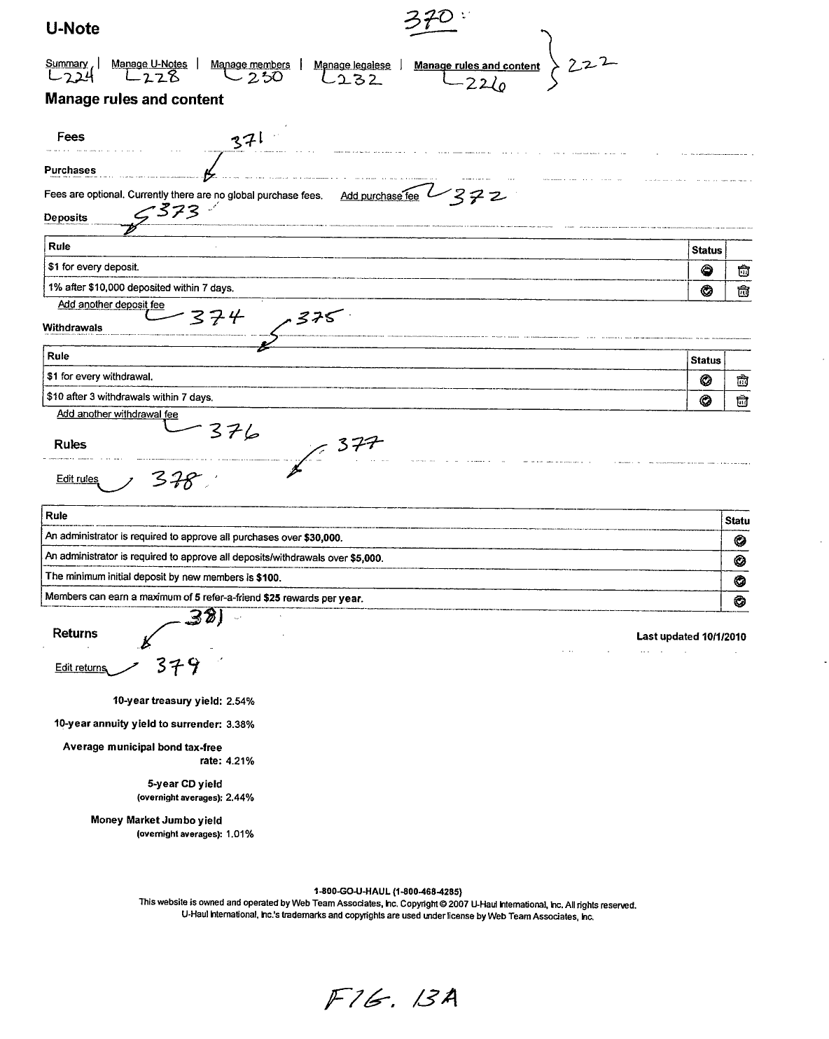

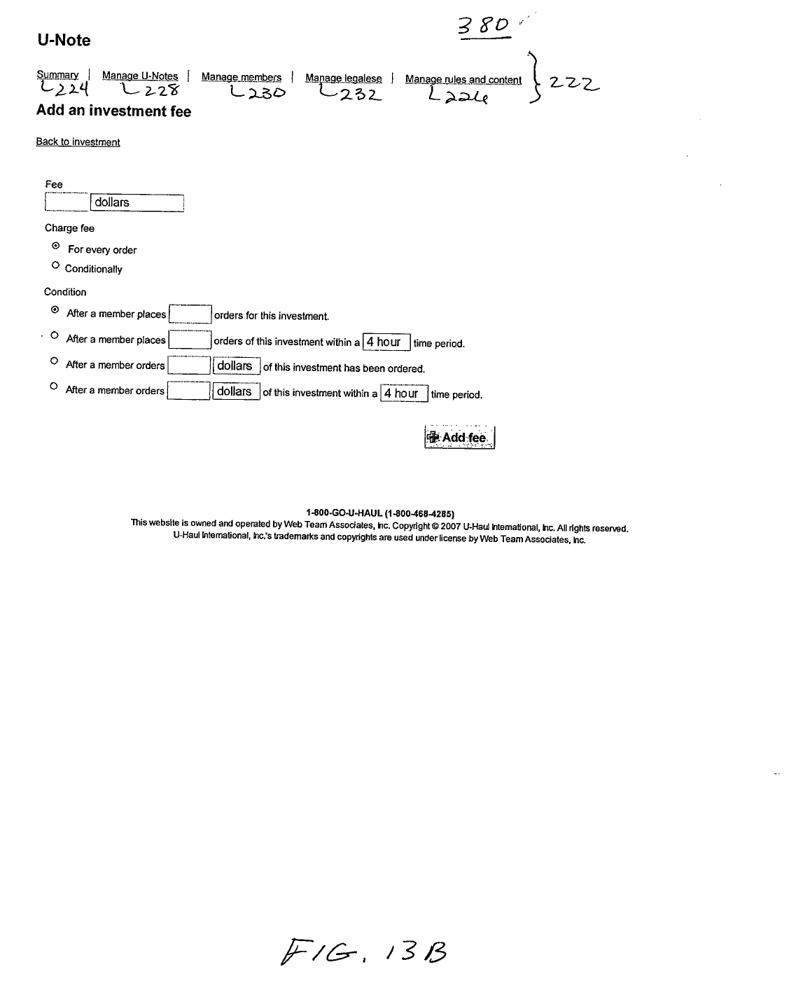

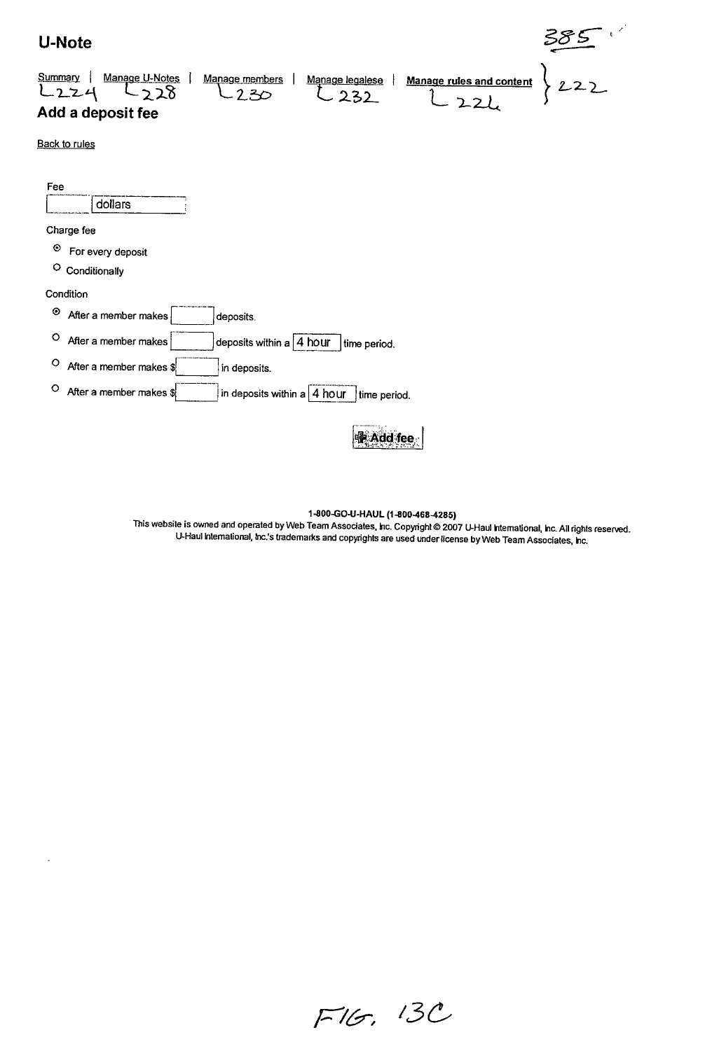

Still referring to FIG. 9, when the administrative user clicks on the Manage Notes link 228, the system displays a Manage Notes page 340, as shown in FIG. 12A, which can be used to search, display and add information on securities stored in the system. FIG. 12B shows a second example of an embodiment of the Manage Notes page 340.

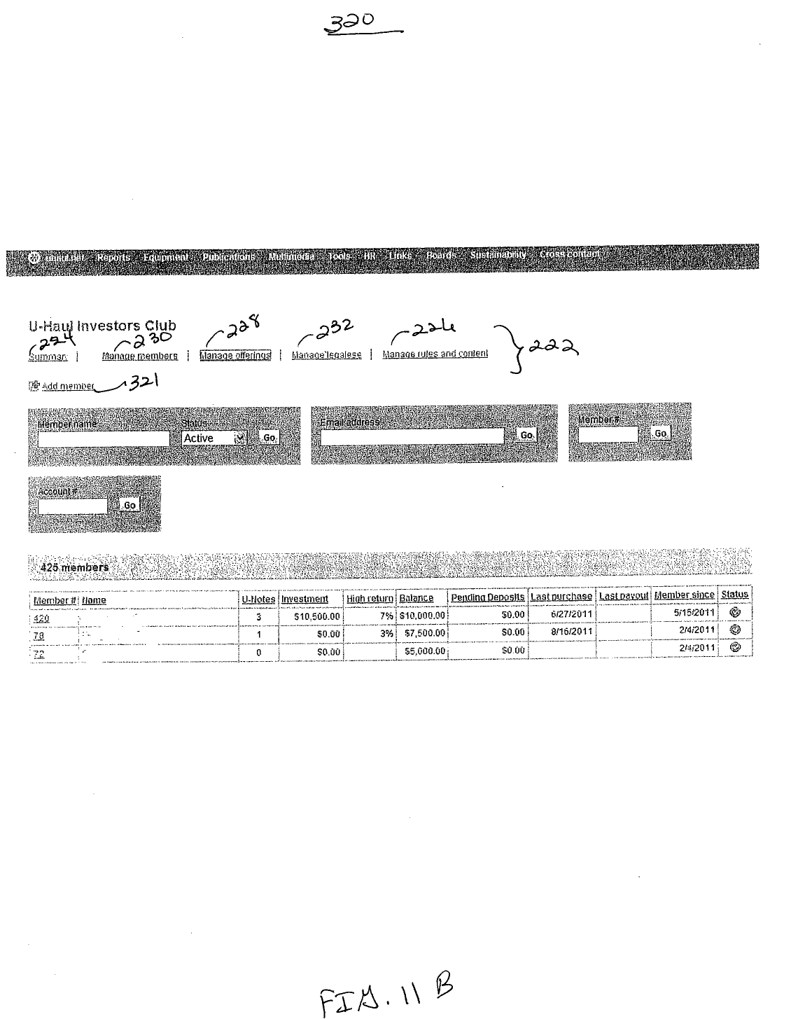

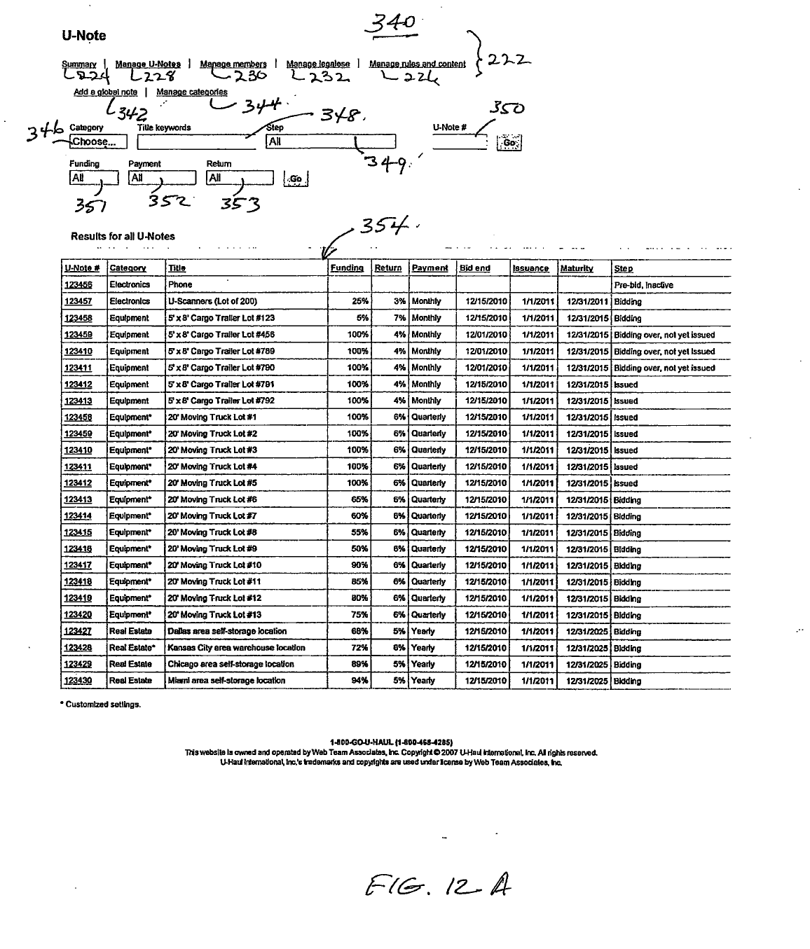

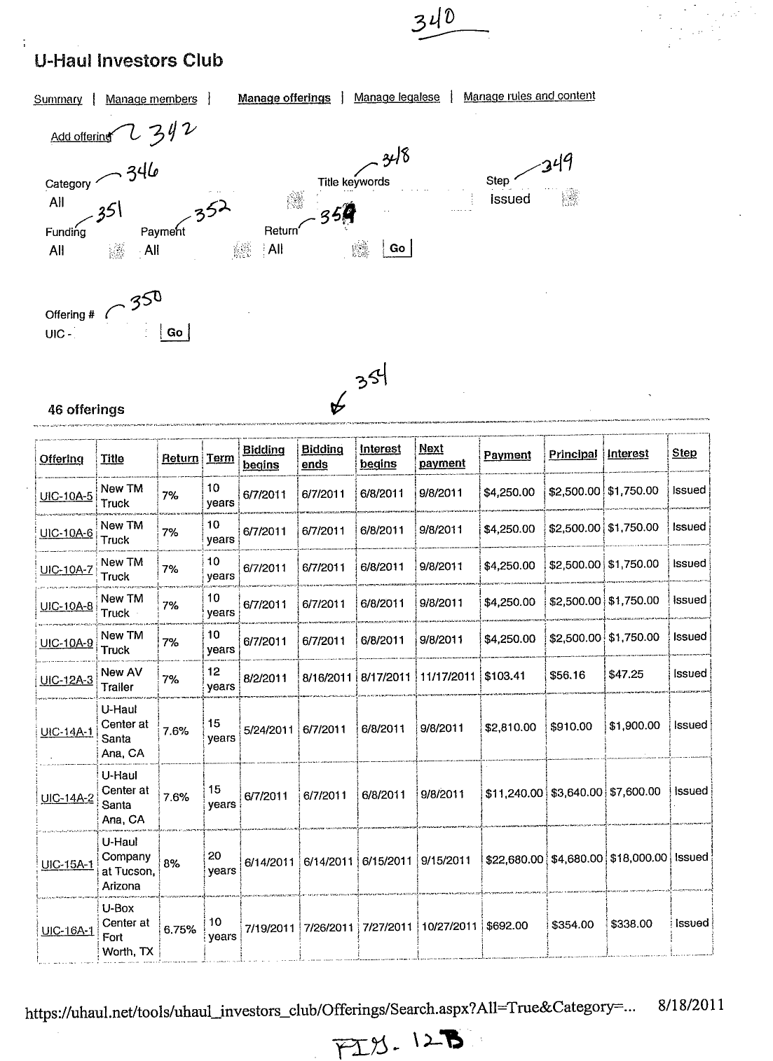

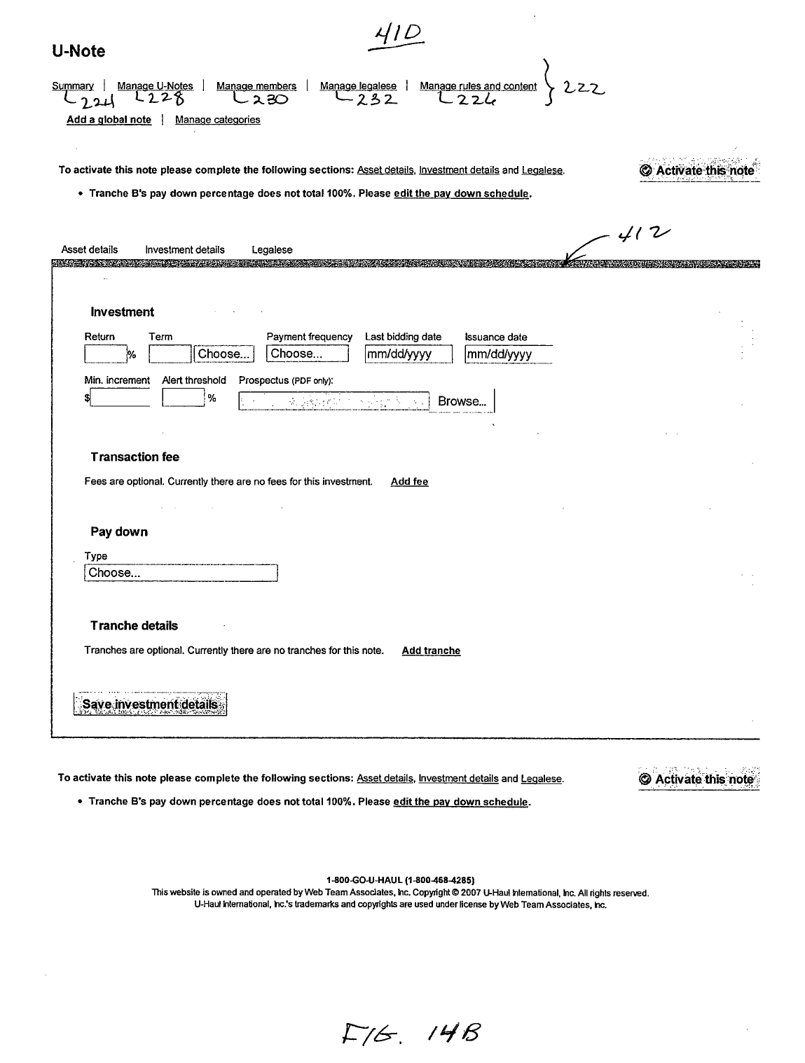

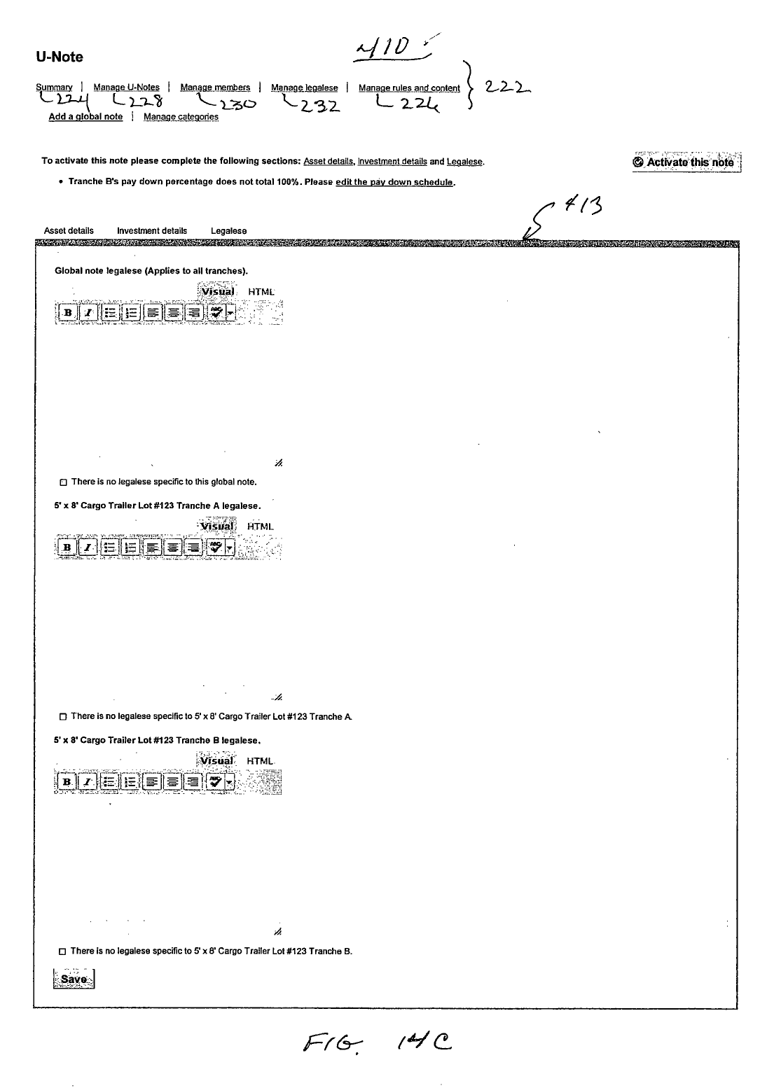

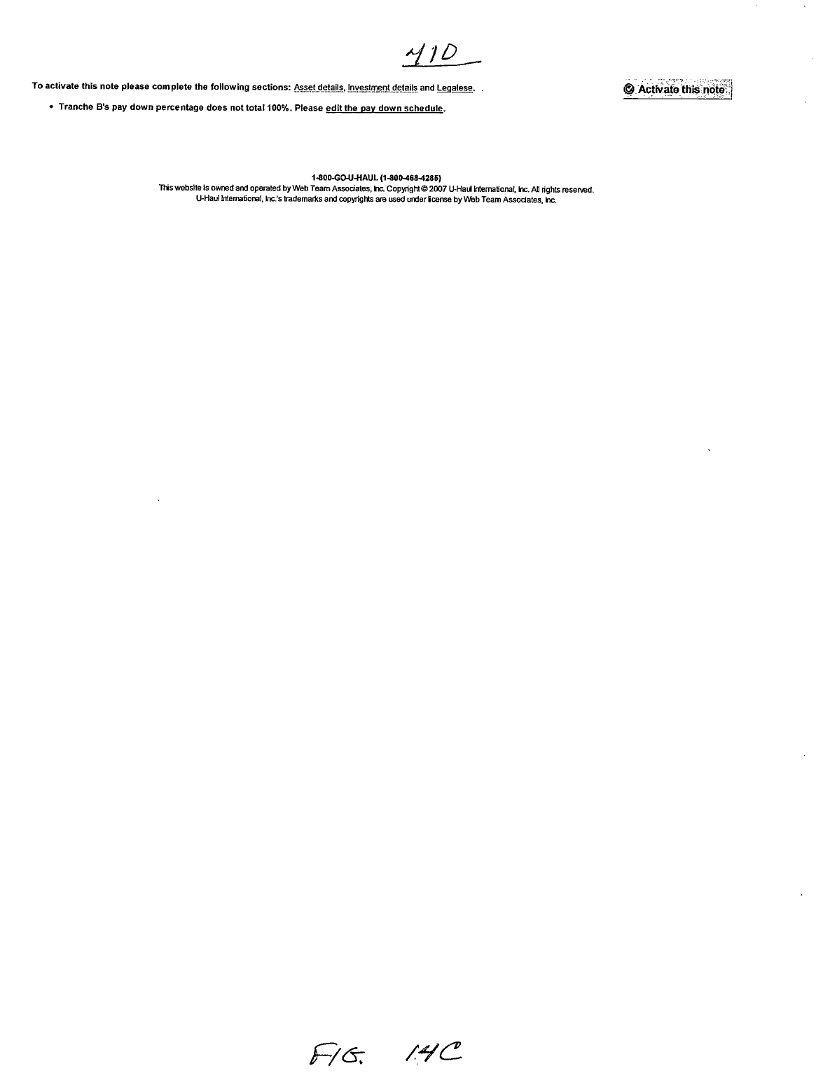

When the administrative user clicks on the Manage Members link 230, the system displays a Manage Members page 320, as shown in FIG. 11A, which can be used to search, display, edit and add information on users who are registered with the system as members and to add new members. The Manage Members page 320 includes an Add Member link 321. When the administrative user clicks on the Add Members link 321, the system displays an Add Member page, like that shown in FIG. 16, with which the administrative user can input to the system the profile information for a new investor. FIG. 11B shows a second example of an embodiment of the Manage Members page 320.

When the administrative user clicks on the Manage Legal Terms link 232, the system displays a Manage Legal Terms page (not shown), which allows the administrative user to view, edit and track edit history of the posted legal terms for deposits, withdrawals, securities purchases, membership, membership by state, and the website.

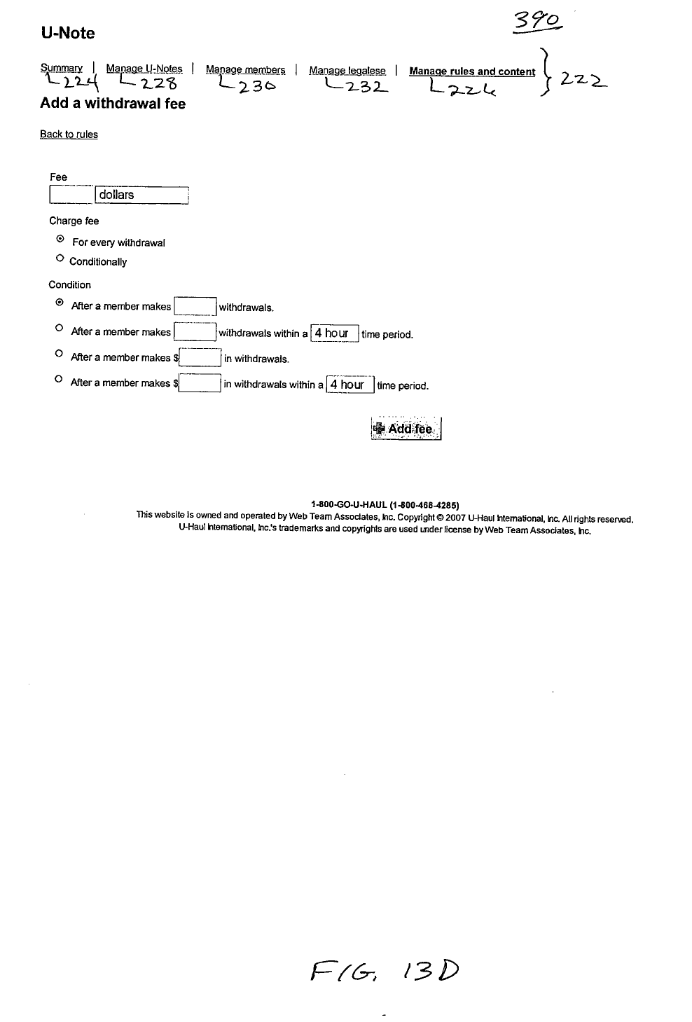

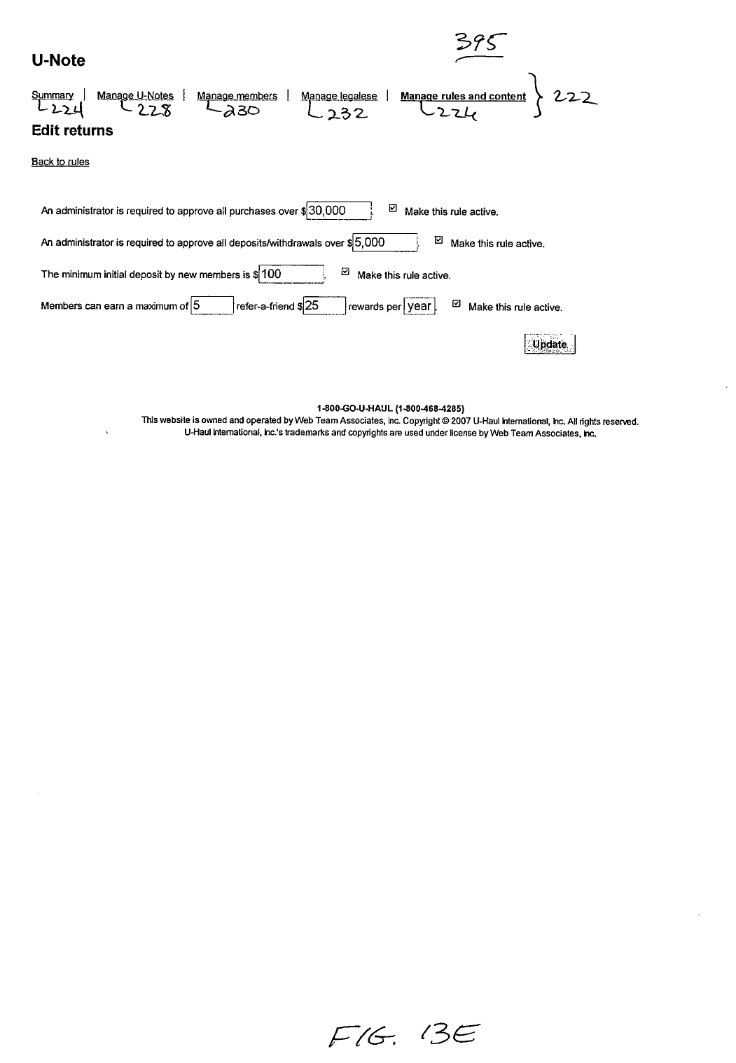

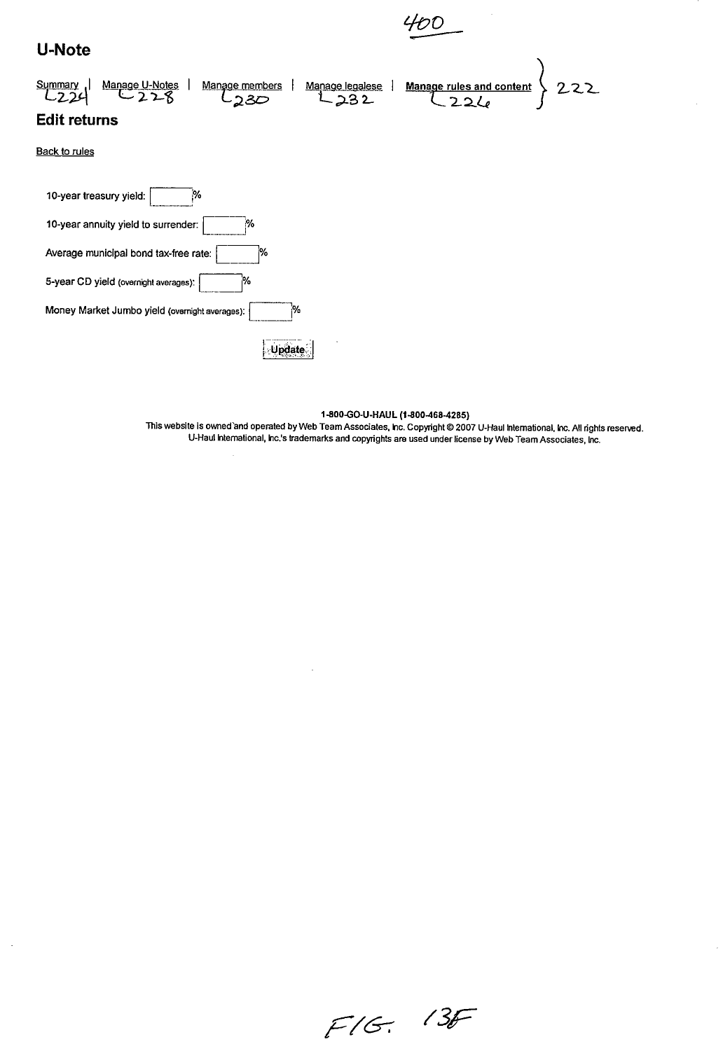

When the administrative user clicks on the Manage Rules and Content link 226, the system displays a Manage Rules and Content page 370, as shown in FIG. 13A. This page can be used to set and dynamically change the business rules applied by the system to purchase fees, deposits, withdrawals, administration matters and interest returns. The Manage Rules and Content page 370 includes a Purchase Fees section 371 with an Add Purchase Fee link 372, a Deposits section 373 with an Add Deposit Fee link 374, a Withdrawals section 375 with an Add Withdrawal Fee link 376, a Rules section 377 with an Edit Rules link 378 and a Returns section 381 with an Edit Returns link 379. When the administrative user clicks on the Add Purchase Fee link 372, the system displays an Add Investment Fee page 380, as shown in FIG. 13B. When the administrative user clicks on the Add Deposit Fee link 374, the system displays an Add Deposit Fee page 385, as shown in FIG. 13C. When the administrative user clicks on the Add Withdrawal Fee link 376, the system displays an Add Withdrawal Fee page 390, as shown in FIG. 13D. When the administrative user clicks on the Edit Rules link 378, the system displays an Edit Rules page 395, as shown in FIG. 13E. When the administrative user clicks on the Edit Returns link 379, the system displays an Edit Returns page 400, as shown in FIG. 13F. FIG. 13G shows a second example of an embodiment of the Manage Rules and Content page 370. FIG. 13H shows a second example of an embodiment of the Add Investment Fee page 380.

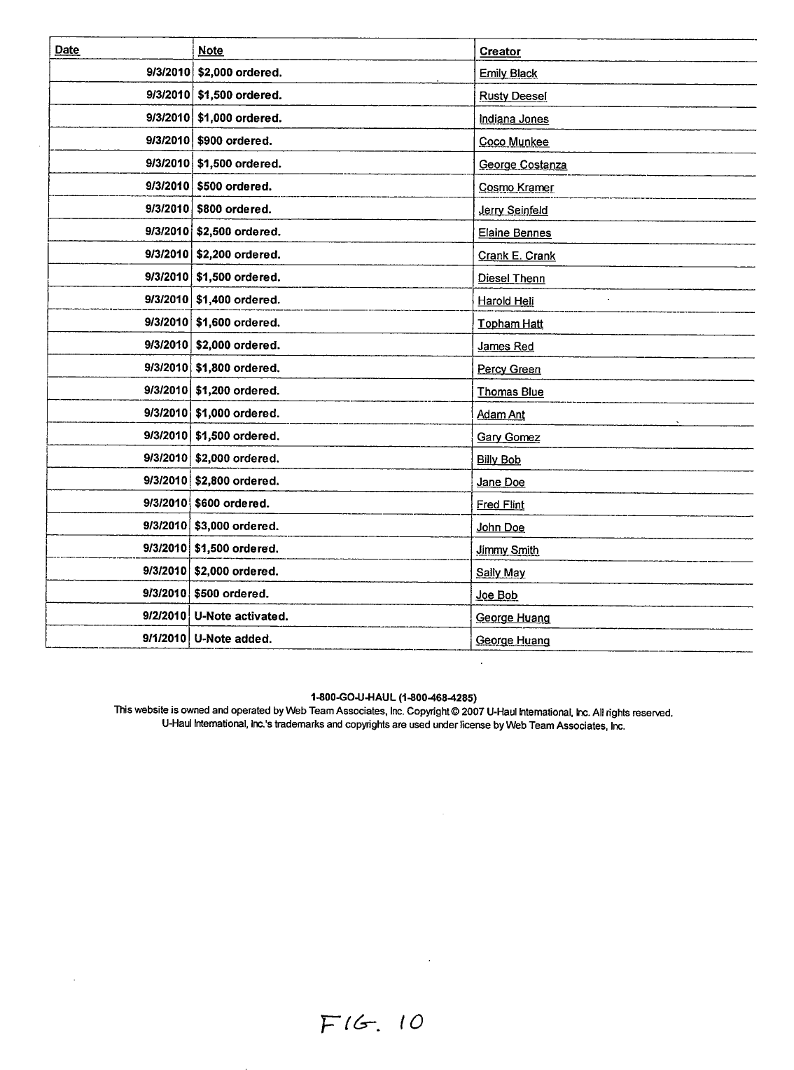

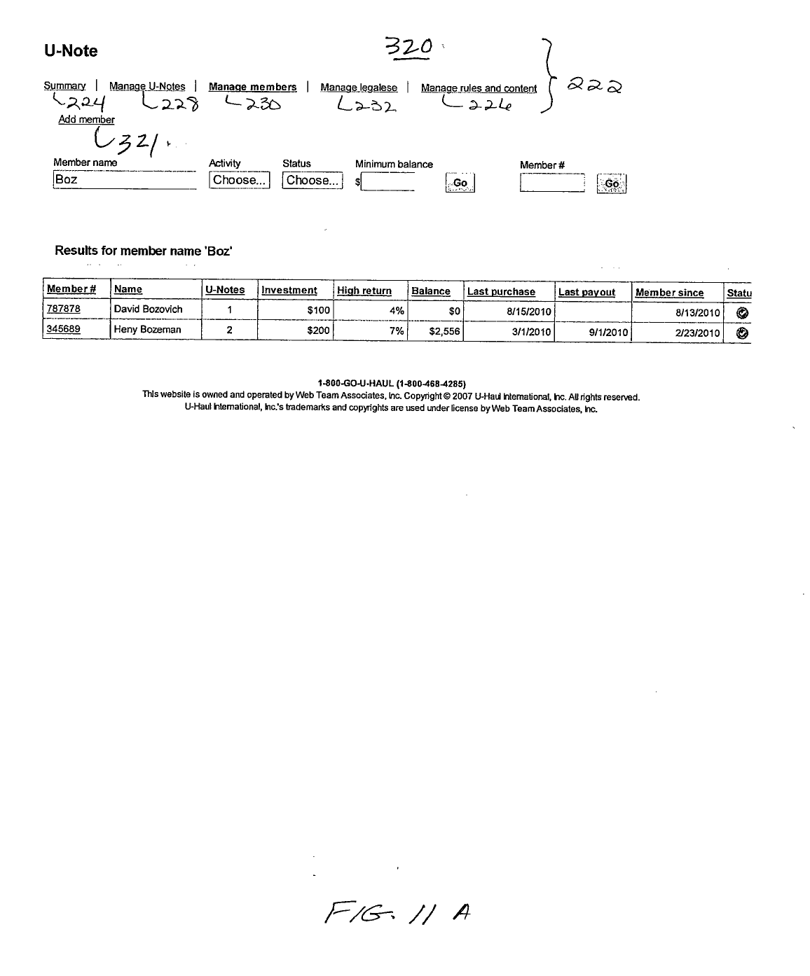

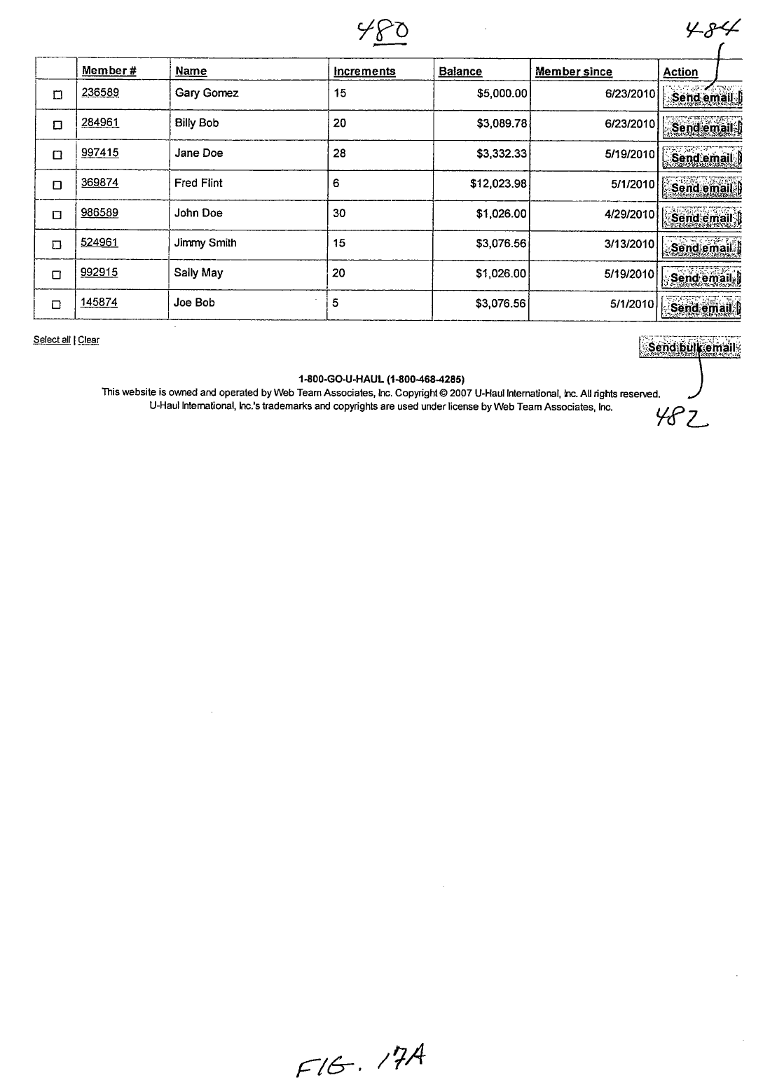

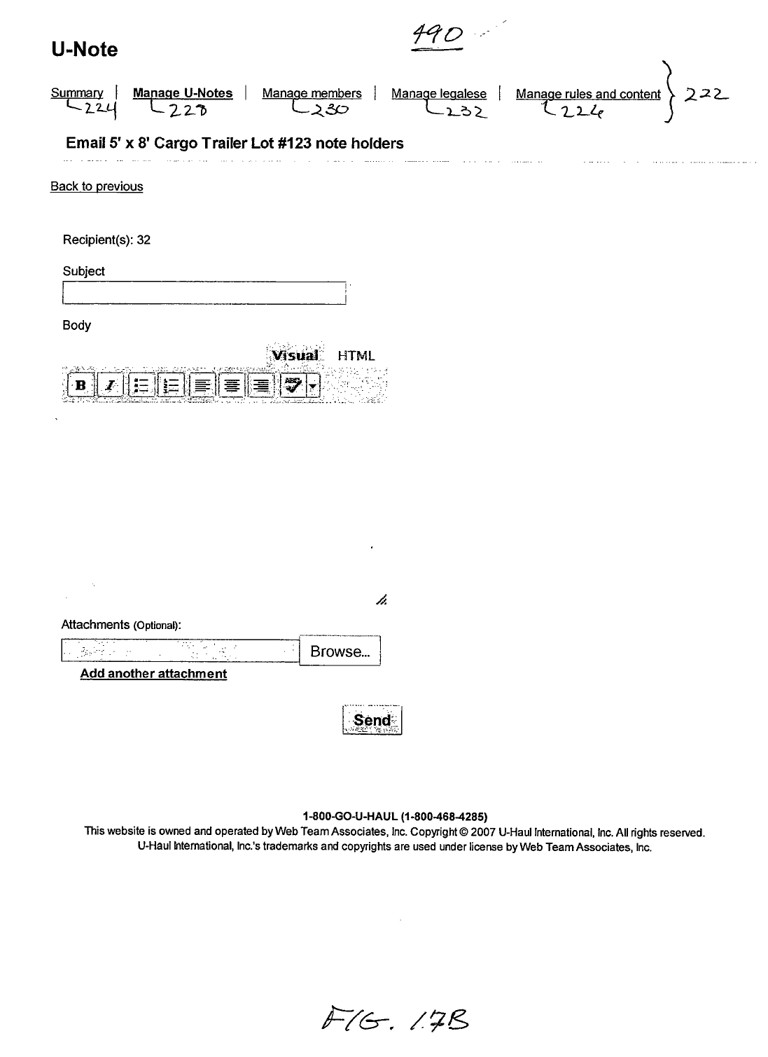

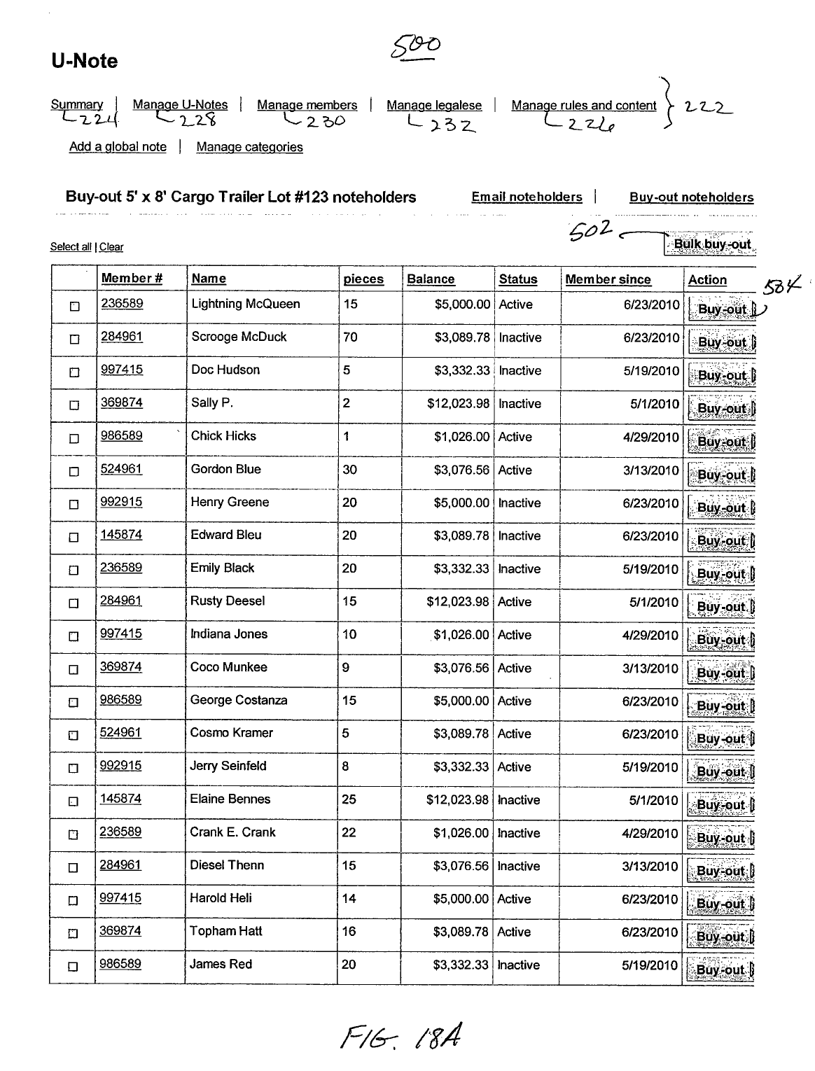

Referring again to FIG. 9, the Summary page 220 includes user name links 280 and security name links 282. Clicking on any user name link 280 displays a member information page 520 for the specific user, as shown in FIG. 19. Clicking on any security name link 282 displays a Security Information page 300 as shown in FIG. 10.

Referring again to FIG. 12A, the Manage Notes page 340 includes links to Add a Global Note 342 and to Manage Categories 344. The administrative user can also search the database for securities by entering information into the search fields 346-353. The search results are displayed in a search result section 354. For example, a search can be performed to display all securities collateralized by a particular category of asset (e.g., Electronics, Equipment, or Real Estate), or by the step in the issuance process, or by the percent funded, payment period (e.g., Monthly, Quarterly, Semi-annually or Yearly), interest return, title keywords or the like. The steps of the issuance process can include the following:
Pre-bid, inactive—The status when a note has been selected by the issuer for offering but is not yet ready to be offered.
Pre-bid, active—The status when a note has been selected by the issuer for offering and is ready to be offered but cannot yet to be viewed or purchased by investors.
Bidding—The status when a note is available to investors for purchase.
Bidding over, not yet issued—The status when a note has been fully funded, the bidding period has expired, or the offering is otherwise closed by the issuer, but the note has not yet been issued.
Issued—The status when a note has been fully funded and has been issued.
Matured—The status when an issued note has matured.

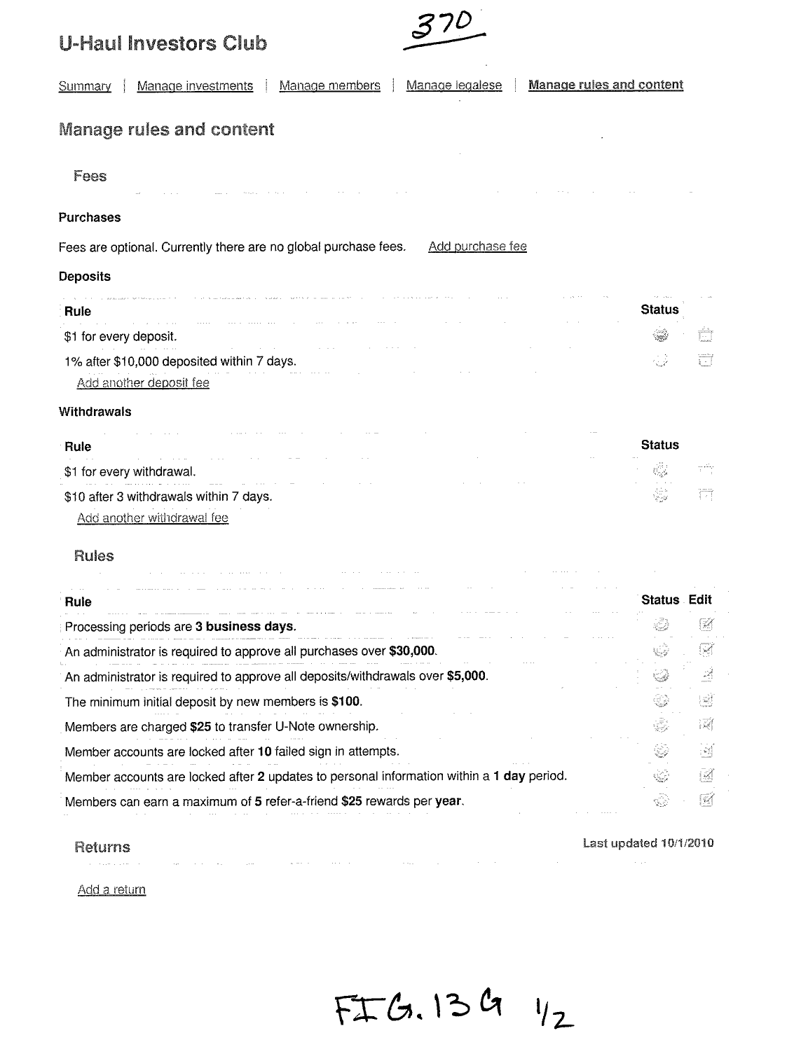

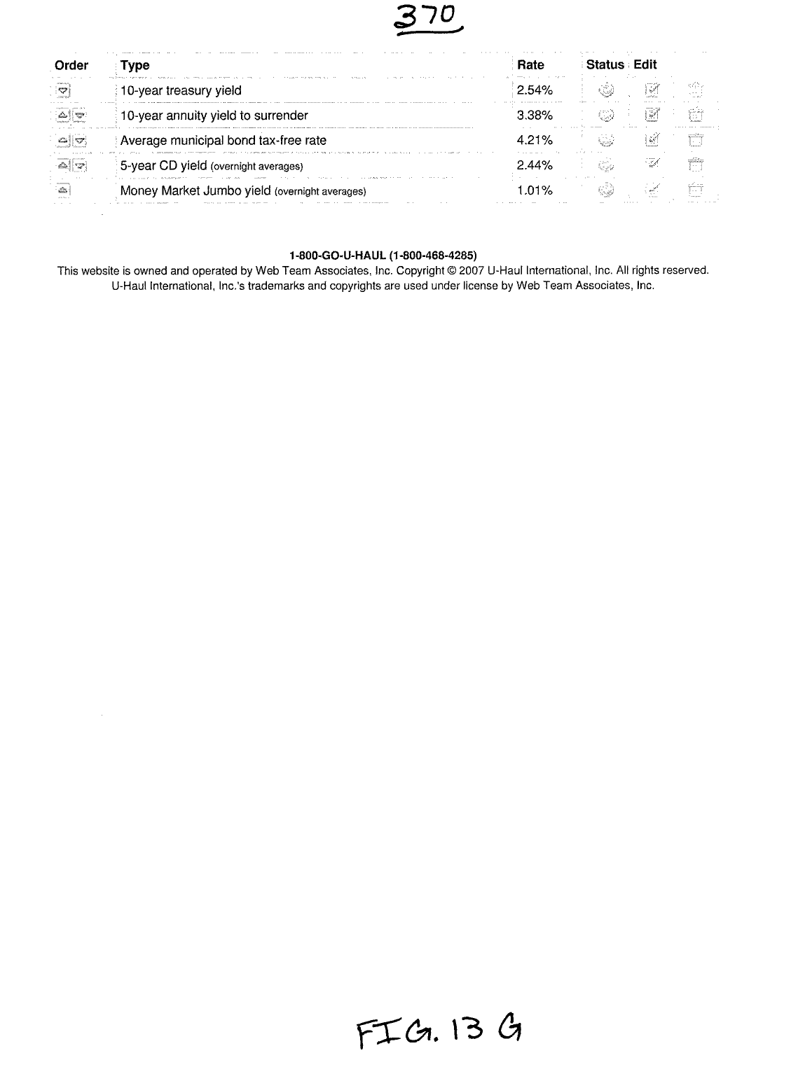

Still referring to FIG. 12A, when the administrative user clicks on the Add a Note link 342, the system displays an Add a Note page 410, which can be used to enter detailed information into the system about a security, as shown in FIG. 14A. Using the Add a Note page 410, the administrative user can enter information about collateral for the security in an Asset Detail section 411, as shown in FIGS. 14A and 14E. Referring to FIG. 14B, the administrative user can enter information about investment details for the security in an Investment Details section 412. As shown in FIG. 14C, the administrative user can enter information about legal terms for a security in a Legal Terms section 413. As shown in the example of FIG. 14D, the administrative user can use the Investment Details section 412 to issue multiple sub-series (referred to in FIG. 14D as “tranches”) for a given security.

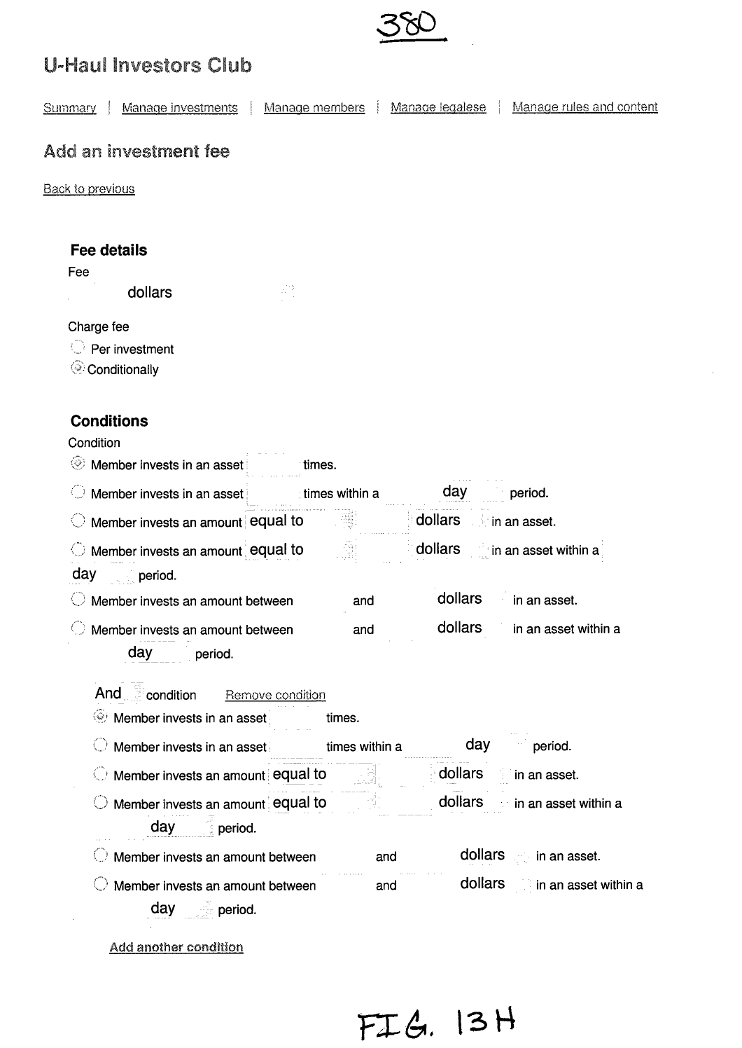

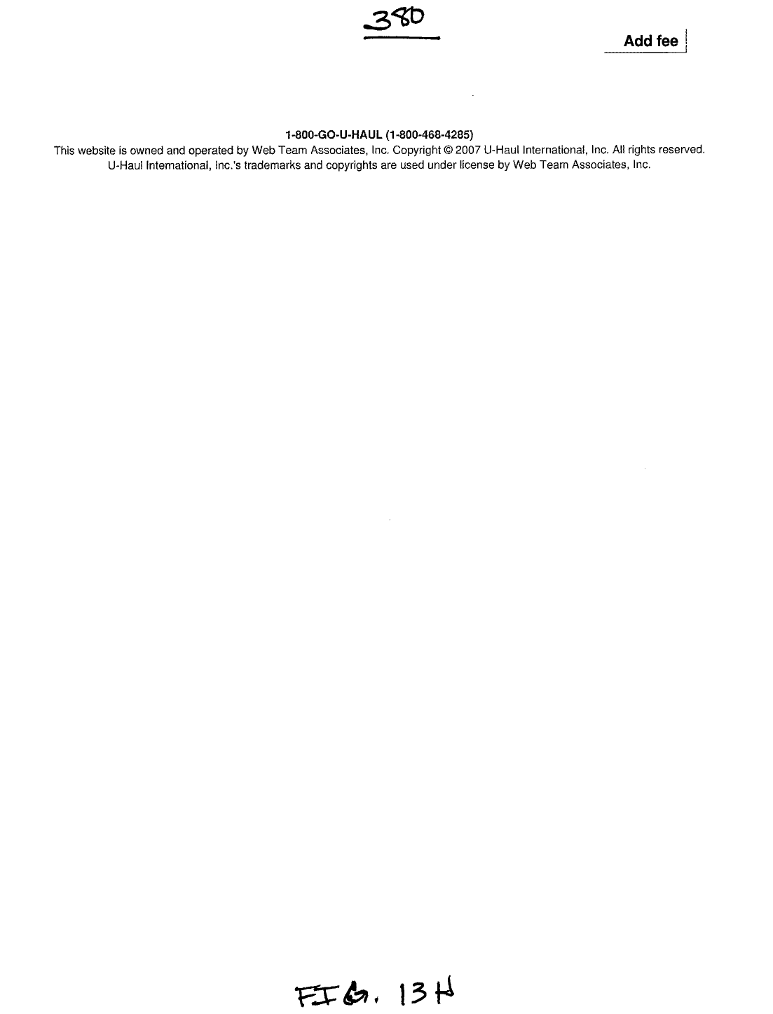

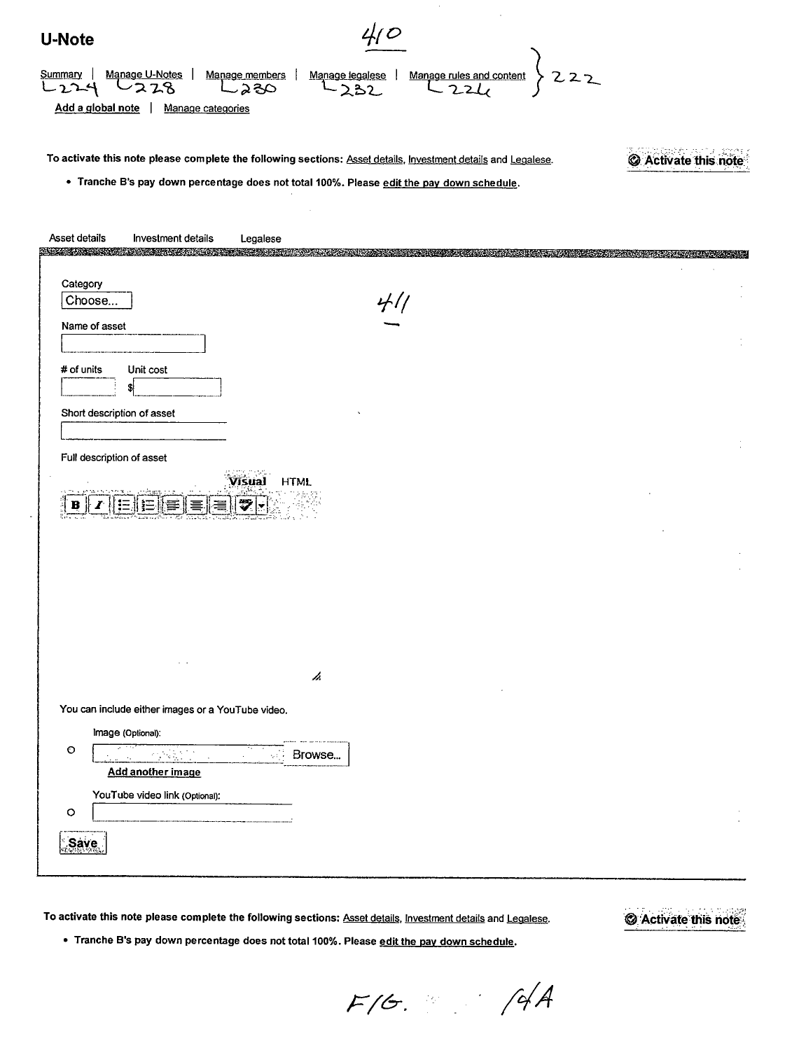

Referring again to FIG. 12A, when the administrative user clicks on the Manage Categories link 344, the system displays a Manage Categories page 430, as shown in FIG. 15, which lists the categories of collateral.

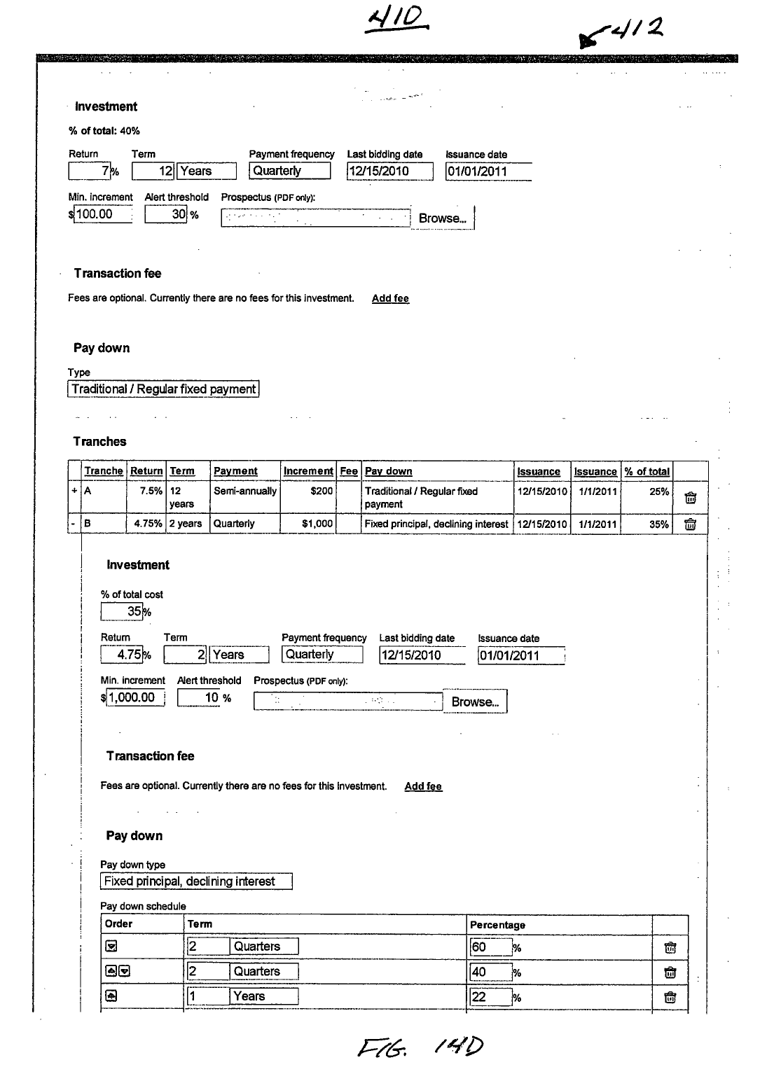

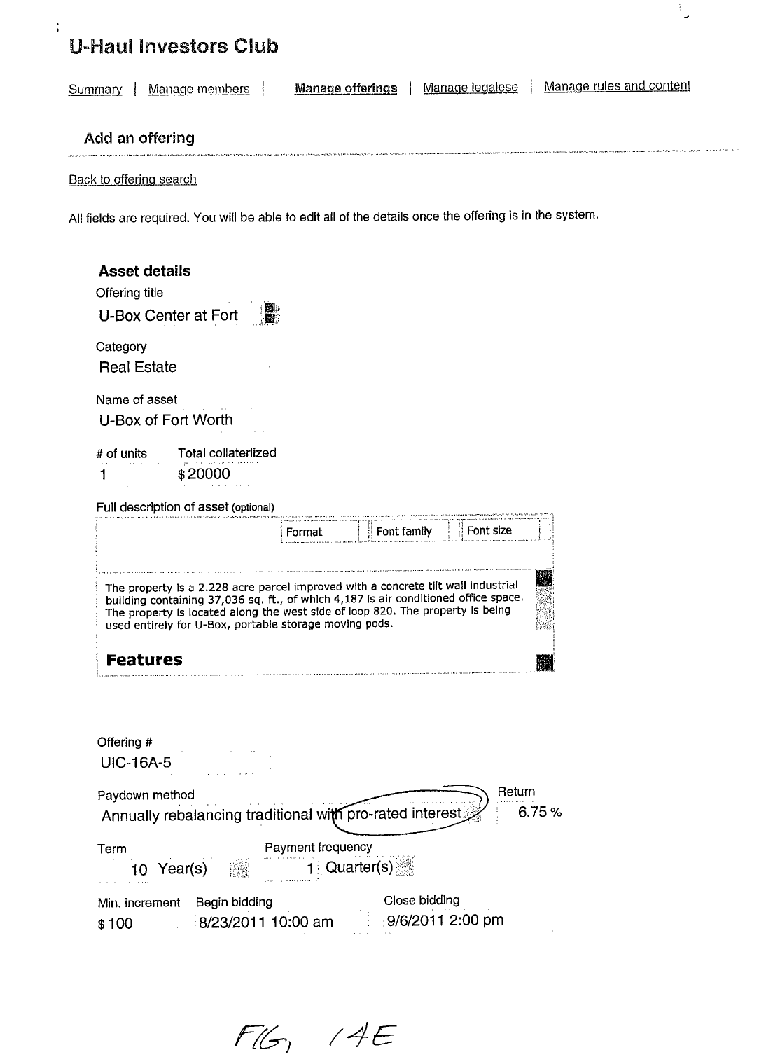

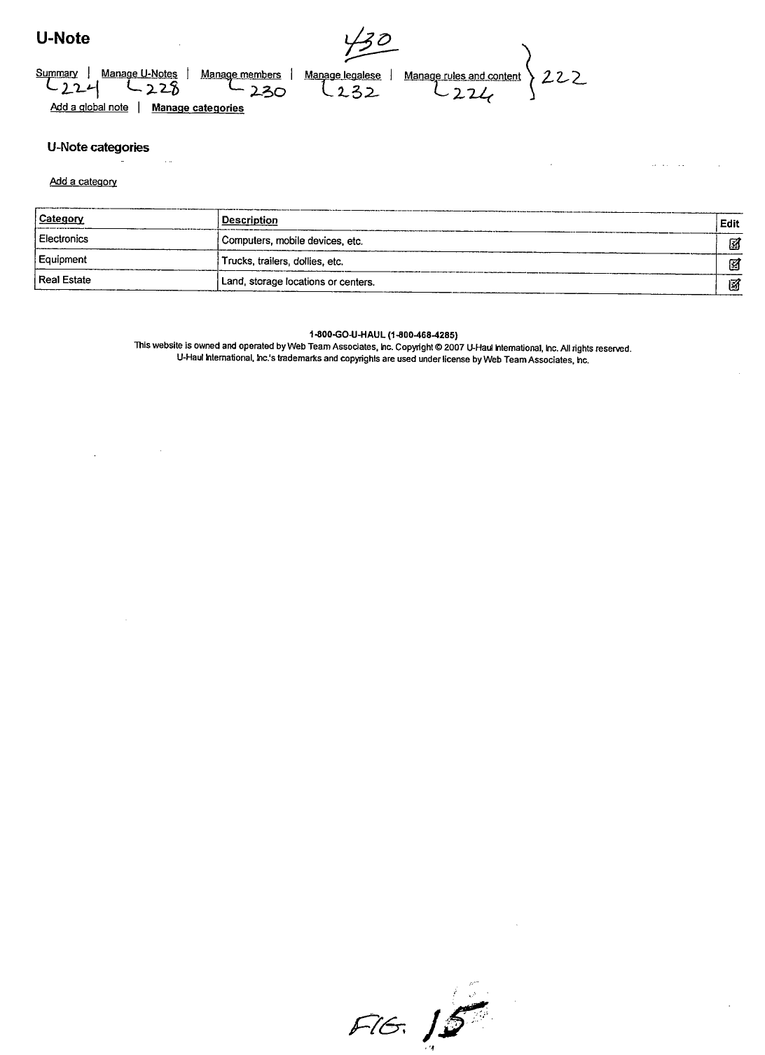

Referring again to FIG. 10, the Security Information page 300 includes an Add a Note link 342, which functions as described above. The user can send communications to holders of the displayed security by clicking on an Email Noteholders link 304, which displays an Email Noteholders page 480, as shown in FIG. 17A. The administrative user can compose and send a bulk email to all owners of the displayed security by selecting a Send Bulk Email button 482, or can send an email to one or more selected holders of the security by selecting the appropriate Send Email buttons 484. The system then displays a Compose Email page 490, as shown in FIG. 17B, for composing and sending the email.

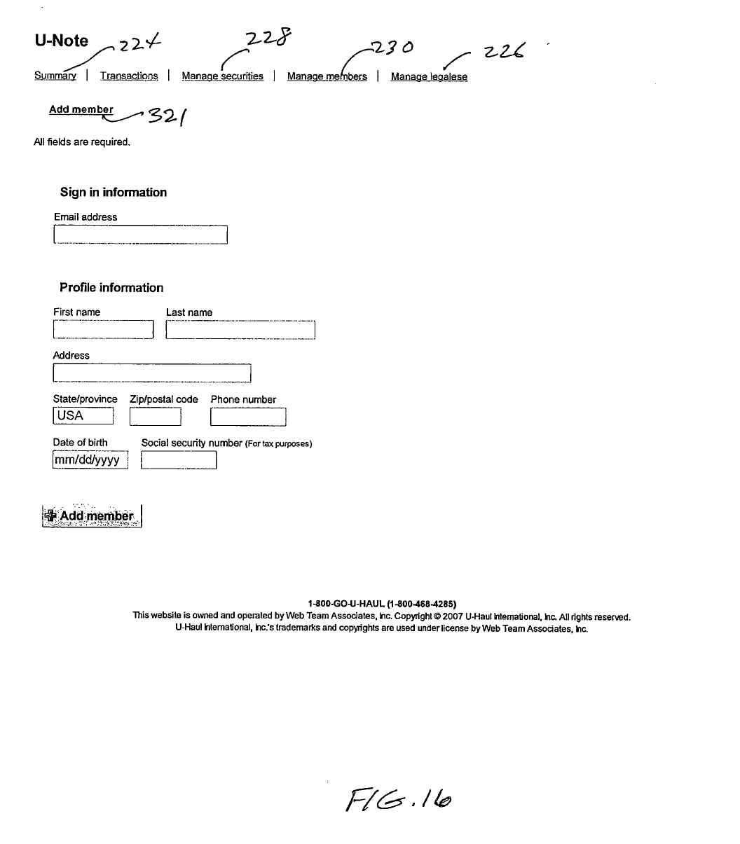

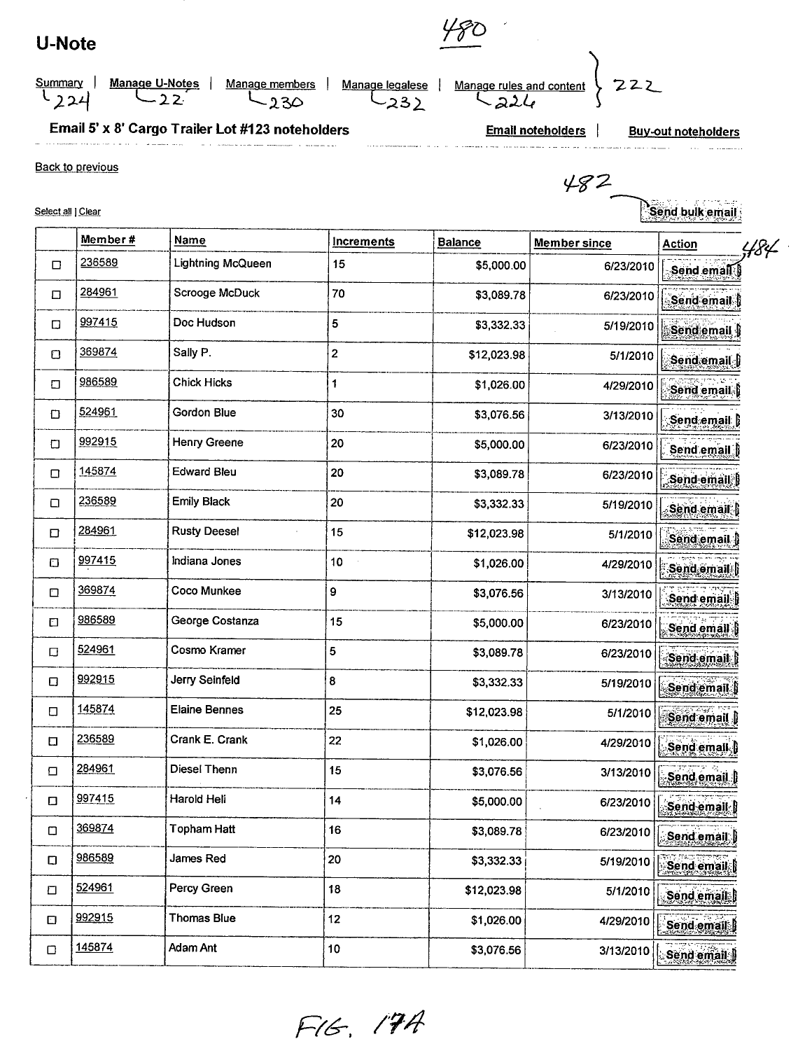

Still referring to FIG. 10, the administrative user can initiate a buyout of selected shares of the displayed security whereby the issuer purchases all or a portion of a selected security from the note holders. To initiate this process, the administrative user clicks on a Buy-out Noteholders link 306, which displays a Buyout page 500, as shown in FIG. 18A. To initiate a buyout, the administrative user selects a Bulk Buy-out button 502 or a Buy-out button 504 for one or more holders of the displayed security. In response, the system displays a Complete Buy-out page 530, as shown in FIG. 18B, which the administrative user can use to complete the buy-out process.

### Exemplary Offering

The method and system of the present invention have been used to offer debt securities over the Internet. The attached Appendix sets forth information relating to an example of one such offering of fixed rate notes issued by AMERCO and secured by a lien on a pool of U-Haul tow dollies. The information includes excerpts from a Prospectus Supplement filed with the U.S. Securities and Exchange Commission. The full prospectus is available online at http://www.edgar-online.com and is incorporated herein by this reference. According to this example, in order to subscribe to purchase the notes, prospective investors must set up a system account (referred to in the Prospectus Supplement as a U-Haul Investors Club online account) by becoming a member of the U-Haul Investors Club by complying with instructions available on the website at uhaulinvestorsclub.com. Also according to this example, the notes are issued as provided in the Prospectus Supplement over a period of time and from time to time, in separate sub-series, with each such sub-series bearing a unique interest rate and term. A prospective investor has the opportunity to select the sub-series of notes for which the prospective investor is subscribing.

From the foregoing, it will be understood that the method and system of the present invention will provide a number of advantages. The invention can enable an organization to issue collateralized debt securities backed by specific assets and in relatively small amounts. The securities can be issued and sold directly to retail investors without the assistance and cost of middlemen traditionally required for securities issuance. Individuals or small investors can purchase these securities directly from the issuer, allowing companies an alternative to traditional methods of financing corporate debt. The invention provides the company more control over the terms of the loans comprising the debt; it reduces cost, length of time and complexity of obtaining financing; it allows for fair yields and other favorable terms; and it provides transparency by allowing investors to see exactly what assets are securing the loan. By using the system and method of the invention, transactions between the issuer and investors can be conducted electronically without any paper or alternatively with extremely minimal paperwork (as required by government). In a presently preferred embodiment, the system of the invention is implemented using an Internet website, which investors can access using any device suitable for communication over the Internet, including without limitation, a personal computer, PDA, smartphone, handheld mobile digital electronic device, or the like.

Upon reading this disclosure, those skilled in the art will appreciate that various changes and modifications may be made to the preferred embodiments and methods of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

### APPENDIX

### Fixed Rate Secured Notes Series UIC-18A and UIC-20A

AMERCO has filed a registration statement (including a prospectus) with the U.S. Securities and Exchange Commission (SEC) for the offering to which this communication relates. Before investing, one should read the prospectus in that registration statement and other documents AMERCO ghas filed with the SEC for more complete information about AMERCO and the offering. You may get these documents for free by visiting EDGAR on the SEC website at www.sec.gov, or under “SEC filings” page of the U-Haul Investors Club website. Securities issued under the U-Haul Investors Club are not FDIC insured.

AMERCO is offering up to $3,552,000 aggregate principal amount of its Fixed Rate Secured Notes Series UIC-18A and UIC-20A (the “notes”). The notes will be issued over a period of time and from time to time, in up to four separate sub-series, with each such sub-series bearing a unique interest rate and term as provided herein. Prospective investors shall have the opportunity to select the sub-series of notes for which such prospective investor is subscribing. The notes are fully amortizing. Principal and interest on the notes will be credited to each holder's U-Haul Investors Club™ account in arrears every three months, beginning three months from the issue date, until the maturity date. The notes issued under Series UIC-18A are secured by a first-priority lien on a pool of U-Haul tow dollies (each, a “Tow Dolly Unit”); and the notes issued under Series UIC-20A are secured by a first priority lien on a pool of U-Haul furniture dollies (each, a “Furniture Dolly Unit”), in all cases subject to collateral substitutions as provided herein. For each $1,600 invested with us in the notes under Series UIC-18A, we will pledge to the trustee, for the benefit of the noteholders, one Tow Dolly Unit. For each $1,600 invested with us in the notes under Series UIC-20A, we will pledge to the trustee, for the benefit of the noteholders, forty Furniture Dolly Units.

With respect to each sub-series of the notes, the terms and interest rates are as follows:

Series UIC-18A:
5 year term, the sub-series of notes shall bear interest at 5.05%
6 year term, the sub-series of notes shall bear interest at 5.57%
7 year term, the sub-series of notes shall bear interest at 6.10%

Series UIC-20A:
2 year term, the sub-series of notes shall bear interest at 3.00% No underwriter or other third-party has been engaged to facilitate the sale of the notes in this offering.

The notes are not savings accounts, deposit accounts or money market funds. The notes are not guaranteed or insured by the Federal Deposit Insurance Corporation, the Federal Reserve or any other governmental agency.

See “Risk Factors” [described in the Prospectus Supplement] to read about important facts you should consider before buying the notes.

Neither the Securities and Exchange Commission nor any other regulatory body has approved or disapproved of these securities or passed upon the accuracy or adequacy of this prospectus supplement or the accompanying prospectus. Any representation to the contrary is a criminal offense.

The notes are being issued in uncertificated book-entry form only, and will not be listed on any securities exchange.

### The Offering

The following summary describes the principal terms of the notes and the U-Haul Investors Club. Certain of the terms and conditions below are subject to important limitations and exceptions. For a more detailed description of the terms and conditions of the notes and the U-Haul Investors Club, see “Description of the Notes” set forth below and “U-Haul Investors Club” set forth below.

### Issuer: AMERCO.

### Notes Offered; Notes Issued in Sub-Series:

Up to $3,552,000 aggregate principal amount of Fixed Rate Secured Notes Series UIC-18A and UIC-20A (the “notes”). The notes will be issued over a period of time and from time to time in up to four separate sub-series, with each such sub-series bearing a unique interest rate and term as provided herein. Prospective investors shall have the opportunity to select the sub-series of notes for which such prospective investor is subscribing.

### Issue Date:

Notes will be issued within five business days following our receipt and acceptance of investor subscriptions with respect to any sub-series of the notes in the aggregate principal amount of up to $20,000 for such sub-series, or at such other time as AMERCO determines in its sole discretion. Interest on issued notes shall commence to accrue on the issue date. Each sub-series of the notes may have more than one issue date.

### Sub-Series Interest Rate and Term:

The respective sub-series of notes hereunder shall bear the following interest rate and term:

Series UIC-18A:
5 year term, the sub-series of notes shall bear interest at 5.05%
6 year term, the sub-series of notes shall bear interest at 5.57%
7 year term, the sub-series of notes shall bear interest at 6.10%

Series UIC-20A:
2 year term, the sub-series of notes shall bear interest at 3.00%

### Minimum Investment: $100

### Principal and Interest Payment Date; Credited to Holders' U-Haul Investors Club Account:

The notes are fully amortizing. Principal and interest on the notes will be credited to each holder's U-Haul Investors Club account in arrears on the payment date, which is every three months, beginning three months from the issue date through the maturity date. Principal and interest will be credited to the U-Haul Investors Club accounts of the holders who own the notes as of each applicable record date.

### Record Date:

The record date is the first day of the month preceding the related due date for the crediting of principal and interest on the notes.

### Initial Collateral:

The notes issued under Series UIC-18A are secured by a first-priority lien on a pool of U-Haul tow dollies (each, a “Tow Dolly Unit”); and the notes issued under Series UIC-20A are secured by a first priority lien on a pool of U-Haul furniture dollies (each, a “Furniture Dolly Unit” and together with the Tow Dolly Units, the “Initial Collateral”), in all cases subject to collateral substitutions as provided herein. For each $1,600 invested with us in the notes under Series UIC-18A, we will pledge to the trustee, for the benefit of the noteholders, one Tow Dolly Unit. For each $1,600 invested with us in the notes under Series UIC-20A, we will pledge to the trustee, for the benefit of the noteholders, forty Furniture Dolly Units.
The Initial Collateral is owned by U-Haul Leasing & Sales Co., a Nevada corporation (“Owner”), an indirect subsidiary of AMERCO. The Initial Collateral is utilized in the operations of the U-Haul system, in which U-Haul rental equipment and self-storage units are rented to customers in the ordinary course of business. No appraisal of the Initial Collateral has been or will be prepared by us or on our behalf in connection with this offering.

### Substitution of Collateral:

AMERCO has the right, in its sole discretion, to substitute or to cause any third party or affiliate to substitute any assets (the “Replacement Collateral”) for all or part of the Collateral that from time to time secures the notes or any sub-series thereof, including the Initial Collateral and any Replacement Collateral (the “Collateral”), provided that the value of the Replacement Collateral is at least 100% of the value of the Collateral that is released at the time of substitution (the “Released Collateral”). In connection with any substitution of Collateral, the value of the Replacement Collateral and the Released Collateral is determinable by AMERCO in its sole discretion, and no appraisal will be prepared by us or on our behalf in this regard. AMERCO is permitted to make an unlimited number Collateral substitutions.
The value of the Collateral at any time will depend on market and other economic conditions, including the availability of suitable buyers for the Collateral.

### Ranking:

The notes are secured in the Collateral and will rank equally among themselves.

### No Subsidiary Guarantees:

The notes are not guaranteed by any subsidiary of AMERCO, and therefore will be effectively structurally subordinated to all of the existing and future claims of creditors of each of AMERCO's subsidiaries, including U-Haul.

### Covenants:

The notes are being issued under a base indenture (“base indenture”) between AMERCO and U.S. Bank National Association, as trustee (the “trustee”), an indenture supplement (“indenture supplement”) between AMERCO and the trustee, and a pledge and security agreement (“security agreement”, and together with the base indenture, the indenture supplement, and any other instruments and documents executed and delivered pursuant to the foregoing documents, as the same may be amended, supplemented or otherwise modified from time to time, the “financing documents”) among AMERCO, the trustee and Owner. The financing documents contain certain covenants for the benefit of the holders. These covenants consist of:
maintenance of a first-priority lien on the Collateral; and
prohibition of additional liens on the Collateral.

### Optional Redemption:

Under the terms of the financing documents, the notes or any sub-series thereof may be redeemed by AMERCO in its sole discretion at any time, in whole or in part on a pro rata basis, without penalty, premium or fee, at a price equal to 100% of the principal amount then outstanding, plus accrued and unpaid interest, if any, through the date of redemption.

### Use of Proceeds:

AMERCO intends to use the net proceeds from this offering to reimburse its subsidiaries and affiliates for the cost of production of the Collateral and for other general corporate purposes.

### Listing:

The notes will not be listed on any national securities exchange.

### Rating:

The notes will not be rated by any statistical rating organization.

### U-Haul Investors Club:

Through this offering, AMERCO is extending to investors the opportunity to subscribe to purchase notes. In order to subscribe to purchase notes, prospective investors must become a member of the U-Haul Investors Club and comply with the instructions available on our website at uhaulinvestorsclub.com. Among other things, this will require the prospective investor to:
   complete a membership application;
   complete a note subscription offer;
   set up a U-Haul Investors Club online account through which you will be able to transfer funds from your linked U.S. bank account to pay for the notes; and
   receive and deliver in electronic format any and all documents, statements and communications related to the offering, the notes and the U-Haul Investors Club.
AMERCO reserves the right to reject, in whole or in part, in its sole discretion, any subscription to purchase notes. Before AMERCO closes the offering, you may withdraw your subscription to purchase notes.
AMERCO intends to offer additional securities through the U-Haul Investors Club simultaneously with this offering and in the future.

### Form of Notes:

The notes are being issued in uncertificated book-entry form only, through the U-Haul Investors Club website.

### Transferability:

The notes are not transferable except between members of the U-Haul Investors Club through privately negotiated transactions. The notes will not be listed on any securities exchange, and there is no anticipated public market for the notes. Therefore, investors must be prepared to hold their notes until the maturity date.

### Servicer:

The notes will be serviced exclusively by U-Haul International, Inc., a subsidiary of AMERCO, or its designee.

### Rick Factors:

An investment in the notes involves substantial risk. See “Risk Factors” [described in the Prospectus Supplement] for a description of certain risks you should consider before investing in the notes.

### DESCRIPTION OF NOTES

The following description is a summary of the material provisions of the notes and the financing documents under which the notes are being issued. Each of the financing documents and the notes that will be executed and delivered upon the issuance date, and not the description of the financing documents and the notes in this prospectus supplement, defines your rights as holders of the notes. Copies of the financing documents will be available electronically through the U-Haul Investors Club website. You may also request electronic copies of the financing documents from AMERCO as indicated under “Where You Can Find More Information” in this prospectus supplement.

### Brief Description of the Notes

The notes are:
   to be issued over a period of time and from time to time in up to four separate sub-series, with each such sub-series bearing a unique interest rate and term as provided herein. Prospective investors shall have the opportunity to select the sub-series of notes for which such prospective investor is subscribing;
   being issued under a base indenture entered into between AMERCO and the trustee, an indenture supplement between AMERCO and the trustee, and a pledge and security agreement among AMERCO, the trustee and the Owner (collectively, and together with any other instruments and documents executed and delivered pursuant to the foregoing documents, as the same may be amended, supplemented or otherwise modified from time to time, the “financing documents”);
   AMERCO's obligations only, and not guaranteed by any of AMERCO's subsidiaries, and therefore are structurally subordinated to the claims of existing and future creditors of AMERCO's subsidiaries, including U-Haul;
   obligations of AMERCO, secured by a first-priority lien on the Collateral;
   ranked equally among themselves; and
   being issued by AMERCO in uncertificated book-entry form only.
      The notes will not be listed on any securities exchange. There is no market for the notes.

### Principal, Maturity and Interest; Amortization Schedule

The notes are secured debt securities under the financing documents and are limited to the aggregate principal amount identified above. The notes will be issued over a period of time and from time to time, in up to four sub-series, with terms and interest rates as follows:

### Series UIC-18A:

5 year term, the sub-series of notes shall bear interest at 5.05%
6 year term, the sub-series of notes shall bear interest at 5.57%
7 year term, the sub-series of notes shall bear interest at 6.10%

### Series UIC-20A:

2 year term, the sub-series of notes shall bear interest at 3.00%

The notes issued under Series UIC-18A will initially be secured by a first-priority lien on a pool of U-Haul tow dollies (each, a “Tow Dolly Unit”); and the notes issued under Series UIC-20A will initially be secured by a first priority lien on a pool of U-Haul furniture dollies (each, a “Furniture Dolly Unit”), in all cases subject to collateral substitutions as provided herein. For each $1,600 invested with us in the notes under Series UIC-18A, we will pledge to the trustee, for the benefit of the note holders, one Tow Dolly Unit. For each $1,600 invested with us in the notes under Series UIC-20A, we will pledge to the trustee, for the benefit of the note holders, forty Furniture Dolly Units.

The notes are being issued in minimum denominations of $100 and integral multiples of $100 thereof.

The respective notes accrue interest at the interest rates identified above, commencing as of the issue date. Interest on the notes is computed on the basis of a 360-day year comprised of twelve 30-day months. The notes are fully amortizing. Payments of principal and the accrued interest will be credited to the respective holder's U-Haul Investors Club account, in arrears every three months, commencing three months from the issue date and ending on the maturity date, as reflected in the following payment schedules. Interest on the notes is calculated based upon the outstanding balance of the notes at the time interest is due. The following schedules illustrate investments of $100 in each of the four sub-series of the notes.

Series UIC-18A, 5 year term, 5.05% interest rate:

| Payment | | | | |
|---|---|---|---|---|
| Number | Note Balance | Principal | Interest | Payout |
| 1 | $100.00 | $5.00 | $1.26 | $6.26 |
| 2 | $95.00 | $5.00 | 1.20 | 6.20 |
| 3 | 90.00 | $5.00 | 1.14 | 6.14 |
| 4 | 85.00 | $5.00 | 1.07 | 6.07 |
| 5 | 80.00 | $5.00 | 1.01 | 6.01 |
| 6 | 75.00 | $5.00 | 0.95 | 5.95 |
| 7 | 70.00 | $5.00 | 0.88 | 5.88 |
| 8 | 65.00 | $5.00 | 0.82 | 5.82 |
| 9 | 60.00 | $5.00 | 0.76 | 5.76 |
| 10 | 55.00 | $5.00 | 0.69 | 5.69 |
| 11 | 50.00 | $5.00 | 0.63 | 5.63 |
| 12 | 45.00 | $5.00 | 0.57 | 5.57 |
| 13 | 40.00 | $5.00 | 0.51 | 5.51 |
| 14 | 35.00 | $5.00 | 0.44 | 5.44 |
| 15 | 30.00 | $5.00 | 0.38 | 5.38 |
| 16 | 25.00 | $5.00 | 0.32 | 5.32 |
| 17 | 20.00 | $5.00 | 0.25 | 5.25 |
| 18 | 15.00 | $5.00 | 0.19 | 5.19 |
| 19 | 10.00 | 5.00 | 0.13 | 5.13 |
| 20 | 5.00 | 5.00 | 0.06 | 5.06 |
| Total | | $100.00 | $13.26 | $113.26 |

Series UIC-18A, 6 year term, 5.57% interest rate:

| Payment | | | | |
|---|---|---|---|---|
| Number | Note Balance | Principal | Interest | Payout |
| 1 | $100.00 | $4.17 | $1.39 | $5.56 |
| 2 | 95.83 | 4.17 | 1.33 | 5.50 |
| 3 | 91.66 | 4.17 | 1.28 | 5.45 |
| 4 | 87.49 | 4.17 | 1.22 | 5.39 |
| 5 | 83.32 | 4.17 | 1.16 | 5.33 |
| 6 | 79.15 | 4.17 | 1.10 | 5.27 |
| 7 | 74.98 | 4.17 | 1.04 | 5.21 |
| 8 | 70.81 | 4.17 | 0.99 | 5.16 |
| 9 | 66.64 | 4.17 | 0.93 | 5.10 |
| 10 | 62.47 | 4.17 | 0.87 | 5.04 |
| 11 | 58.30 | 4.17 | 0.81 | 4.98 |
| 12 | 54.13 | 4.17 | 0.75 | 4.92 |
| 13 | 49.96 | 4.17 | 0.70 | 4.87 |
| 14 | 45.79 | 4.17 | 0.64 | 4.81 |
| 15 | 41.62 | 4.17 | 0.58 | 4.75 |
| 16 | 37.45 | 4.17 | 0.52 | 4.69 |
| 17 | 33.28 | 4.17 | 0.46 | 4.63 |
| 18 | 29.11 | 4.17 | 0.41 | 4.58 |
| 19 | 24.94 | 4.17 | 0.35 | 4.52 |
| 20 | 20.77 | 4.17 | 0.29 | 4.46 |
| 21 | 16.60 | 4.17 | 0.23 | 4.40 |
| 22 | 12.43 | 4.17 | 0.17 | 4.34 |
| 23 | 8.26 | 4.17 | 0.12 | 4.29 |
| 24 | 4.09 | 4.17 | 0.06 | 4.15 |
| Total | | $100.00 | $17.40 | $117.40 |

Series UIC-18A, 7 year term, 6.10% interest rate:

| Payment | | | | |
|---|---|---|---|---|
| Number | Note Balance | Principal | Interest | Payout |
| 1 | $100.00 | $3.57 | $1.53 | $5.10 |
| 2 | 96.43 | 3.57 | 1.47 | 5.04 |
| 3 | 92.86 | 3.57 | 1.42 | 4.99 |
| 4 | 89.29 | 3.57 | 1.36 | 4.93 |
| 5 | 85.72 | 3.57 | 1.31 | 4.88 |
| 6 | 82.15 | 3.57 | 1.25 | 4.82 |
| 7 | 78.58 | 3.57 | 1.20 | 4.77 |
| 8 | 75.01 | 3.57 | 1.14 | 4.71 |
| 9 | 71.44 | 3.57 | 1.09 | 4.66 |
| 10 | 67.87 | 3.57 | 1.04 | 4.61 |
| 11 | 64.30 | 3.57 | 0.98 | 4.55 |
| 12 | 60.73 | 3.57 | 0.93 | 4.50 |
| 13 | 57.16 | 3.57 | 0.87 | 4.44 |
| 14 | 53.59 | 3.57 | 0.82 | 4.39 |
| 15 | 50.02 | 3.57 | 0.76 | 4.33 |
| 16 | 46.45 | 3.57 | 0.71 | 4.28 |
| 17 | 42.88 | 3.57 | 0.65 | 4.22 |
| 18 | 39.31 | 3.57 | 0.60 | 4.17 |
| 19 | 35.74 | 3.57 | 0.55 | 4.12 |
| 20 | 32.17 | 3.57 | 0.49 | 4.06 |
| 21 | 28.60 | 3.57 | 0.44 | 4.01 |
| 22 | 25.03 | 3.57 | 0.38 | 3.95 |
| 23 | 21.46 | 3.57 | 0.33 | 3.90 |
| 24 | 17.89 | 3.57 | 0.27 | 3.84 |
| 25 | 14.32 | 3.57 | 0.22 | 3.79 |
| 26 | 10.75 | 3.57 | 0.16 | 3.73 |
| 27 | 7.18 | 3.57 | 0.11 | 3.68 |
| 28 | 3.61 | 3.57 | 0.06 | 3.67 |
| Total | | $100.00 | $22.14 | $122.14 |

Series UIC-20A, 2 year term, 3.00% interest rate:

| Payment | | | | |
|---|---|---|---|---|
| Number | Note Balance | Principal | Interest | Payout |
| 1 | $100.00 | $14.50 | $0.75 | $15.25 |
| 2 | 85.50 | 14.50 | 0.64 | 15.14 |
| 3 | 71.00 | 14.50 | 0.53 | 15.03 |
| 4 | 56.50 | 14.50 | 0.42 | 14.92 |
| 5 | 42.00 | 10.50 | 0.32 | 10.82 |
| 6 | 31.50 | 10.50 | 0.24 | 10.74 |
| 7 | 21.00 | 10.50 | 0.16 | 10.66 |
| 8 | 10.50 | 10.50 | 0.08 | 10.58 |
| Total | | $100.00 | $3.14 | $103.14 |

The record date is the first day of the month preceding the related due date for the crediting of principal and interest on the notes in the holder's U-Haul Investors Club account. If any date for the crediting of principal and interest into a holder's U-Haul Investors Club account, including the maturity date, falls on a day that is not a business day, the required crediting of principal and interest on the notes shall be due and made on the next day constituting a business day.

### Additional Issuances

AMERCO may not create or issue additional notes secured by the Collateral unless it obtains the consent of holders of at least 51% of the principal amount of the outstanding notes. However, AMERCO intends to offer additional securities through the U-Haul Investors Club simultaneously with this offering and in the future, including securities that are secured by assets owned by AMERCO or its subsidiaries other than the Collateral, which it may do in its sole discretion and without the consent of the holders of the notes.

### Ranking

The notes are the obligations of AMERCO only. The notes are not being guaranteed by any of AMERCO's subsidiaries, and therefore will effectively be structurally subordinated to the claims of existing and future creditors of AMERCO's subsidiaries, including U-Haul. Other than with respect to the Collateral, the notes rank equally in right of payment with any existing and future unsecured indebtedness of AMERCO.

### Optional Redemption

The notes or any sub-series or other portion thereof may be redeemed by AMERCO in its sole discretion at any time, in whole or in part on a pro rata basis or on any other basis as determined by AMERCO in its sole discretion, without penalty, premium or fee, at a price equal to 100% of the principal amount then outstanding, plus accrued and unpaid interest, if any, through the date of redemption. In the event of a redemption, AMERCO will cause notices of redemption to be emailed, to the email address associated with your account, at least 10 but not more than 30 days before the redemption date to each applicable registered holder of notes. However, AMERCO is under no obligation to redeem the notes in whole or in part, under any circumstances. Accordingly, investors must be prepared to hold the notes until the maturity date.

### Security Interest and Initial Collateral

The obligations of AMERCO with respect to the notes are initially secured by a first-priority lien on the Initial Collateral. The Initial Collateral is being pledged by the Owner to the trustee (or the trustee's agent, nominee or nominee mortgagee or titleholder) for the benefit of the holders, pursuant to the financing documents.

### Substitution of Collateral

AMERCO has the right, in its sole discretion, to substitute or to cause one or more affiliates or third parties to substitute any assets (the “Replacement Collateral”) for all or part of the Collateral that from time to time secures the notes, including the Initial Collateral and any Replacement Collateral (the “Collateral”), provided that the value of the Replacement Collateral is at least 100% of the value of the Collateral that is released at the time of substitution (the “Released Collateral”) and provided further that the owner of such Replacement Collateral promptly enters a separate pledge and security agreement, substantially in the form of the pledge agreement, and executes such other documents and instruments as may be necessary or appropriate to grant to the trustee, for the benefit of the holders, a first-priority lien on such Replacement Collateral. In connection with any substitution of Collateral, the value of the Replacement Collateral and the Released Collateral is determinable by AMERCO in its sole discretion, and no appraisal will be prepared by us or on our behalf in this regard. AMERCO is permitted to make an unlimited number Collateral substitutions.

AMERCO may make a substitution of Collateral by delivering a written certificate to the trustee executed by an officer of AMERCO which contains (i) a description of the Replacement Collateral, (ii) a statement that such Replacement Collateral has been pledged by the owner thereof to the trustee, for the benefit of the holders, pursuant to the financing documents, (iii) a description of the Released Collateral and (iv) a certification by AMERCO that the value of the Replacement Collateral is at least 100% of the value of the Released Collateral. Upon the trustee's receipt of such notice, the Replacement Collateral will be deemed “Collateral”, and the Released Collateral will be released from the first-priority lien thereon and will no longer be subject to the terms of the financing documents. The trustee shall have no duty to evaluate the determination made in such certificate and shall be allowed to conclusively rely on such certificate from AMERCO.

### Perfection of Security Interest in the Collateral

The financing documents require AMERCO to file, or cause the filing of, such documents and instruments, in all appropriate jurisdictions and recording offices, as are necessary or appropriate to perfect and protect the trustee's first-priority lien on the Collateral.

### Use and Release of Collateral

Unless an Event of Default has occurred and is continuing, and the trustee shall have commenced an enforcement of remedies under the financing documents, AMERCO and its subsidiaries, including U-Haul, have the right to:
remain in possession and retain exclusive control of the Collateral;
freely operate the Collateral, including, without limitation, by integrating the Collateral into the U-Haul system and using it or renting it to customers, as the case may be, in the ordinary course of business; and
collect, invest and dispose of any income thereon, which income will not constitute part of the Collateral.

Release of Collateral. The financing documents provide that the first-priority lien on the Collateral with respect to the notes or any subseries or other portion thereof will automatically be released, whether in full or incrementally, as the case may be, upon (1) satisfaction of all of AMERCO's obligations with respect to the applicable notes, sub-series of the notes or other portion thereof, whether due to a scheduled repayment in full or a redemption; or (2) discharge, legal defeasance or covenant defeasance of AMERCO's obligations with respect to the applicable notes or sub-series or other portion thereof, as described below under “Discharge, Defeasance and Covenant Defeasance”.

### Further Assurances; After Acquired Collateral

The financing documents provide that AMERCO shall, at its expense, duly execute and deliver, or cause to be duly executed and delivered, such further agreements, documents and instruments, and do or cause to be done such further acts as may be necessary or proper, or which the trustee may reasonably request, to evidence, perfect, maintain and enforce the first-priority lien on the Collateral and the benefits intended to be conferred thereby, and to otherwise effectuate the provisions or purposes of, the financing documents.

Upon the acquisition by the Company after the issue date of (1) any after-acquired assets, including, but not limited to, any after-acquired equipment or fixtures which constitute accretions, additions or technological upgrades to the equipment or fixtures or any working capital assets that, in any such case, form part of the Collateral, or (2) any proceeds (as defined in the UCC of any relevant jurisdiction) from a sale or other disposition of the Collateral, AMERCO shall execute and deliver, to the extent required, any information, documentation, financing statements or other certificates as may be necessary to vest in the trustee a perfected security interest, subject only to Permitted Liens, in such after-acquired property and to have such after-acquired property added to the Collateral, and thereupon all provisions of the financing documents relating to the Collateral shall be deemed to relate to such after-acquired property to the same extent and with the same force and effect.

### Change of Control, Merger, Consolidation or Sale of Assets

The holders of the notes do not have the right to require AMERCO to repurchase the notes in connection with a change of control of the Company, a merger of the Company, a consolidation of the Company or the sale of all or substantially all of the assets of the Company or its subsidiaries, to or with any Person.

### Covenants

The covenants with respect to the notes consist of the following:

Maintenance of first prioritylien on the Collateral. So long as any of the notes are outstanding, AMERCO and Owner are required to maintain, subject to Permitted Liens, and may not take any action to negate, the first-priority lien on the Collateral or the benefits intended to be conferred thereby.

Prohibition of additional liens on the Collateral. Neither AMERCO nor Owner is permitted to incur any Lien of any nature whatsoever on the Collateral, other than the first-priority lien pursuant to the financing documents and Permitted Liens.

### Events of Default, Waiver and Notice

The events of default with respect to the notes (each, an “Event of Default”), consist of the following:

Nonpayment. The default in the crediting of principal or interest when due to a holder's U-Haul Investors Club account, and the continuance of such default for a period of 30 days.

Failure to maintain first-priority lien on the Collateral. Failure by the Company or Owner to maintain the first-priority Lien on the Collateral, subject to Permitted Liens, continued for 90 days after written notice thereof to the Company from the trustee or to the Company and the trustee from the holders of at least 51% in principal amount of the outstanding notes, specifying such default or breach and requiring it to be remedied and stating that such notice is a “notice of default” pursuant to the financing documents.

Incurrence of additional Liens on the Collateral. The incurrence by the Company, Owner or any of their respective affiliates of any additional Lien on the Collateral, other than Permitted Liens and the Lien pursuant to the financing documents, continued for 90 days after written notice thereof to the Company from the trustee or to the Company and the trustee from the holders of at least 51% in principal amount of the outstanding notes, specifying such default or breach and requiring it to be remedied and stating that such notice is a “notice of default” pursuant to the financing documents.

If an Event of Default under the indenture supplement or pledge agreement occurs and is continuing, then the trustee, on behalf of the holders, if it has notice or actual knowledge of such Event of Default, has the right to declare the principal amount of the notes outstanding to be due and payable immediately by written notice to AMERCO and to the servicer. A default or Event of Default under the notes does not cause, and is not caused by, a default or event of default under any other notes issued pursuant to the U-Haul Investors Club.

Waiver. The indenture provide that the holders of not less than 51% in principal amount of the outstanding notes may waive any past Default with respect to the notes and its consequences, except a Default in the crediting of the principal and interest due on the notes.

Notice. The trustee is required, but only to the extent the trustee has notice or knowledge of such Default, to give notice to the holders of the notes within 90 days of a Default, unless the Default has been cured or waived; but the trustee may withhold notice of any Default, except a Default in the crediting of the principal of, or premium, if any, or interest on the notes, if specified responsible officers of the trustee consider the withholding to be in the interest of the holders.

The holders of the notes may not institute any proceedings, judicial or otherwise, with respect to the indenture or for any remedy under the indenture, except in the case of failure of the trustee, for 60 days, to act after the trustee has received a written request to institute proceedings in respect of an Event of Default from the holders of not less than 51% in principal amount of the outstanding notes, as well as an offer of indemnity satisfactory to the trustee, and provided that no direction inconsistent with such written request has been given to the trustee during such 60-day period by the holders of a majority of the outstanding notes. However, no holder of notes is prohibited from instituting suit for the enforcement of payment of the principal of and interest on the notes when due.

The trustee is not under any obligation to exercise any of its rights or powers under the financing documents at the request or direction of any holders of the notes outstanding under the indenture, unless the holders offer to the trustee security or indemnity that is satisfactory to it. Subject to such provisions for the indemnification of the trustee, the holders of not less than a majority in principal amount of the outstanding notes have the right to direct the time, method and place of conducting any proceeding for any remedy available to the trustee, and to exercise any trust or power conferred upon the trustee. However, the trustee may refuse to follow any direction that is in conflict with any law or the indenture that may involve the trustee in personal liability or may be unduly prejudicial to the holders of the notes not joining in the direction.

### Modifications

Modification of the indenture. With the consent of the holders of not less than 51% of the principal amount of all outstanding notes, AMERCO may enter into supplemental indentures with the trustee for the purpose of adding any provisions to or changing in any manner or eliminating any of the provisions of the indenture or modifying in any manner the rights of the holders of the notes. However, no modification or amendment may, without the consent of each holder of notes:
extend the time of crediting of principal and interest on the notes;
reduce the principal amount of, or the rate or amount of interest on, the notes;
impair the right to institute suit for the enforcement of any payment on or with respect to the notes; or
reduce the percentage of outstanding notes necessary to modify or amend the indenture, to waive compliance with specific provisions of or certain defaults and consequences under the indenture, or to reduce the quorum or voting requirements set forth in the indenture.

AMERCO and the trustee may modify and amend the indenture without the consent of any holder of notes for any of the following purposes:
to evidence the succession of another Person to AMERCO as obligor under the indenture;
to add to other covenants for the benefit of the holders of the notes or to surrender any right or power conferred upon AMERCO, Owner, or their respective affiliates, as provided in the financing documents;
to add events of default for the benefit of the holders of the notes;
to add or change any provisions of the indenture to facilitate the issuance of, or to liberalize specific terms of, debt securities in bearer form, or to permit or facilitate the issuance of debt securities in uncertificated form, provided that the action will not adversely affect the interests of the holders of the notes in any material respect;
to change or eliminate any provisions of the indenture, if the change or elimination becomes effective only when there are no debt securities outstanding of any series created prior to the change or elimination that are entitled to the benefit of the changed or eliminated provision;
to establish the form or terms of debt securities of any series and any related coupons;
to provide for the acceptance of appointment by a successor trustee or facilitate the administration of the trusts under the indenture by more than one trustee;
to cure any ambiguity or correct any inconsistency in the indenture provided that the cure or correction does not adversely affect the holders of the notes;
to supplement any of the provisions of the indenture to the extent necessary to permit or facilitate defeasance and discharge of the notes, provided that the supplement does not adversely affect the interests of the holders of the notes in any material respect;
to add to, delete from or revise the conditions, limitations or restrictions on issue, authentication and delivery of the notes;
to conform any provision in the indenture to the requirements of the Trust Indenture Act; or
to make any change that does not adversely affect the legal rights under the indenture of any holder of notes.
In determining whether the holders of the requisite principal amount of outstanding notes have given any request, demand, authorization, direction, notice, consent or waiver under the indenture or whether a quorum is present at a meeting of holders of the notes, the principal amount of the notes that is deemed to be outstanding will be the amount of the principal that would be due and payable as of the date of the determination upon declaration of acceleration of the maturity of the notes.

The Trustee shall be entitled to receive, and shall be fully protected in relying upon, an officers' certificate and an opinion of counsel to the effect that the execution of any such amendment or modification is authorized or permitted pursuant to the financing documents and has been duly authorized, executed and delivered by, and is a valid, binding and enforceable obligation of, the Company, subject to customary exceptions, and that all conditions precedent under the financing documents, if any, have been satisfied.

### Discharge, Defeasance and Covenant Defeasance

Discharge. AMERCO can discharge specific obligations to holders of the notes or any sub-series thereof (1) that have not already been delivered to the trustee for cancellation and (2) that either have become due and payable or will, within one year, become due and payable, by irrevocably depositing with the trustee, in trust, money or funds certified to be sufficient to pay when due the principal of and interest on the notes.

Defeasance and covenant defeasance. AMERCO may elect either:
defeasance, which means AMERCO elects to defease and be discharged from any and all obligations with respect to any subseries of the notes, to replace temporary or mutilated, destroyed, lost or stolen debt securities, to maintain an office or agency in respect of the notes and to hold moneys for payment in trust; or
covenant defeasance, which means AMERCO elects to be released from its obligations with respect to any sub-series of the notes under specified sections of the indenture relating to covenants, and any omission to comply with its obligations will not constitute an Event of Default with respect to such sub-series of the notes;

in either case upon the irrevocable deposit by AMERCO with the trustee, in trust, of an amount, in currency or currencies or government obligations, or both, sufficient without reinvestment to make scheduled payments of the principal of and interest on the applicable sub-series of the notes, when due, whether at maturity or otherwise.

A trust is only permitted to be established if, among other things:
AMERCO has delivered to the trustee an opinion of counsel, as specified in the indenture, to the effect that the holders of the applicable sub-series of the notes will not recognize income, gain or loss for federal income tax purposes as a result of the defeasance or covenant defeasance and will be subject to federal income tax on the same amounts, in the same manner and at the same times as would have been the case if the defeasance or covenant defeasance had not occurred, and the opinion of counsel, in the case of defeasance, will be required to refer to and be based upon a ruling of the Internal Revenue Service or a change in applicable U.S. federal income tax law occurring after the date of the indenture;
no Event of Default or Default has occurred;
the defeasance or covenant defeasance will not result in a breach or violation of, or constitute a Default under, the indenture or any other material agreement or instrument to which AMERCO is a party or by which AMERCO is bound; and
AMERCO has delivered to the trustee an officers' certificate and an opinion of counsel, each stating that all conditions precedent to the defeasance or covenant defeasance have been complied with.

In general, if AMERCO elects covenant defeasance with respect to a sub-series of the notes and payments on such sub-series of the notes are declared due and payable because of the occurrence of an Event of Default, the amount of money and/or government obligations on deposit with the applicable trustee would be sufficient to pay amounts due on such notes at the time of their stated maturity, but may not be sufficient to pay amounts due on such notes at the time of the acceleration resulting from the Event of Default. In that case, AMERCO would remain liable to make payment of the amounts due on such notes at the time of acceleration.

### Trustee

U.S. Bank National Association is the trustee under the indenture, and is a party under the other financing documents; provided, however, the trustee has the right to appoint an agent or nominee to be named as mortgagee or nominee titleholder for the benefit of the noteholders under the financing documents.

### Servicer

AMERCO's subsidiary, U-Haul International, Inc., or its designee, is the servicing agent with respect to the notes (the “servicer”). In this capacity, among other duties, the servicer is responsible for crediting principal and interest to the U-Haul Investors Club accounts of each holder, performing recordkeeping and registrar services, perfecting and maintaining the first-priority lien on the Collateral in favor of the trustee for the benefit of the holders subject to Permitted Liens, and electronically receiving and delivering all documents, statements, tax documents and communications related to the offering, the notes and the U-Haul Investors Club.

### No Personal Liability of Directors, Officers, Employees or Stockholders

No director, officer, employee or stockholder of AMERCO or any of its subsidiaries will have any liability for any obligations of AMERCO or any of its subsidiaries under the notes or any of the financing documents or for any claim based on, in respect of, or by reason of such obligations or their creation. Each holder of the notes, by accepting a note, waives and releases all such liability. The waiver and release are part of the consideration for issuance of the notes. Such waiver and release may not be effective to waive liabilities under the U.S. Federal Securities laws, and it is the view of the SEC that such a waiver is against public policy.

### Arbitration

The financing documents provide that in the event that we, on the one hand, and one or more of the holders, or the trustee on behalf of one or more of the holders, on the other hand, are unable to resolve any dispute, claim or controversy between them related to the financing documents or the U-Haul Investors Club, as applicable, such parties agree to submit such dispute to binding arbitration. However, such arbitration requirement shall not apply in cases where the dispute is between (i) the trustee and us (other than with respect to when the trustee is acting on behalf of one or more of the holders), (ii) the trustee and one or more of the holders, or (iii) the trustee and any third party.

### Governing Law

The indenture and the notes are governed by, and construed in accordance with, the internal laws of the State of New York.

### Form of Notes

AMERCO is issuing the notes in uncertificated book-entry form only. AMERCO is not issuing physical certificates for the notes.

The laws of some states in the United States may require that certain Persons take physical delivery in definitive, certificated form. AMERCO reserves the right to issue certificated notes only if AMERCO determines not to have the notes held solely in book-entry form.

AMERCO, the servicer and the trustee will treat holders of notes in whose names the notes are registered as of the record date as the owners thereof for purposes of receiving credits of principal and interest due on the notes and for any and all other purposes whatsoever with respect to the notes.

### Restrictions on Transfer

The notes are not being listed on any securities exchange. The notes are not transferable except between members of the U-Haul Investors Club through privately negotiated transactions as to which neither AMERCO, the servicer, the trustee, nor any of their respective affiliates will have any involvement. In addition, the notes will not be listed on any securities exchange, and there is no anticipated public market for the notes. In addition, it is unlikely that a secondary “over-the-counter” market for the notes will develop between bond dealers or bond trading desks at investment houses. Therefore, investors must be prepared to hold their notes until the maturity date.

### No Sinking Fund

The notes are fully amortizing and will not have the benefit of a sinking fund.

### Certain Definitions

“Business day” means any day other than a Saturday, Sunday or other day on which banks are authorized or required by law to be closed in New York City, New York, Chicago, Ill. or Phoenix, Ariz.

“Collateral” has the meaning set forth in “Description of Notes—Substitution of Collateral”.

“Default” means any event which is, or after notice or passage of time or both would be, an Event of Default.

“Event of Default” has the meaning set forth in “Description of Notes—Events of Default, Waiver and Notice”.

“Financing documents” means the base indenture, the indenture supplement and the pledge and security agreement, any other instruments and documents executed and delivered pursuant to the foregoing documents as the same may be amended, supplemented or otherwise modified from time to time and pursuant to which, among other things, the Collateral is pledged, assigned or granted to or on behalf of the trustee for the benefit of the holders.

“Initial Collateral” has the meaning set forth in “The Offering” summary table.

“Issue date” means five business days following our receipt and acceptance of investor subscriptions with respect to any sub-series of the notes in the aggregate principal amount of up to $20,000 for such sub-series, or at such other time as AMERCO determines in its sole discretion. Interest on issued notes shall commence to accrue on the issue date. Each sub-series of the notes may have more than one issue date.

“Holder” or “noteholder” means the Person in whose name a note is registered on the books of servicer, who shall serve as the registrar and paying agent with regard to the notes.

“Lien” means any mortgage, deed of trust, deed to secure debt, pledge, hypothecation, assignment, deposit arrangement, security interest, lien, charge, easement, encumbrance, preference, priority or other security agreement or preferential arrangement of any kind or nature whatsoever on or with respect to such property or assets, conditional sale or other title retention agreement having substantially the same economic effect as any of the foregoing; provided that in no event shall an operating lease be deemed to constitute a Lien.

“Notes” means the debt securities of the Company issued pursuant to the indenture and the indenture supplement in an aggregate principal amount of up to $3,552,000, to be issued in sub-series, as provided herein.

“Obligations” means, with respect to any indebtedness under the notes, all obligations for principal, premium, interest (including any interest accruing subsequent to the filing of a petition in bankruptcy, reorganization or similar proceeding at the rate provided for in the documentation with respect thereto, whether or not such interest is an allowed claim under applicable state, federal or foreign law), penalties, fees, indemnifications, reimbursements (including in respect of letters of credit), and other amounts payable pursuant to the documentation governing such indebtedness.

“Owner” means U-Haul Leasing & Sales Co., a Nevada corporation, an indirect subsidiary of AMERCO.

“Permitted Liens” means Liens in favor of carriers, warehousemen, mechanics, suppliers, repairmen, materialmen and landlords and other similar Liens imposed by law, in each case for sums not overdue or being contested in good faith by appropriate proceedings or other Liens arising out of judgments or awards against the Company.

“Person” means any individual, corporation, partnership, limited liability company, joint venture, association, joint-stock company, trust, unincorporated organization, government or any agency or political subdivision thereof or any other entity.

“Principal” of a note means the principal of such note, plus the premium, if any, payable on the note which is due or overdue or is to become due at the relevant time.

“Record date” means the first day of the month preceding the related due date for the crediting of principal and interest on the notes.

“Replacement Collateral” has the meaning set forth in “Description of Notes—Substitution of Collateral”.

“Released Collateral” has the meaning set forth in “Description of Notes—Substitution of Collateral”.

“SEC” means the U.S. Securities and Exchange Commission.

“Trust Indenture Act” means the Trust Indenture Act of 1939, as amended.

“Trustee” means U.S. Bank National Association until a successor replaces it and, thereafter, means the successor.

“UCC” means the Uniform Commercial Code as in effect from time to time in the applicable jurisdiction.

### U-Haul Investors Club™

### Overview

The offering of the notes is structured as a subscription offering. This means AMERCO is offering you the opportunity to subscribe to purchase notes, which AMERCO may accept or reject. In order to subscribe to purchase notes, you must become a member of the U-Haul Investors Club and follow the instructions available on our website at uhaulinvestorsclub.com. Prospective investors shall have the opportunity to select the sub-series of notes for which such prospective investor is subscribing.

### Membership Application

In order to become a member of the U-Haul Investors Club (a “member”) you must first submit a membership application online. A member of the U-Haul Investors Club must:
with respect to natural persons, be of at least 18 years of age and be a U.S. resident with a valid social security number;
with respect to entities, be a corporation, partnership, limited partnership, trust, limited liability company or any other entity, organized under the laws of a United States jurisdiction and have a valid tax identification number or social security number;
have an email account and a U.S. bank account;
link such member's U.S. bank account to such member's U-Haul Investors Club account;
be comfortable using the Internet and investing in a self-directed manner; and
agree to other specified terms and conditions of membership in the U-Haul Investors Club, including electronic receipt and delivery of all documents, statements and communications related to the offering, the notes and the U-Haul Investors Club online, as well as the obligation to arbitrate resolution of any and all disputes that arise, and a waiver of class action claims.

If your membership application is accepted, AMERCO will notify you by email and a password-protected U-Haul Investors Club account will be created.

### Subscription Agreement and Process

Once you are a member of the U-Haul Investors Club, in order to subscribe to purchase notes you must submit a subscription offer online. In the subscription offer, you will designate the maximum principal amount of notes, and the applicable sub-series, that you are willing to purchase. The minimum amount of notes that you can subscribe to purchase is $100, and you may only subscribe to purchase a principal amount of notes in an integral multiple of $100 (e.g., $100, $200, $300, etc.). Unless otherwise determined by AMERCO, there is no maximum amount of notes that you can subscribe to purchase.

AMERCO reserves the right to accept or reject your subscription to purchase notes, in whole or in part, and in its sole discretion, for any reason.

### Revocability of Subscription to Purchase Notes

Your subscription to purchase notes in any sub-series is revocable until AMERCO closes the offering. Upon the closing of the offering, your subscription to purchase notes for such sub-series shall be irrevocable. The anticipated offering closing date for each sub-series of the notes is or will be identified on the uhaulinvestorsclub.com website; however, such date is subject to change at AMERCO's sole discretion. To the extent AMERCO changes the anticipated closing date, the uhaulinvestorsclub.com website will be updated to reflect such changed date. It is recommended that prospective investors periodically check the uhaulinvestorsclub.com website for any changes in the anticipated closing date.

### Issuance of Notes

Notes will be issued within five business days following our receipt and acceptance of investor subscriptions with respect to any sub-series of the notes in the aggregate principal amount of up to $20,000 for such sub-series, or at such other time as AMERCO determines in its sole discretion. Interest shall on issued notes commence to accrue on the issue date. Each sub-series of the notes may have more than one issue date. Such note issuance will be in uncertificated book-entry format only. Servicer will register the notes in the names of these members on servicer's books and records.

### U-Haul Investors Club Member Accounts

In order to subscribe to purchase notes, a member must have sufficient funds in its U-Haul Investors Club account. In order to fund its U-Haul Investors Club account, such account must be linked to such member's outside U.S. bank account and funds must be transferred from the linked bank account to the U-Haul Investors Club account, using the Automated Clearing House, or ACH, network. Funds are considered available in the member's U-Haul Investors Club account a minimum of three business days after such member initiates the ACH transfer. U-Haul Investors Club accounts are record-keeping subaccounts of a bank account maintained by servicer (referred to herein as the “investment account”) with a third party financial institution, and reflect balances and transactions with respect to each member of the U-Haul Investors Club. The servicer administers the investment account and maintains the sub-accounts for each member of the U-Haul Investors Club. These record-keeping sub-accounts, which we refer to as “U-Haul Investors Club accounts”, are purely administrative. U-Haul Investors Club members have no direct relationship with the financial institution at which the investment account is maintained, or any successor thereto, by virtue of becoming a member of and participating in the U-Haul Investors Club. Funds in the investment account will always be maintained by the servicer at an FDIC member financial institution.

How to Remove Funds from Your U-Haul Investors Club Account

Uninvested funds in each member's U-Haul Investors Club account may remain in the respective U-Haul Investors Club accounts indefinitely and do not earn interest, and may include funds never committed by the member to the purchase of notes. Upon request by the member through the U-Haul Investors Club website, AMERCO will transfer, or will cause the servicer to transfer, U-Haul Investors Club account funds to the member's linked U.S. bank account by ACH transfer, provided such funds are not already committed to the purchase of notes. It may take up to five business days for funds to transfer from a member's U-Haul Investors Club account to such member's linked U.S. bank account. However, in order to ensure that sufficient funds are available in a member's U-Haul Investors Club account, with respect to funds ACH transferred into the member's U-Haul Investors Club account from its linked bank account, there will be a thirty (30) day hold before such funds are eligible for ACH transfer to such member's linked bank account.

### Principal and Interest; Servicing of the Notes

Each holder will have the principal and interest due on the notes credited to such holder's U-Haul Investors Club account. The notes are being exclusively serviced by the servicer, which means, among other things, that the servicer is responsible for performing recordkeeping and registrar services with respect to the notes, and electronically receiving and delivering all documents, statements and communications related to the offering, the notes and the U-Haul Investors Club. Each member is permitted one free ACH transfer initiation per week (Sunday through Saturday) from such member's U-Haul Investors Club account to such member's linked U.S. bank account. Additional transfers may be subject to a $1.00 per transaction charge. The trustee has no duty, responsibility or liability with respect to the transfer, registration or payments on the notes.

### Transfer of Notes

The notes will not be listed on any securities exchange, and there is no public market for the notes. Therefore, you must be prepared to hold your notes until the maturity date. The notes are not transferable except between members of the U-Haul Investors Club through privately negotiated transactions, as to which neither AMERCO, the servicer, the trustee, nor any of their respective affiliates will have any involvement. In the event you sell or transfer your note, you must notify servicer, and there will be assessed to the transferor a $25.00 per transaction registrar transfer fee. Such registrar transfer fee will be automatically deducted from the note transferor's U-Haul Investors Club account. There can be no assurance that a holder desiring to sell its notes will be able to find a buyer in any privately negotiated transaction, or that even if such a buyer is located by a holder, that such buyer would be willing to pay a price equal to the outstanding principal balance due on such note.

### U-Haul Investors Club Fees

There are no fees to join the U-Haul Investors Club or to maintain a membership, and there are no commissions on the purchases of notes. In addition to the $25.00 registrar transfer fee noted above, non-routine requests made in connection with your notes may lead to additional fees, subject to your prior approval. Such fees will be automatically deducted from the funds in your U-Haul Investors Club account.

### Electronic Communication

By participating in the offering, members of the U-Haul Investors Club agree to receive and submit all documents, statements, records and notices, and tax documents including IRS Form 1099s, electronically through the U-Haul Investors Club website and their U-Haul Investors Club accounts. Each member is responsible for keeping its U-Haul Investors Club account contact information up-to-date with the servicer. The notes are maintained in book-entry form, with AMERCO.

What is claimed is:

1. A computer-implemented method for issuing collateralized securities, the method comprising:
storing in a database offering information associated with a public offering of a collateralized debt security offered for sale by the issuer of the debt security, wherein the offering information includes payment terms of a loan and a description of collateral for securing the loan;
displaying on a website the offering information for viewing by a retail investor; and
using the website to receive from the retail investor an offer for the purchase of the debt security directly from the issuer.

2. The method of claim 1 wherein the collateral includes equipment to be used by the issuer of the debt security in its business.

3. The method of claim 1 wherein the collateral includes real estate to be used by the issuer of the debt security in its business.

4. The method of claim 1 wherein the collateral includes vehicles to be used by the issuer of the debt security in its business.

5. The method of claim 4 wherein the vehicles are moving vehicles to be used by the issuer of the debt security in its business.

6. The method of claim 1 wherein the purchase price for the retail investor offer can be as small as $100.

7. The method of claim 1 wherein the offering information includes the number of units of the security to be sold in the initial offering and the current percentage funded of the initial offering.

8. A computer-implemented method for issuing collateralized securities, the method comprising:
storing in a database offering information associated with a public offering of a collateralized debt security offered for sale by the issuer of the debt security, wherein the offering information includes payment terms of a loan and a description of collateral for securing the loan and wherein the collateral is to be used by the issuer of the debt security in its business;
displaying on a website the offering information for viewing by a retail investor; and
using the website to receive from the retail investor an offer for the purchase of the debt security directly from the issuer; and
using the website to process payment from the retail investor for the purchase offer without the involvement of a third-party underwriter, investment banker, broker or dealer.

9. The method of claim 8 wherein the collateral includes equipment to be used by the issuer of the debt security in its business.

10. The method of claim 8 wherein the collateral includes real estate to be used by the issuer of the debt security in its business.

11. The method of claim 8 wherein the collateral includes vehicles to be used by the issuer of the debt security in its business.

12. The method of claim 11 wherein the vehicles are moving vehicles to be used by the issuer of the debt security in its business.

13. The method of claim 8 wherein the purchase price for the retail investor offer can be as small as $100.

14. The method of claim 1 wherein the offering information includes the number of units of the security to be sold in the public offering and the current percentage funded of the initial offering.

15. A system for issuing collateralized securities, the system comprising:
a database operative to store offering information associated with a public offering of a collateralized debt security offered for sale by the issuer of the debt security, wherein the offering information includes payment terms of a loan and a description of collateral for securing the loan and wherein the collateral includes tangible assets to be used by the issuer of the debt security in its business;
displaying on a website the offering information for viewing by a retail investor; and
an input component operative to receive from the retail investor an offer for the purchase of the debt security directly from the issuer; and
a processor operative with the database to process the retail investor offer and to process the retail investor purchase offer without the involvement of a third-party underwriter, investment banker, broker or dealer.

16. The system of claim 15 wherein the collateral includes equipment to be used by the issuer of the debt security in its business.

17. The system of claim 15 wherein the collateral includes real estate to be used by the issuer of the debt security in its business.

18. The system of claim 15 wherein the collateral includes vehicles to be used by the issuer of the debt security in its business.

19. The system of claim 18 wherein the vehicles are moving vehicles to be used by the issuer of the debt security in its business.

20. The system of claim 15 wherein the purchase price for the retail investor offer can be as small as $100.

21. A system for issuing debt securities, the system comprising:
a database operative to store offering information associated with a public offering of a debt security offered for sale by the issuer of the debt security, wherein the offering information includes payment terms of a loan;
displaying on a website the offering information for viewing by a retail investor; and
an input component operative to receive from the retail investor an offer for the purchase of the debt security directly from the issuer; and
a processor operative with the database to process the retail investor purchase offer without the involvement of a third-party underwriter, investment banker, broker or dealer

22. The system of claim 21 wherein the purchase price for the retail investor offer can be as small as $100.
